(19) United States
(12) Patent Application Publication
(10) Pub. No.: US 2005/0266249 A1
(43) Pub. Date: Dec. 1, 2005

(54) Flexible metal clad laminate film and a manufacturing method for the same

(76) Inventors: Dongcheon Shin, Seoul (KR); Jeong-Il Byun, Seoul (KR); Jun-Hee Lee, Gyeonggi-do (KR); Byoung-Un Kang, Gyeonggi-do (KR); Kyung Joon Lee, Gyeonggi-do (KR)

Correspondence Address: JONES DAY, 222 EAST 41ST ST, NEW YORK, NY, 10017, US

(21) Appl. No.: 10/959,016

(22) Filed: Oct. 5, 2004

(30) Foreign Application Priority Data
May 28, 2004 (KR) 10-2004-0038007
May 28, 2004 (KR) 10-2004-0038008
May 28, 2004 (KR) 10-2004-0038009
May 28, 2004 (KR) 10-2004-0038010
May 28, 2004 (KR) 10-2004-0038011

(51) Int. Cl. B32B 15/08

(52) U.S. Cl. 428/416; 528/106

(57) ABSTRACT

The present invention relates to a flexible metal clad laminate film and a manufacturing method for the same. The flexible metal clad laminate film of the present invention comprises a metal thin film; and a flexible insulating film formed by photo-crosslinking reaction of photoactive polymers having photoactive side chains, which may be crosslinked by photo-irradiation. The flexible metal clad laminate film of the present invention has good physical properties such as size stability, and is almost not deflected or twisted, since it includes the flexible insulating film composed of crosslinked resin formed by photo-crosslinking reaction of photoactive polymer.

### BACKGROUND OF THE INVENTION

1. Field of the Invention

The present invention relates to a flexible metal clad laminate film and a manufacturing method for the same.

2. Description of the Related Art

Recently, a flexible circuit board (FCB) having a flexible metal clad laminate film as a base is in the spotlight, which is characterized by thinness, flexuosity, and lightness, according as electronic products have been subminiatured, high-intergrated, simplified, and high-performed.

The flexible metal clad laminate film is manufactured in the form of a flexible basefilm laminated on an electro-conductive metal thin film such as copper and aluminum. Moreover, adhesives may be used between them. In other words, the flexible metal clad laminate film has the structure of one or more than 3-layers composed of flexible base film-adhesive-metal thin film, or one or more than 2-layers composed of flexible base film-metal thin film.

The flexible base film in the flexible metal clad laminate film is made of organic polymer materials such as polyimide, polyamide, polyester, polysulfone, and polyether-imide. The flexible base film should have physical properties of insulation, durability against high temperature and chemicals, size stability, electric permittivity, mechanical strength, solvent resistance, soldering stability, and so on.

However, since traditional flexible base films generally have great linear expansion coefficient, flexible metal clad laminate films using them have some problems such as easy occurrence of deflecting or twisting. Moreover, the physical properties such as size stability, heat resistance, electric permittivity, and so on are not satisfactory.

### SUMMARY OF THE INVENTION

The present invention is designed to solve the problems of the prior art, and therefore it is an object of the present invention to provide a flexible metal clad laminate film comprising a metal thin film; and a flexible insulating film formed by photo-crosslinking reaction of photoactive polymers having photoactive side chains, which may be crosslinked by photo-irradiation.

Another object of the present invention is to provide a method for manufacturing a flexible metal clad laminate film comprising the steps of: preparing a photoactive polymer having photoactive side chains, which may be crosslinked by photo-irradiation; preparing a solution by dissolving the photoactive polymer in a solvent; forming a coating layer by applying the solution on a surface of a metal thin film; eliminating the solvent from the coating layer; and forming a flexible insulating film by irradiating on the surface of the solvent-free coating layer so that the photoactive polymers may be crosslinked.

Still another object of the present invention is a method for manufacturing a flexible metal clad laminate film comprising the steps of: preparing a photoactive polymer having photoactive side chains, which may be crosslinked by photo-irradiation; preparing a solution by dissolving the photoactive polymer in a solvent; forming a coating layer by applying the solution on a surface of a base plate; eliminating the solvent from the coating layer; forming a flexible insulating film by irradiating on the surface of the solvent-free coating layer so that the photoactive polymers may be crosslinked; peeling off the flexible insulating film from the surface of the base plate; and adhering both the peeled flexible insulating film and a metal thin film using an adhesive.

### DESCRIPTION OF THE PREFERRED EMBODIMENT

Hereinafter, a flexible metal clad laminate film and a manufacturing method for the same of the present invention will be described in more detail.

First of all, terms and words used in the specification and the claims should be interpreted not in a limited normal or dictionary meaning, but to include meanings and concepts conforming with technical aspects of the present invention, based on the face that inventors may appropriately define a concept of a term to describe his/her own invention in a best way.

In the specification, if a straight line for substituent is passed through any ring structure such as phenyl in chemical formula, it may attached to any carbon of the ring having no substituent. In other words, it may be in any position of ortho, meta, and para relatively to a fixed substituent on the ring.

The flexible metal clad laminate film of the present invention comprises a metal thin film and a flexible insulating film laminated on the metal thin film.

Herein, it may be 2-layer or 3-layer structure according to the presence of an adhesive layer between the metal thin film and the flexible insulating film.

The flexible insulating film is formed by photo-crosslinking reaction of photoactive polymers having photoactive side chains capable of being crosslinked by photo-irradiation. Therefore, the photoactive side chain may be reacted to the light of specific wavelength such as UV ray so that crosslinking reaction including photo-dimerization and photo-crosslinking reaction between polymer chains may be occurred. The photoactive side chains include, but not limited to, alkene derivatives or alkyne derivatives, such as cinnamate, chalcone, coumarin, maleimide, and so on.

The crosslinkage between polymer chains may be formed by cyclic addition between the photoactive side-chains initiated by the light such as UV ray. Some examples of the photo-crosslinking reaction are as follows in the reaction formula 1;

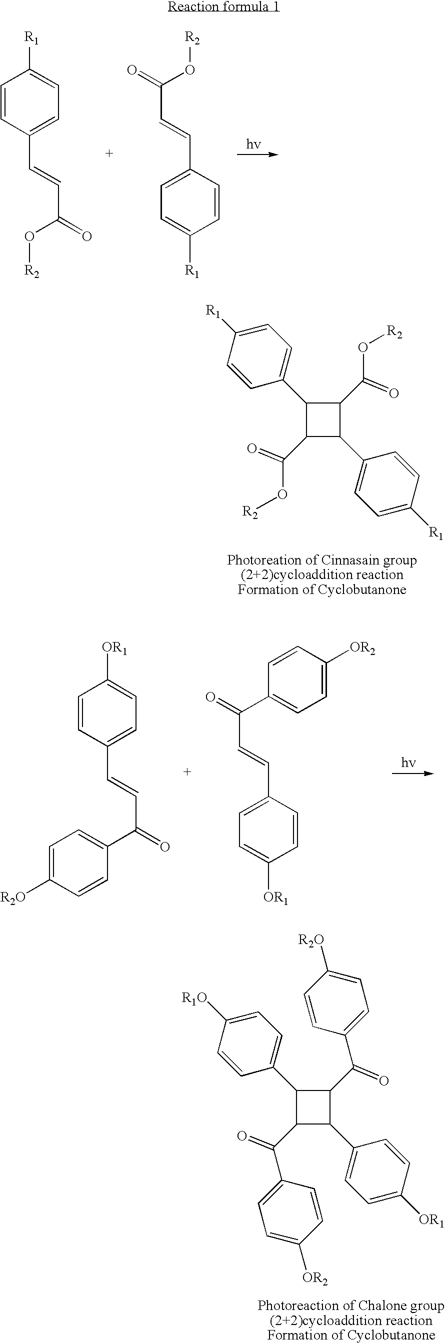

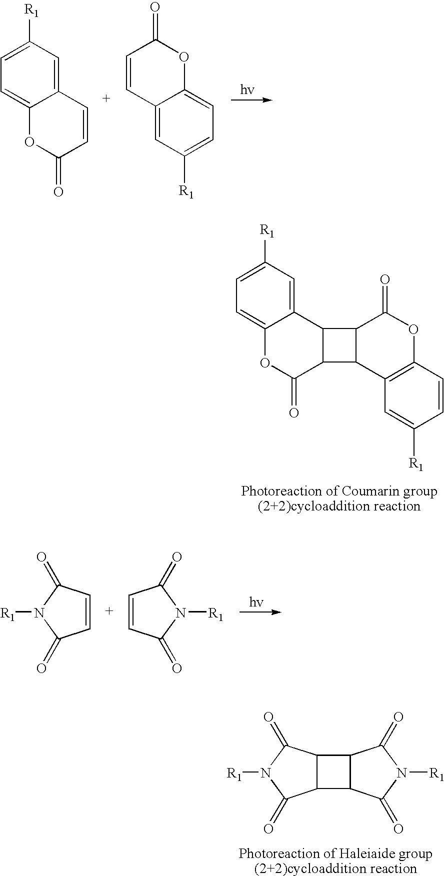

Preferably, in the present invention, the photoactive polymer has good properties including heat resistance. For example, it include, but not limited to, polycyanurate, poly(amide-imide), polyester, poly(thio)ether, polyimide, and so on. Particularly, the photoactive polymer having a main chain in which triazine rings are introduced is more preferred, since its physical properties such as heat resistance, electric permittivity, and so on, are good. It is the reason that the triazine ring having 3 nitrogen atoms is able to withdraw electrons well.

Moreover, since the triazine rings may promote photo-crosslinking reaction between their side chains having photoactive functional group, the photoactive polymer having a main chain in which triazine rings having photoactive side chains capable of crosslinking reaction by photo-irradiation are introduced is more preferred in the present invention. Preferably, the number average molecular weight (Mn) of the photoactive polymer in the present invention is 1,000˜1,000,000. Moreover, the thickness of the flexible insulating film formed from the photoactive polymer is 1 nm˜10 cm preferably.

In the present invention, the metal thin film is made of, but not limited to, copper, platinum, gold, silver, aluminum, and so on preferably. In particular, copper is more preferred because of good performance as compared with cost. Generally, the thickness of the metal thin film is about 0.1˜500 μm.

Meanwhile, the flexible metal clad laminate film of the present invention further comprises an adhesive layer. The adhesive may be generally used in manufacturing for flexible metal clad laminate films, for example, but not limited to, acrylic-based, silicon-based, epoxy-based adhesive, and so on.

As mentioned above, since the flexible metal clad laminate film of the present invention has a flexible insulating film made of photo-crosslinked polymer good properties, its physical property such as size stability is improved, and the phenomena of deflecting or twisting is minimized.

Hereinafter, several preferred photoactive polymers having main chains in which triazine rings having photoactive side chains are introduced, will be described in detail as an example to form the flexible insulating film in the present invention.

In the present invention, a photoactive polycyanurate polymer having the structure of the following chemical formula 1 is preferred. 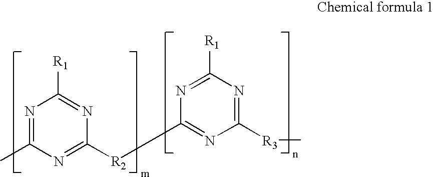
where in the chemical formula 1, m+n=1, 0≦m≦1, 0≦n≦1, and R₁ is selected from the group of (1a), (2a), (3a), and (4a) of the following chemical formula 2 respectively, 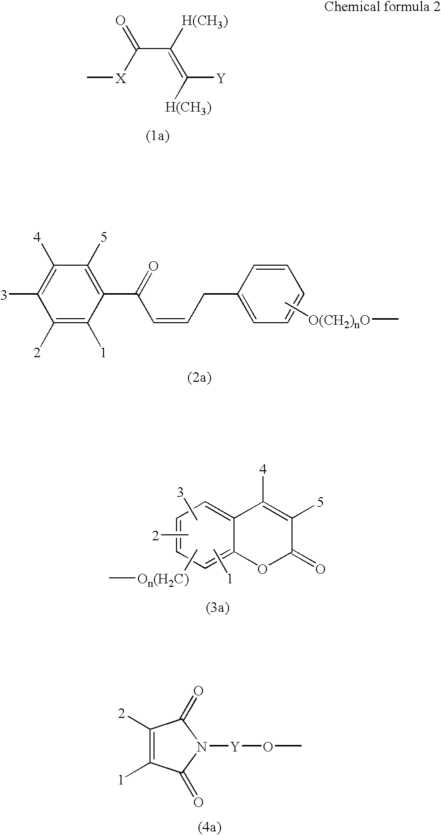
where X of the chemical formula 2 (1a) is selected from the group consisting of the structures of the following chemical formula 3, 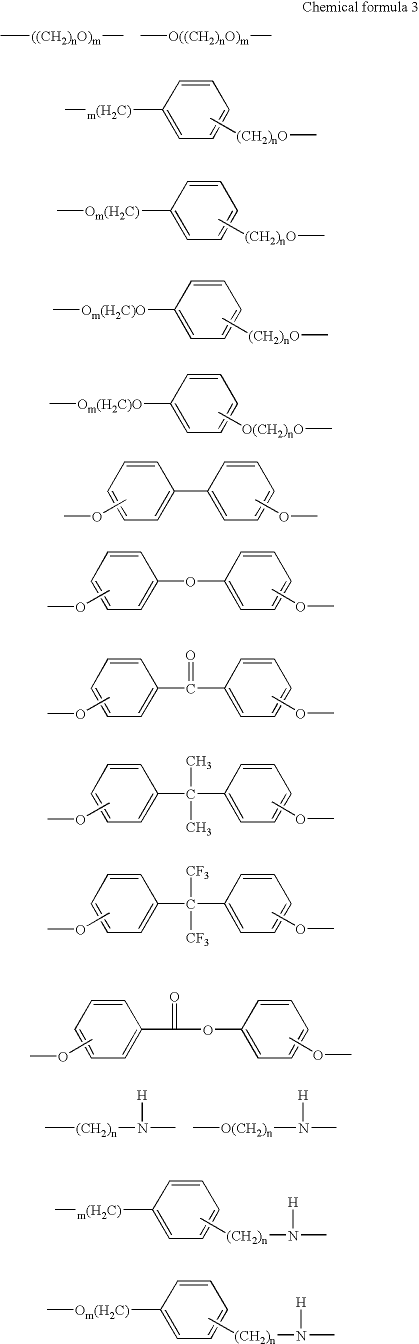 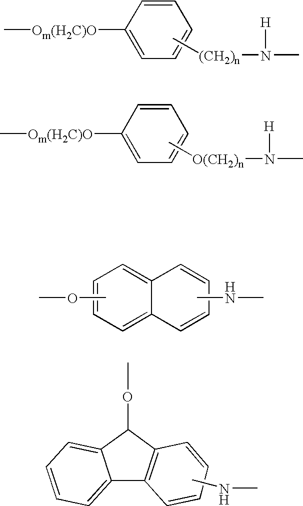
where, in the chemical formula 3, m and n are 0˜10 respectively.

In the chemical formula 2(1a), Y is selected from the group consisting of the structures of the following chemical formula 4, 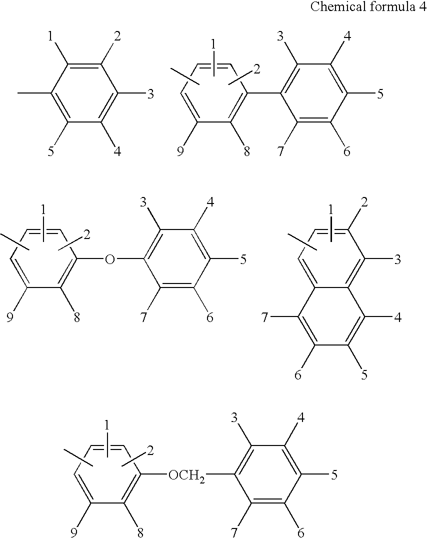
where, in the chemical formula 4, the numerals 1, 2, 3, 4, 5, 6, 7, 8, and 9 are respectively selected from the group consisting of the structures of the following chemical formula 5. 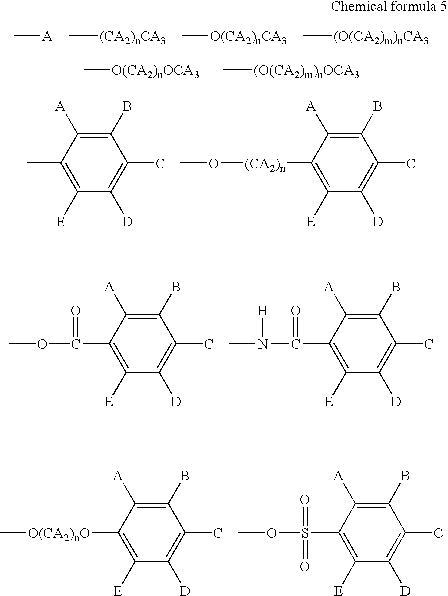
   where, in the chemical formula 5, m and n are 0˜10 respectively, and A, B, C, D, and E are respectively selected from the group consisting of H, F, Cl, CN, CF₃ and CH₃.

In the chemical formula 2 (2a) and (3a), n is 0˜10, and the numerals 1, 2, 3, 4, and 5 are respectively selected from the group consisting of the structures of the following formula 6, 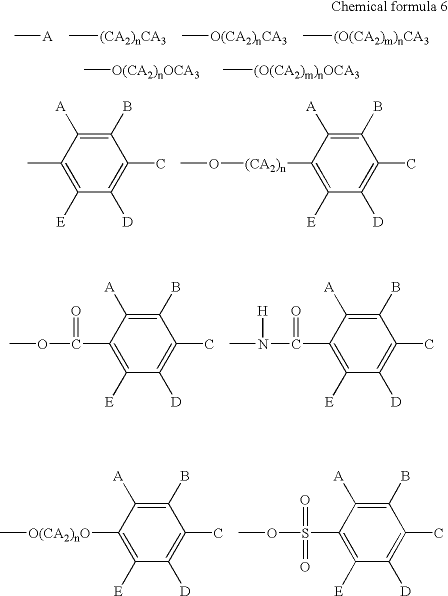
where, in the chemical formula 6, m and n are 0˜10 respectively, and A, B, C, D, and E are respectively selected from the group consisting of H, F, Cl, CN, CF₃ and CH₃.

In the chemical formula 2 (4a), Y is selected from the group consisting of the structures of the following chemical formula 7, 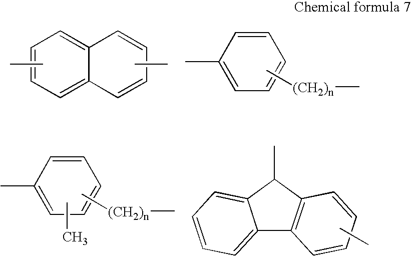
where, in the chemical formula 7, n is 0˜10, In the chemical formula 2 (4a), 1 and 2 are respectively selected from the group consisting of the structures of the following chemical formula 8, 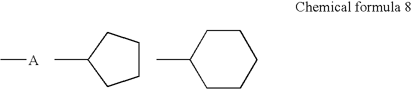
where, in the chemical formula 8, A is selected from the group consisting of H, F, CH₃, CF₃, and CN,

In the chemical formula 1, R₂ and R₃ are respectively selected from the group consisting of the structures of the following chemical formula 9, 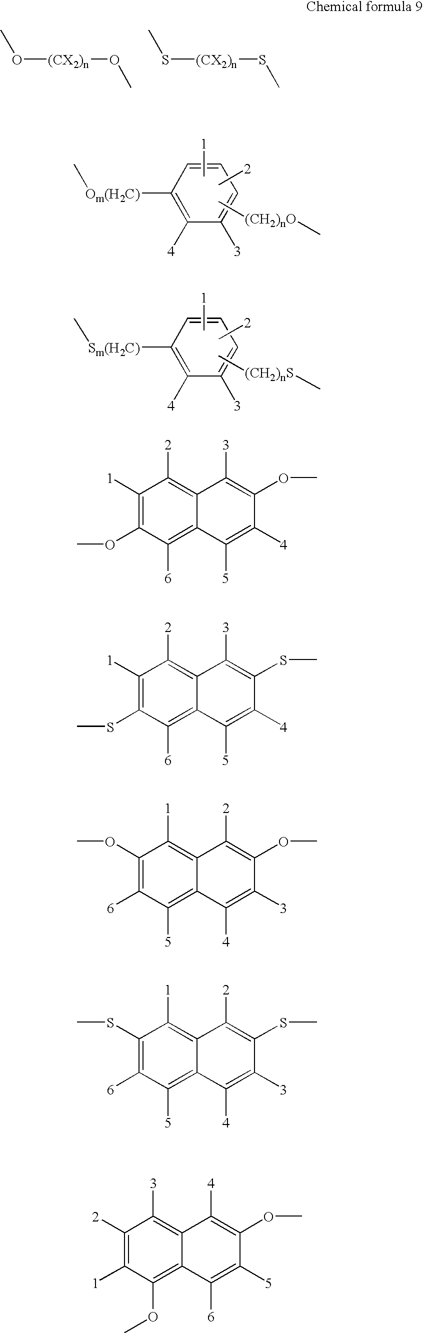 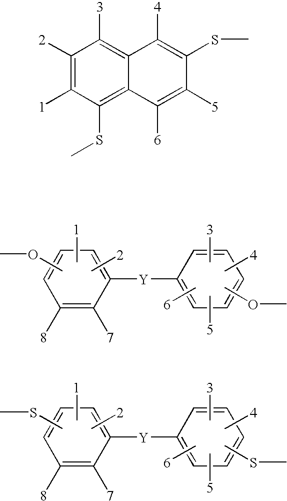
where, in the chemical formula 9, m and n are 0˜10 respectively, the numerals 1, 2, 3, 4, 5, 6, 7, and 8 are respectively selected from the group consisting of H, F, Cl, CN, CH₃, OCH₃, and CF₃, X is selected from the group consisting of H, F, Cl, CN, CH₃, OCH₃, and CF₃, and Y is selected from the group consisting of CH₂, C(CH₃)₂, C(CF₃)₂, O, S, SO₂, CO, and CO₂.

In the present invention, a photoactive polyester polymer having the structure of the following chemical formula 10 is preferred.

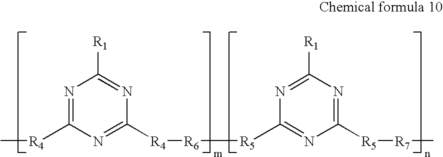

In the chemical formula 10, m+n=1, 0≦m≦1, 0≦n≦1, and R₁, as a photoactive side chain, is selected from the group of (1a), (2a), (3a), and (4a) of the aforementioned chemical formula 2 respectively. Herein, the specific explanation of the chemical formula 2 is the same as the aforementioned chemical formulas 3 to 8.

In the chemical formula 10, ester bonds are formed by the reaction between alcohol and carboxylic acid as shown in the following reaction formula 2.

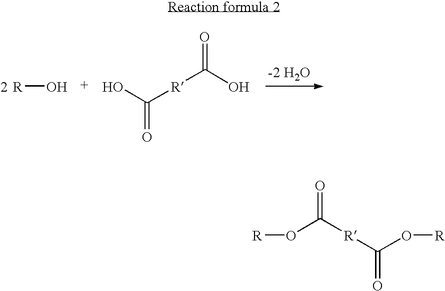

In the chemical formula 10, R₄ and R₅ are respectively selected from the group consisting of the structures of the following chemical formula 11.

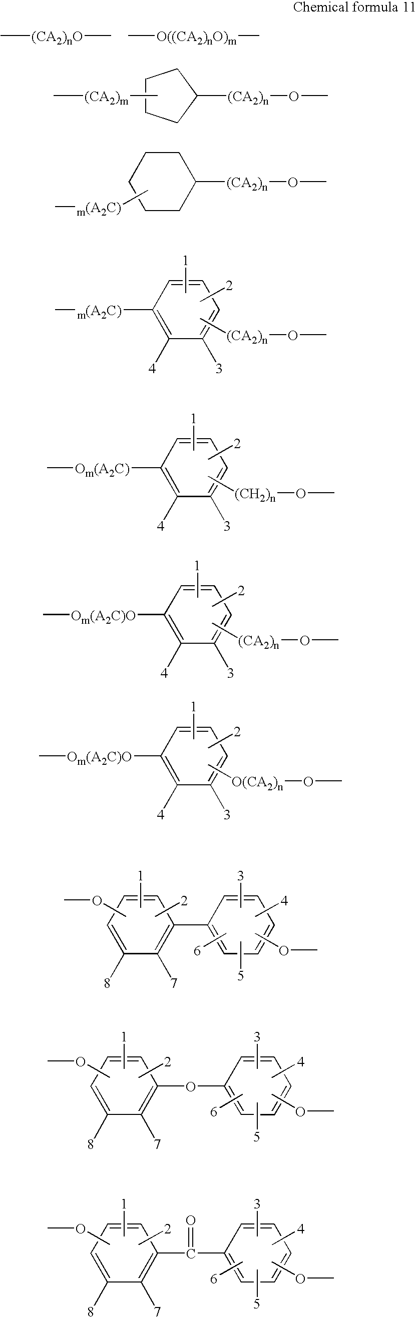

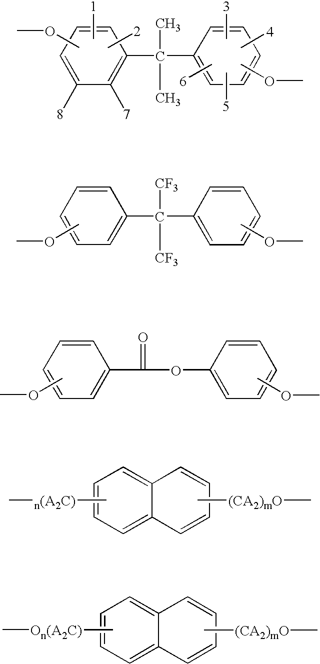

In the chemical formula 11, m and n are 0˜10 respectively, and A, the numerals 1, 2, 3, 4, 5, 6, 7, and 8 are respectively selected from the group consisting of H. F, Cl, CN, CF₃, and CH₃.

In the chemical formula 10, R₆ and R₇ are respectively selected from the group consisting of the structures of the following chemical formula 12, 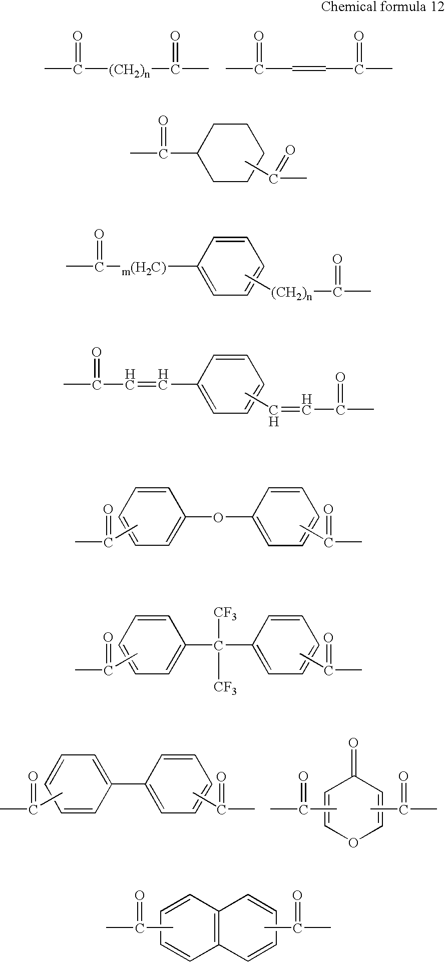
where, in the chemical formula 12, m and n are 0˜10 respectively.

In the present invention, a photoactive poly(thio)ether polymer having the structure of the following chemical formula 13 is preferred.

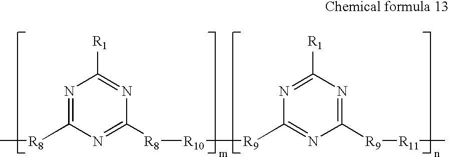

In the chemical formula 13, m+n=1, 0≦m≦1, 0≦n≦1, and R₁, as a photoactive side chain, is selected from the group of (1a), (2a), (3a), and (4a) of the aforementioned chemical formula 2 respectively. Herein, the specific explanation of the chemical formula 2 is the same as the aforementioned chemical formulas 3 to 8.

In the chemical formula 13, ether bonds are formed by the reaction between dihalide and diol as shown in the following reaction formula 3.

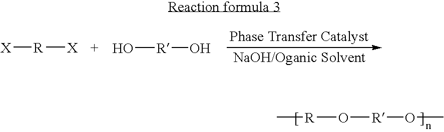

Moreover, in the chemical formula 13, thioether bonds are formed by the reaction between dihalide and dithiol as shown in the following reaction formula 4,

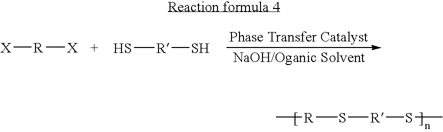

In the chemical formula 13, R₈ and R₉ are respectively selected from the group consisting of the structures of the following chemical formula 14, 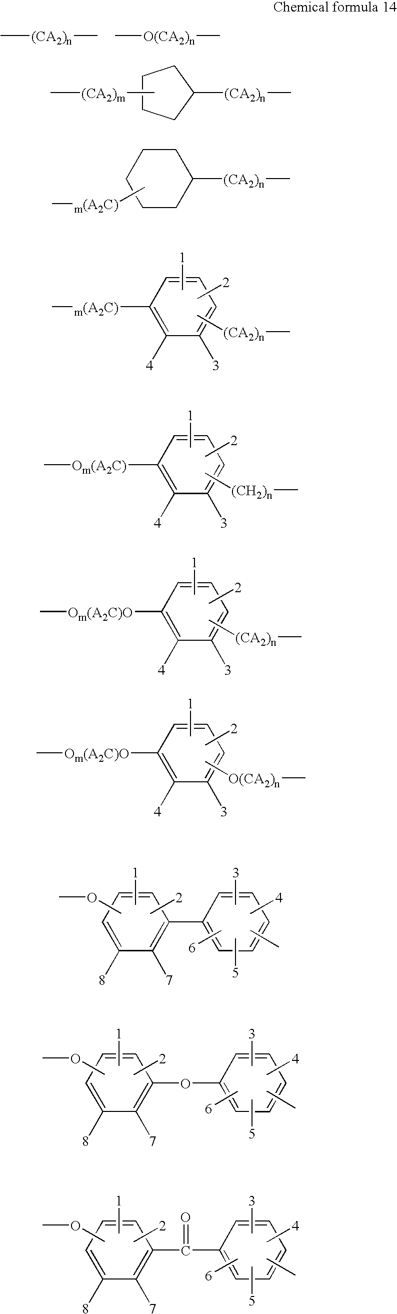 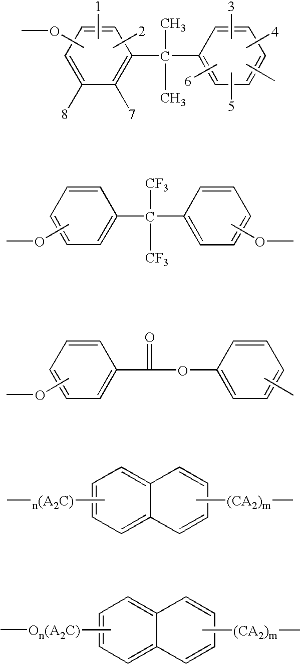
where in the chemical formula 14, m and n are 0˜10 respectively, and A, the numerals 1, 2, 3, 4, 5, 6, 7, and 8 are respectively selected from the group consisting of H, F, Cl, CN, CF₃, and CH₃.

In the chemical formula 13, R₁₀ and R₁₁ are respectively selected from the group consisting of the structures of the following chemical formula 15.

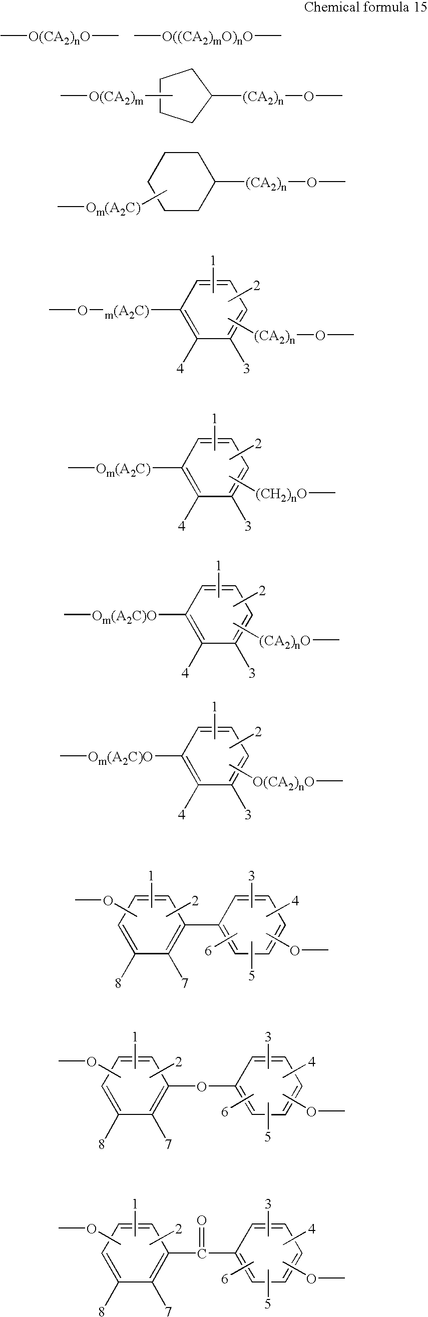

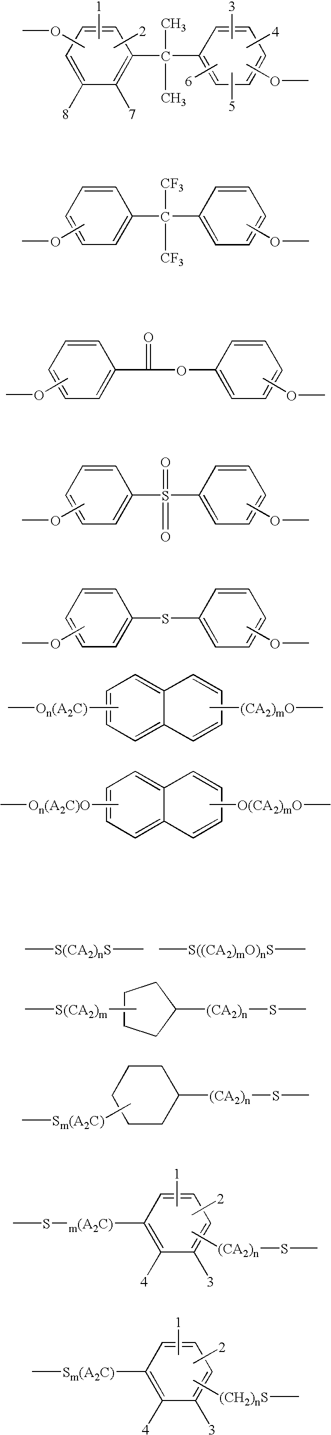

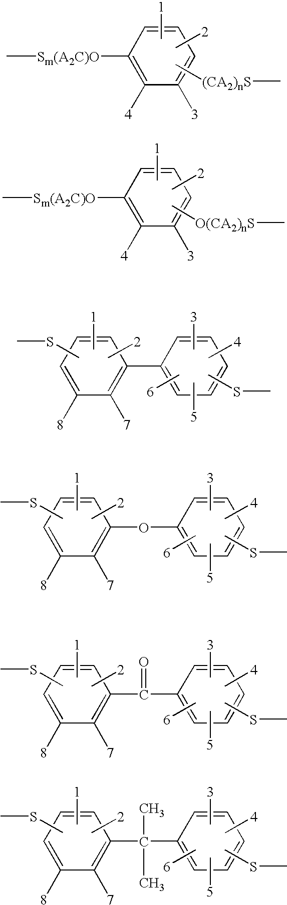

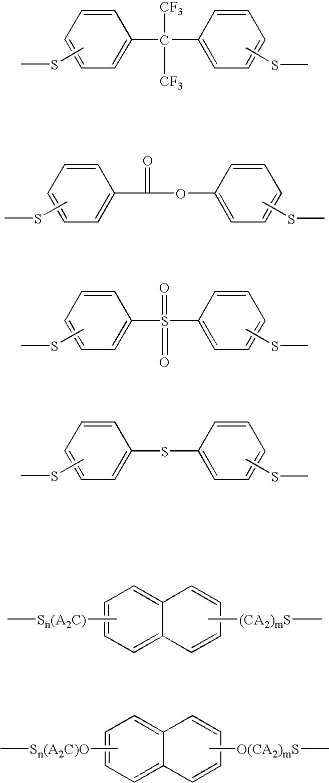

In the chemical formula 15, m and n are 0˜10 respectively, and A, the numerals 1, 2, 3, 4, 5, 6, 7, and 8 are respectively selected from the group consisting of H, F, Cl, CN, CF₃, and CH₃.

In the present invention, a photoactive poly(amide-imide) having the structure of the following chemical formula 16 is preferred.

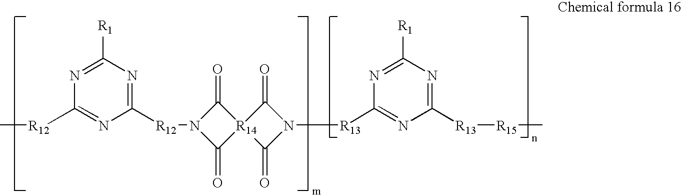

In the chemical formula 16, m+n=1, 0≦m≦1, 0≦n≦1, and R₁, as a photoactive side chain, is selected from the group of (1a), (2a), (3a), and (4a) of the aforementioned chemical formula 2 respectively. Herein, the specific explanation of the chemical formula 2 is the same as the aforementioned chemical formulas 3 to 8.

In the chemical formula 16, imide bonds are formed by the reaction between amine and carboxylic acid dianhydride as shown in the following reaction formula 5.

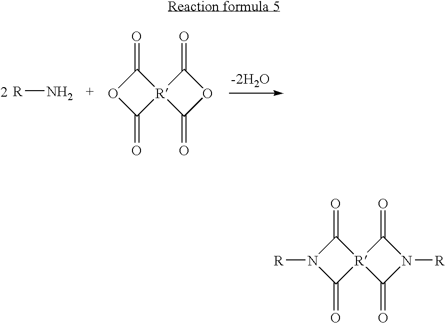

Moreover, in the chemical formula 16, amide bonds are formed by the reaction between amine and carboxylic acid as shown in the following reaction formula 6.

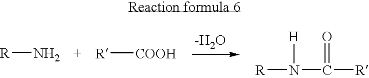

In the chemical formula 16, R₁₂ and R₁₃ are respectively based on one amine selected from the group consisting of the structures of the following chemical formula 17, 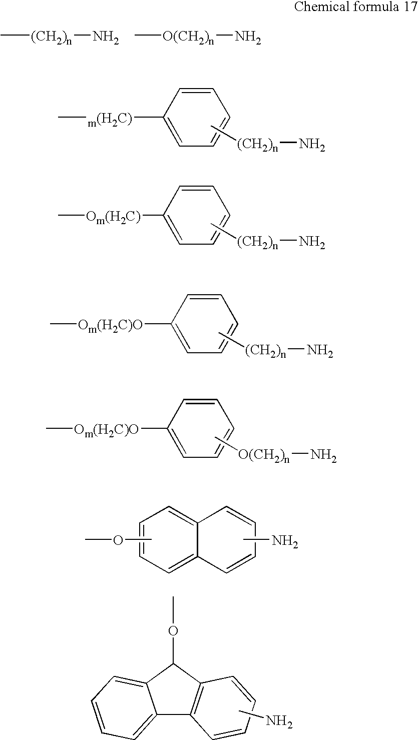
where in the chemical formula 17, m and n are 0˜10 respectively.

Moreover, in the chemical formula 16, R₁₄ is respectively based on one carboxylic acid dianhydride selected from the group consisting of the structures of the following chemical formula 18.

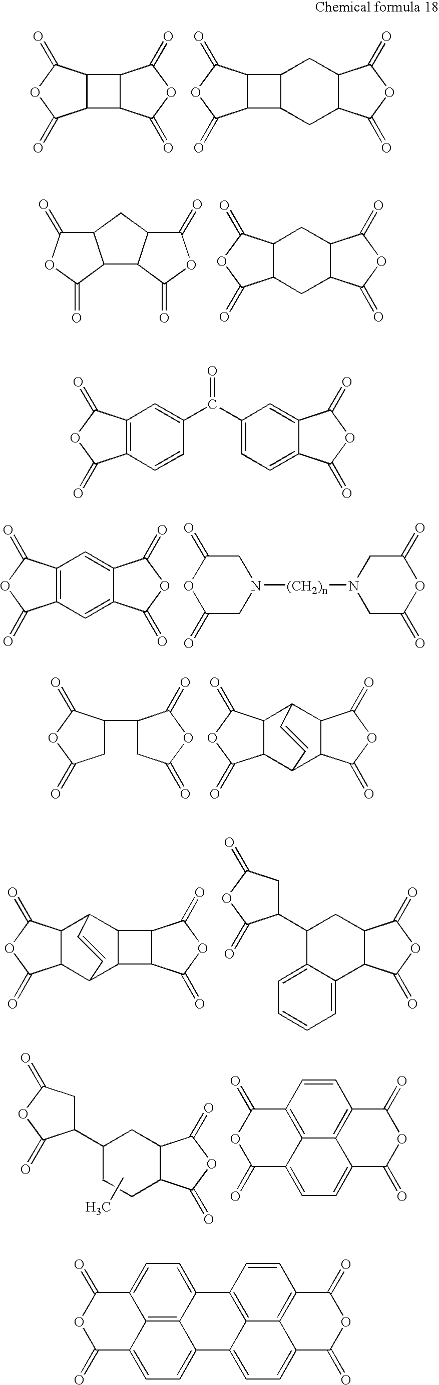

In the chemical formula 16, R₁₅ is selected from the group consisting of the structures of the following chemical formula 19, 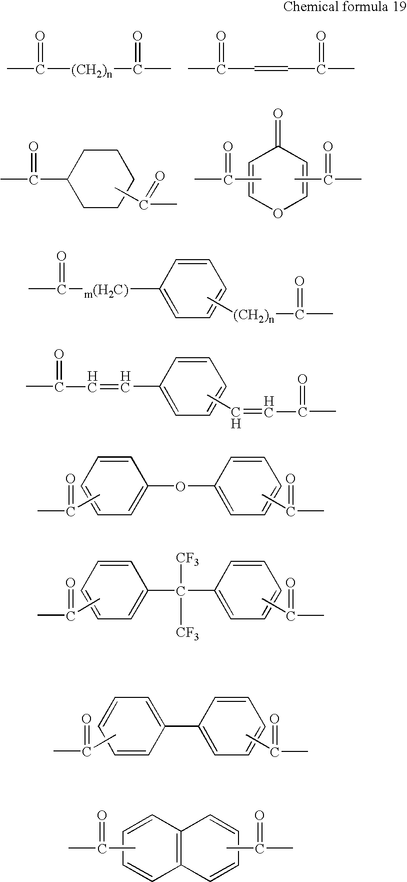
where, in the chemical formula 19, m and n are 0˜10 respectively.

In the present invention, a photoactive polyimide having the structure of the following chemical formula 20 is preferred.

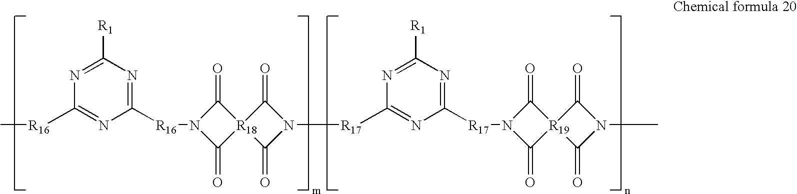

In the chemical formula 20, m+n=1, 0≦m≦1, 0≦n≦1, and R₁, as a photoactive side chain, is selected from the group of (1a), (2a), (3a), and (4a) of the aforementioned chemical formula 2 respectively. Herein, the specific explanation of the chemical formula 2 is the same as the aforementioned chemical formulas 3 to 8.

In the chemical formula 20, imide bonds are formed by the reaction between amine and carboxylic acid dianhydride as shown in the aforementioned reaction formula 5,

In the chemical formula 20, R₁₆ and R₁₇ are respectively based on one amine selected from the group consisting of the structures of the aforementioned chemical formula 17. Moreover, R₁₈ and R₁₉ are respectively based on one carboxylic acid dihalide selected from the group consisting of the structures of the aforementioned chemical formula 18.

Then, several methods of manufacturing for the flexible metal clad laminate film of the present invention will be described as an example.

First of all, photoactive polymers are prepared. The photoactive polymers may be prepared by general methods for polymer synthesis. As an example, but not limited to, monomers having both photoactive functional group and reactive functional group such as amine, (thio)alcohol, halide, and so on, may be synthesized. And then, aforementioned monomers are polymerized by forming any of amide, imide, ester, ether and thioether bonds between them to prepare the photoactive polymer used in the present invention. As another example, main chain of a polymer, such as polyimide, poly(thio)ether, polycyanurate, poly(amide-imide), polyester, and so on may be synthesized first, and then a photoactive side chains is introduced to it so as to prepare the photoactive polymer used in the present invention.

A method of manufacturing for the flexible metal clad laminate film of the present invention, using the photoactive polymers prepared by above method, for example polycyanurate, poly(amide-imide), polyester, poly(thio)ether, and so on, is as follows.

A photoactive polymer solution is made by dissolving the prepared photoactive polymer in a solvent. The solvent is 30˜4000 of boiling point, 0.5˜1000 cps of viscosity. The solvent may be used as alone or a mixture of at least 2 kinds. For example, N-methylpyrrolidone (NMP) or N,N-dimethylacetamide (DMAC) is preferred. Moreover, the prepared photoactive polymer solution is 0.5˜60 wt % of concentration and 10˜1,000,000 cps of viscosity preferably.

The prepared photoactive polymer solution is applied on a metal thin film made of copper, platinum, gold, silver, aluminum, and so on, so as to form a coating layer. And then, the solvent in the coating layer is eliminated by heating, pressure reduction or airflow.

Subsequently, the surface of the solvent-free coating layer is irradiated to form a flexible insulating film. As a result, the flexible metal clad laminate film may be obtained. In this case, used light may be linearly polarized, partially polarized or non-polarized, and the light is irradiated on the surface of the coating layer obliquely or perpendicularly.

In case of photoactive polyimide, photoactive polyamic acid as a precursor of it is used because of its low solubility for solvent. Therefore, additional imidization process is necessary to form polyimide from the polyamic acid.

A manufacturing method for flexible metal clad laminate film using the polyamic acid solution is as follows.

First of all, photoactive polyamic acid solution as precursor of photoactive polyimide is prepared, and applied on a metal thin film to form a coating layer. The solvent in the coating layer is eliminated, and then the polyamic acid in the solvent-free coating layer is imidized to form a photoactive polyimide. Before or after the imidization process, the surface of the coating layer is irradiated to form a flexible insulating film by crosslinking the photoactive polyimide. Consequently, the flexible metal clad laminate film may be obtained by above process. All methods and conditions but additional imidization process are almost same as those of aforementioned other photoactive polymers.

In the present invention, it is preferred that the imidization process is performed after the crosslinking process by irradiation, since some problems in such as size stability of the flexible metal clad laminate film may be minimized during the imidization process under high temperature.

Hereinafter, a manufacturing method of another aspect of the present invention will be described in detail. In other word, the method is related to a flexible metal clad laminate film further comprising adhesive layer between a metal thin film and a flexible insulating film.

First of all, in the same manner of aforementioned methods and conditions, a photoactive polymer is prepared and then a photoactive polymer solution is prepared by dissolving the photoactive polymer in a solvent. The photoactive polymer solution is applied on a base plate such as, but not limited to, glass to form a coating layer. Subsequently, in the same manner of aforementioned methods and conditions, the solvent in the coating layer is eliminated, and the solvent-free coating layer is irradiated to form a flexible insulating film by crosslinking the photoactive polymer in the coating layer.

In case of a photoactive polyimide, the aforementioned photoactive polyamic acid solution is applied on a base plate such as, but not limited to, glass to form a coating layer. Subsequently, in the same manner of aforementioned methods and conditions, the solvent in the coating layer is eliminated, and the photoactive polyamic acid is imidized to form a photoactive polyimide. Before or after the imidization process, the solvent-free coating layer is irradiated to form a flexible insulating film by crosslinking the photoactive polyimide in the coating layer. In the same reason aforementioned, it is preferred that the imidization process is performed after the crosslinking process.

The flexible insulating film formed is peeled off from the base plate, and the peeled flexible insulating film and a metal thin film are adhered using an adhesive. Consequently, the flexible metal clad laminate film further comprising an adhesive layer may be obtained.

As mentioned above, since the flexible metal clad laminate film manufactured by the present invention includes the flexible insulating film of photo-crosslinked polymer resin, its size stability is improved, deflecting or twisting is minimized, and physical properties are good.

The present invention hereinafter described with reference to following examples and comparative examples. However, these examples should be understood only to illustrate the invention, and the present invention should not be construed to be limited thereto.

### PREPARATION EXAMPLE 1

### Preparation of Photoactive Polycyanurate

### PREPARATION EXAMPLE 1-1

### Photoactive Polycyanurate Having Side Chain of Cinnamate

(1) Synthesis of Triazine Monomer

10 g of 4-(2-tetrahydropyranyloxy)bromobenzene was dissolved into 50 ml of anhydrous tetrahydrofuran in three-neck flask filled with nitrogen, and then made to react upon magnesium for 24 hours. This solution was reacted at −20° C. for 12 hours in a three-neck flask filled with nitrogen while slowly dropping into a solution where 7.17 g of 2,4,6-trichloro-1,3,5-s-triazine were dissolved in 200 ml of anhydrous tetrahydrofuran. After the reaction, the reaction solution was decompressed at a room temperature to remove the tetrahydrofuran, and then dissolved in ethylacetate. After mixing this solution with basic solution and severely agitating it to extract impurities, aqueous phase was separated and removed from the solution, and then the solution was decompressed at a room temperature to remove ethylacetate. The solid phase material remaining after the removal of solvent is recrystallized in n-hexane to obtain 8.2 g of triazine monomer.

(2) Polymeriztion of Polycyanurate

3.77 g of Bisphenol A, 1.23 g of sodium hydroxide, and 0.59 g of cetyldimethylbenzylammonium chloride were dissolved in 100 ml of distilled water. This solution was transferred into 1-neck flask where 5.13 g of the triazine monomer obtained in a way of (1) of the manufacturing example 1-1 was dissolved in 50 ml of chloroform. And then the mixure was stirred for 12 hours. After the reaction, the resulting solution was slowly dropped into methanol to form a precipitate, and then the precipitate was separated by filtration under reduced pressure. The obtained solid material was dried under vacuum at 40° C. to produce 4.4 g of polycyanurate.

(3) Reforming of Polycyanurate

3.5 g of polycyanurate obtained in a way of (2) of the manufacturing example 1-1 was dissolved in 40 ml of tetrahydrofuran and 15 ml of ethanol. 0.18 g of pyridinium p-toluenesulfonate was added to the above solution, and reacted at room temperature for 24 hours. After the reaction, the reacted solution was dropped slowly into methanol to form a precipitate, which was filtered and isolated. The precipitate was dried under vacuum at 40° C. to form 2.1 g of polycyanurate having hydroxy group.

(4) Introduction of Cinnamate Photoactive Group

3 g of polycyanurate having hydroxy group was dissolved in 25 ml of tetrahydrofuran and 5.57 ml of triethylamine. A solution of 7.16 g of cinnamoyl chloride dissolved in 5 ml of tetrahydrofuran was dropped into the above solution at 0° C., and reacted for 2 hours. After the reaction, the reacted solution was dropped slowly into methanol to form a polymer, which was filtered and isolated. That process was repeated twice. The precipitate was dried under vacuum at 40° C. to form 3.2 g of polycyanurate having photoactive side chains of cinnamate group.

### MANUFACTURING EXAMPLE 1-2

### Photoactive Polycyanurate Having Side Chains of Chalcone Group

(1) Synthesis of Chalcone Photoactive Group

10 g of 4-methoxy chalcone and 2.05 g of sodium cyanide were dissolved into 100 ml of dimethyl-sulfoxide, and then reacted during 24 hours. After the reaction, the reacted solution was mixed with chloroform and stirred together with distilled water so as to extract impurities. After removing the aqueous solution phase, the solution was decompressed at a room temperature in order to eliminate chloroform. After recrystallizing the remained solid phase in methanol, the solid was dried at 40° C. under vacuum to obtain 5.4 g of 4-hydroxychalcone for photoreaction.

(2) Introduction of a Chalcone Functional Group 5 g of 4-hydroxychalcone and 6.14 g of polycyanurate having hydroxy group synthesized in a way of (3) of the manufacturing example 1-1 were dissolved in 60 ml of tetrahydrofuran. 0.38 g of diethylazodicarboxylate and 0.58 g of triphenylphosphine was added to the above solution, and reacted at room temperature for 24 hours. After the reaction, the reacted solution was dropped slowly into methanol to form a polymer material, which was filtered under reduced pressure. That process was repeated twice. The precipitate was dried under vacuum at 40° C. to form 5.7 g of polycyanurate having chalcone photoactive side chain.

### MANUFACTURING EXAMPLE 1-3

### Photoactive Polycyanurate Having Side Chain of Coumarin Group

(1) Introduction of Coumarin Photoactive Group

3.57 g of 7-hydroxycoumarin and 6.14 g of polycyanurate having hydroxy group synthesized in a way of (3) of the manufacturing example 1-1 were dissolved in 60 ml of tetrahydrofuran. 0.38 g of diethylazodicarboxylate and 0.58 g of triphenylphosphine was added to the above solution, and reacted at room temperature for 24 hours. After the reaction, the reacted solution was dropped slowly into methanol to form a polymer, which was filtered under reduced pressure. That process was repeated twice. The precipitate was dried under vacuum at 40° C. to form 5.3 g of polycyanurate having photoactive side chains of coumarin groups.

### MANUFACTURING EXAMPLE 2

### Synthesis of Photoactive Polyester

### MANUFACTURING EXAMPLE 2-1

### Photoactive Polyester Having Side Chains of Cinnamate Group

(1) Introduction of Alcolhol Functional Group

90 g of 4-(2-tetrahydropyranyloxy)bromobenzene was put into into a 3-neck flask filled with nitrogen, then dissolved with 500 ml of anhydrous tetrahydrofuran, and reacted with 9.6 g of magnesium for 3 hours. While the above solution was dropped into a solution of a cyanuric chloride (18.4 g) dissolved in tetrahydrofuran (200 ml), the mixture was severely stirred and reacted for 6 hours at refluxing temperature.

After the reaction, 3 g of pyridinium p-toluenesulfonate was added to the solution and further reacted for 6 hours. After the reaction, the reacted solution was distilled under reduced pressure to remove tetrahydrofuran, and then the solution was dissolved by methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 30.1 g of 2,4,6-trihydroxyphenyl-1,3,5-triazine.

(2) Synthesis of Diol Monomer Having Cinnamoyl Group

14.8 g of cinnamic acid was put into a round bottom flask. 17.8 g of thionyl chloride (SOCl₂) was added to it, and the mixture was stirred. Additionally 0.5 ml of dimethyl formamide (DMF) was added to the flask, and the mixture was reacted at room temperature for 24 hours. After the reaction, it was distilled under reduced pressure to obtain 16 g of cinnamoyl chloride.

35.7 g of 2,4,6-trihydroxyphenyl-1,3,5-triazine obtained in a way of (1) of the manufacturing example 2-1 was put into a round bottom flask, and dissolved in 400 ml of chloroform. After adding 15.2 g of triethylamine to this solution and then lowering the temperature of the solution to −5° C., the solution was severely stirred and reacted for 12 hours with slowly dropping a cinnamoyl chloride solution diluted by putting 20 ml of anhydrous tetrahydrofuran into 16 g of cinnamoyl chloride.

After the reaction, the reacted solution was distilled under reduced pressure to remove tetrahydrofuran, and then the solution was dissolved by methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 36.7 g of diol monomer having cinnamoyl functional group.

(3) Polymerization of Polyester Having a Cinnamate Functional Group

48.7 g of the triazine monomer obtained in the way of (2) of the manufacturing example 2-1 was put into a round bottom flask filled with nitrogen and then dissolved by 400 ml of tetrahydrofuran. 20.238 g of triethylamine was added to the solution.

After dissolving 20.3 g of terephthaloyl chloride in 100 ml of anhydrous tetrahydrofuran, the solution was severely stirred and reacted for 12 hours while slowly dropping it into a solution in which the above-mentioned triazine monomer and triethylamine were dissolved. After the reaction, the reacted solution was slowly poured into methanol to form a precipitate. The precipitate was filtered and dried under vacuum. The process for dissolving the obtained precipitate again in tetrahydrofuran and then precipitating in methanol was repeated twice, and then it was dried under vacuum to finally obtain 37.1 g of polyester having a cinnamate functional group with the use of a triazine ring.

### MANUFACTURING EXAMPLE 2-2

### Photoactive Polyester Having Side Chains of Chalcone Groups

(1) Synthesis of Chalcone Photoactive Group

10 g of 4-methoxy chalcone and 2.05 g of sodium cyanide were dissolved into 100 ml of dimethyl-sulfoxide, and then reacted during 24 hours. After the reaction, the reacted solution was mixed with chloroform and stirred together with distilled water so as to extract impurities. After removing the aqueous solution phase, the solution was decompressed at a room temperature in order to eliminate chloroform. After recrystallizing the remained solid phase in methanol, the solid was dried under vacuum to obtain 20.1 g of 4-hydroxychalcone for photoreaction.

(2) Introduction of a Chalcone Functional Group into a Triazine Ring

23.8 g of 4-hydroxchalcone synthesized in a way of (1) of the manufacturing example 2-2 was put into a round bottom flask filled with nitrogen and then dissolved in 240 ml of anhydrous tetrahydrofuran. 2.4 g of sodium hydride (NaH) was added to the solution and reacted at a room temperature for 6 hours. The solution was reacted at −5° C. for 24 hours by severely stirring with slowly dropping into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 30.2 g of triazine derivative having chalcone functional group.

(3) Synthesis of a Triazine Monomer Having Diol Functional Group

51.4 g of 4-(2-tetrahydropyranyloxy)bromobenzene was dissolved in 300 ml of anhydrous tetrahydrofuran under nitrogen, and reacted with 7.2 g of magnesium for 3 hours to form Grignard reagent solution. The solution of 38.6 g of the triazine having chalcone photoactive group obtained in a way of (2) of the manufacturing method 2-2 dissolved in 300 ml of anhydrous tetrahydrofuran, was reacted for 12 hours at room temperature with slowly dropping it into the Grignard reagent solution. After the reaction, 3 g of pyridinium p-toluenesulfonate was added to the solution and further reacted for 6 hours. After the reaction, the reacted solution was distilled under reduced pressure to remove tetrahydrofuran, and then the solution was dissolved by methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 42.3 g of a triazine monomer having diol functional group.

(4) Polymerization of Polyester Having a Chalcone Functional Group

50.1 g of the triazine monomer obtained in the way of (3) of the manufacturing example 2-2 was put into a round bottom flask filled with nitrogen and dissolved by 500 ml of anhydrous tetrahydrofuran. 20.2 g of triethylamine was added to the solution. 20.3 g of terephthaloyl chloride was dissolved in 100 ml of anhydrous tetrahydrofuran, and then with slowly dropping it into the above-mentioned solution in which the triazine monomer and triethylamine were dissolved, the solution was severely stirred and reacted for 12 hours. After the reaction, the reacted solution was slowly poured into methanol for precipitation, filtered and dried under vacuum. The process for dissolving the obtained polymer again in tetrahydrofuran and then precipitating in methanol was repeated twice, and then it was dried under vacuum to finally obtain 42.1 g of photoactive polyester having a chalcone functional group.

### MANUFACTURING EXAMPLE 2-3

### Photoactive Polyester Having Side Chains of Coumarin Groups

(1) Introduction of a Coumarin Photoactive Group

16.2 g of 7-hydroxycoumarin and 2.4 g of sodium hydride (NaH) were put into a round bottom flask filled with nitrogen, and then they were dissolved into 160 ml of anhydrous tetrahydrofuran. After that, the solution was severely stirred and reacted for 6 hours. This solution was severely stirred and reacted for 24 hours at −5° C. with slowly dropping it into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 28.7 g of triazine derivative having a coumarin functional group.

(2) Synthesis of a Triazine Monomer Having Diamine Functional Group

51.4 g of 4-(2-tetrahydropyranyloxy)bromobenzene was dissolved in 300 ml of anhydrous tetrahydrofuran under nitrogen, and reacted with 7.2 g of magnesium for 6 hours to form Grignard reagent solution. The solution of 31.1 g of the triazine having coumarin photoactive group obtained in a way of (1) of the manufacturing method 2-3 dissolved in 300 ml of anhydrous tetrahydrofuran, was reacted for 12 hours at room temperature with slowly dropping it into the Grignard reagent solution. After the reaction, 3 g of pyridinium p-toluenesulfonate was added to the solution and further reacted for 6 hours. After the reaction, the reacted solution was distilled under reduced pressure to remove tetrahydrofuran, and then the obtained solid was dissolved in methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 35.7 g of a triazine monomer having diol functional group.

(3) Polymerization of Polyester Having a Coumarin Functional Group

45.5 g of the triazine monomer obtained in the way of (2) of the manufacturing example 2-3 was put into a round bottom flask filled with nitrogen and dissolved by 500 ml of tetrahydrofuran. 20.2 g of triethylamine was added to the solution. 20.3 g of terephthaloyl chloride was dissolved in 100 ml of anhydrous tetrahydrofuran, and then with slowly dropping it into the above-mentioned solution in which the triazine monomer and triethylamine were dissolved, the solution was severely stirred and reacted for 12 hours. After the reaction, the reacted solution was slowly poured into methanol for precipitation, filtered and dried under vacuum. The process for dissolving the obtained polymer again in tetrahydrofuran and then precipitating in methanol was repeated twice, and then it was dried under vacuum to finally obtain 35.6 g of polyester having a coumarin functional group.

### MANUFACTURING EXAMPLE 3

### Synthesis of Photoactive Polyether

### MANUFACTURING EXAMPLE 3-1

### Photoactive Polyether Having Side Chains of Cinnamate Groups

(1) Reforming of Triazine Ring

25.7 g of 4-(2-tetrahydropyranyloxy)bromobenzene was dissolved into 250 ml of anhydrous tetrahydrofuran in three-neck flask filled with nitrogen, and then made to react upon 3 g of magnesium for 24 hours. This solution was reacted at −20° C. for 12 hours in a three-neck flask filled with nitrogen while slowly dropping it into a solution of 18.4 g of cyanuric chloride in 200 ml of anhydrous tetrahydrofuran.

After the reaction, the reacted solution was decompressed at a room temperature to remove the tetrahydrofuran, and then dissolved in ethylacetate. After mixing this solution with basic solution and severely stirring it to extract impurities, aqueous phase was separated and removed from the solution, and then the solution was decompressed at a room temperature to remove ethylacetate.

The solid phase material remaining after the removal of solvent is recrystallized in n-hexane to obtain 30 g of 2-(4-(2-tetrahydropyranyloxy)phenyl)-4,6-dichloro-1,3,5-triazine.

(2) Introduction of a Hydroxy Functional Group into a Triazine Ring

After putting 32.6 g of the material obtained in (1) of the manufacturing example 3-1 into a round bottom flask and then dissolving it with 300 ml of tetrahydrofuran, 0.3 g of pyridinum-paratoluene-sulfonate was additionally put into the flask and 50 ml of ethanol is added for reaction for 24 hours.

After the reaction, the solvent was removed by distillation under reduced pressure, and then remained solids were dissolved again by methylene-chloride and then blended with distilled water in a separating funnel to extract impurities twice. Calcium chloride was put into the methylene chloride solution to remove moisture, and then the solvent was removed again through distillation under reduced pressure. This solid phase was recrystallized in a mixed solvent of methylene chloride and n-hexane to obtain 20 g of 2-(4-hydroxyphenyl)-4,6-dichloro-1,3,5-triazine.

(3) Synthesis of a Triazine Ring Having Cinnamate Side Chain

24.2 g of the triazine derivative obtained in (2) of the manufacturing example 3-1 was put into a round bottom flask filled with nitrogen and then dissolved with 200 ml of anhydrous tetrahydrofuran. After adding 15.2 g of triethylamine to this solution and then lowering the temperature of the solution to −5° C., the solution was severely stirred and reacted for 12 hours with slowly dropping a cinnamoyl chloride solution diluted by putting 100 ml of anhydrous tetrahydrofuran into 25 g of cinnamoyl chloride.

After the reaction, the reacted solution was distilled under reduced pressure to remove tetrahydrofuran, and then the remained solid was dissolved in methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 31 g of a triazine derivative having a cinnamate side chain.

(4) Synthesis of a Triazine Monomer Having Dihalide Functional Group

37.2 g of the triazine derivative obtained in a way of (3) of the manufacturing example 3-1 was put into a round bottom flask and dissolved in 400 ml of chloroform. 25.6 g of 4-chlorophenol and 8 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 50.5 g of a triazine monomer.

(5) Polymerization of Polyether Having a Cinnamate Functional Group

55.3 g of the triazine monomer obtained in the way of (4) of the manufacturing example 3-1 was put into a round bottom flask filled with nitrogen and then dissolved by 600 ml of nitrobenzene. The solution of 11 g of hydroquinone, 8 g of sodium hydroxide, and 0.3 g of cetyltrimethylammonium bromide dissolved in 100 ml of water, the nitrobenzene solution in which the above-mentioned triazine monomer was dissolved were mixed, severely stirred and reacted for 24 hours. After the reaction, the reacted solution was slowly poured into methanol to form a precipitate, the precipitate was filtered and dried under vacuum. The process for dissolving the obtained polymer again in tetrahydrofuran and then precipitating in methanol was repeated twice, and then it was dried under vacuum to finally obtain 35.9 g of polyether having a cinnamate functional group.

### MANUFACTURING EXAMPLE 3-2

### Photoactive Polyether Polymer Having Side Chain of Chalcone Group

(1) Synthesis of Chalcone Photoactive Group

10 g of 4-methoxy chalcone and 2.05 g of sodium cyanide were dissolved into 100 ml of dimethyl-sulfoxide, and then reacted during 24 hours. After the reaction, the reacted solution was mixed with chloroform and stirred together with distilled water so as to extract impurities. After removing the aqueous solution phase, the solution was decompressed at a room temperature in order to eliminate chloroform. After recrystallizing the remained solid phase in methanol, the solid was dried under vacuum at 40° C. to obtain 23 g of 4-hydroxychalcone for photoreaction.

(2) Introduction of a Chalcone Functional Group into a Triazine Ring

23.8 g of 4-hydroxchalcone synthesized in a way of (1) of the manufacturing example 3-2 was put into a round bottom flask filled with nitrogen and then dissolved in 240 ml of anhydrous tetrahydrofuran. 2.4 g of sodium hydride (NaH) was added to the solution and reacted at a room temperature for 6 hours. The solution was reacted at −5° C. for 24 hours by severely stirring with slowly dropping into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 20 g of triazine derivative having chalcone functional group.

(3) Synthesis of a Triazine Monomer having Dihalide Functional Group

38.6 g of the triazine derivative having chalcone photoactive group obtained in a way of (2) of the manufacturing example 3-2 was put into a round bottom flask and dissolved with 400 ml of chloroform. 25.6 g of 4-chlorophenol and 8 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 50 g of a triazine monomer.

(4) Polymerization of Polyether Having a Chalcone Functional Group

56.7 g of the triazine monomer obtained in the way of (3) of the manufacturing example 3-2 was put into a round bottom flask filled with nitrogen and then dissolved by 600 ml of nitrobenzene. The solution of 11 g of hydroquinone, 8 g of sodium hydroxide, and 0.3 g of cetyltrimethylammonium bromide dissolved in 100 ml of water was mixed with the nitrobenzene solution in which the above-mentioned triazine monomer was dissolved, severely stirred and reacted for 24 hours. After the reaction, the reacted solution was slowly poured into methanol to form a precipitate, the precipitate was filtered and dried under vacuum. The process for dissolving the obtained polymer again in tetrahydrofuran and then precipitating in methanol was repeated twice, and then it was dried under vacuum to finally obtain 37.2 g of polyether having a chalcone functional group.

### MANUFACTURING EXAMPLE 3-3

### Photoactive Polyether Polymer Having Side Chain of Coumarin Group

(1) Introduction of a Coumarin Photoactive Group

16.2 g of 7-hydroxycoumarin and 2.4 g of sodium hydride (NaH) were put into a round bottom flask filled with nitrogen, and then they were dissolved into 160 ml of anhydrous tetrahydrofuran. After that, the solution was severely stirred and reacted for 6 hours. This solution was severely stirred and reacted for 24 hours at −5° C. with slowly dropping it into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 22 g of triazine derivative having a coumarin functional group.

(2) Synthesis of a Triazine Monomer Having Dihalide Functional Group

31.1 g of the triazine derivative having coumarin photoactive group obtained in a way of (1) of the manufacturing example 3-3 was put into a round bottom flask and dissolved with 400 ml of chloroform. 25.6 g of 4-chlorophenol and 8 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 45 g of a triazine monomer.

(3) Polymerization of Polyether Having a Coumarin Functional Group

49.1 g of the triazine monomer obtained in the way of (2) of the manufacturing example 3-3 was put into a round bottom flask filled with nitrogen and then dissolved by 600 ml of nitrobenzene. The solution of 11 g of hydroquinone, 8 g of sodium hydroxide, and 0.3 g of cetyltrimethylammonium bromide dissolved in 100 ml of water was mixed with the nitrobenzene solution in which the above-mentioned triazine monomer was dissolved, severely stirred and reacted for 24 hours. After the reaction, the reacted solution was slowly poured into methanol to form a precipitate, the precipitate was filtered and dried under vacuum. The process for dissolving the obtained precipitate again in tetrahydrofuran and then precipitating in methanol was repeated twice, and then it was dried under vacuum to finally obtain 32.3 g of polyether having a coumarin functional group.

### MANUFACTURING EXAMPLE 4

### Synthesis Photoactive Polythioether

### MANUFACTURING EXAMPLE 4-1

### Photoactive Polythioether Having Side Chains of Cinnamate Groups

(1) Reforming of Triazine Ring

25.7 g of 4-(2-tetrahydropyranyloxy)bromobenzene was dissolved into 250 ml of anhydrous tetrahydrofuran in three-neck flask filled with nitrogen, and then made to react upon 3 g of magnesium for 24 hours. This solution was reacted at −20° C. for 12 hours in a three-neck flask filled with nitrogen while slowly dropping it into a solution of 18.4 g of cyanuric chloride in 200 ml of anhydrous tetrahydrofuran.

After the reaction, the reacted solution was decompressed at a room temperature to remove the tetrahydrofuran, and then dissolved in ethylacetate. After mixing this solution with basic solution and severely stirring it to extract impurities, aqueous phase was separated and removed from the solution, and then the solution was decompressed at a room temperature to remove ethylacetate.

The solid phase material remaining after the removal of solvent is recrystallized in n-hexane to obtain 30.1 g of 2-(4-(2-tetrahydropyranyloxy)phenyl)-4,6-dichloro-1,3,5-triazine.

(2) Introduction of a Hydroxy Functional Group into a Triazine Ring

After putting 32.6 g of the material obtained in (1) of the manufacturing example 4-1 into a round bottom flask and then dissolving it with 300 ml of tetrahydrofuran, 0.3 g of pyridinum-paratoluene-sulfonate was additionally put into the flask and 50 ml of ethanol was added for reaction for 24 hours.

After the reaction, the solvent was removed by distillation under reduced pressure, and then remained solids were dissolved again by methylene-chloride and then blended with distilled water in a separating funnel to extract impurities twice. Calcium chloride was put into the methylene chloride solution to remove moisture, and then the solvent was removed again through distillation under reduced pressure. This solid phase was recrystallized in a mixed solvent of methylene chloride and n-hexane to obtain 20.5 g of 2-(4-hydroxyphenyl)-4,6-dichloro-1,3,5-triazine.

(3) Synthesis of a Triazine Ring Having Cinnamate Side Chain

24.2 g of the triazine derivative obtained in (2) of the manufacturing example 4-1 was put into a round bottom flask filled with nitrogen and then dissolved with 200 ml of anhydrous tetrahydrofuran. After adding 15.2 g of triethylamine to this solution and then lowering the temperature of the solution to −5° C., the solution was severely stirred and reacted for 12 hours with slowly dropping a cinnamoyl chloride solution diluted by putting 100 ml of anhydrous tetrahydrofuran into 25 g of cinnamoyl chloride.

After the reaction, the reacted solution was distilled under reduced pressure to remove tetrahydrofuran, and then the remained solid was dissolved in methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 30.2 g of a triazine derivative having a cinnamate side chain.

(4) Synthesis of a Triazine Monomer Having Dihalide Functional Group

37.2 g of the triazine derivative obtained in a way of (3) of the manufacturing example 4-1 was put into a round bottom flask and dissolved with 400 ml of chloroform. 25.6 g of 4-chlorophenol and 8 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 50.3 g of a triazine monomer.

(5) Polymerization of Polythioether Having a Cinnamate Functional Group

55.3 g of the triazine monomer obtained in the way of (4) of the manufacturing example 4-1 was put into a round bottom flask filled with nitrogen and then dissolved by 600 ml of nitrobenzene. The solution of 14.2 g of 1,4-phenyldithiol, 8 g of sodium hydroxide, and 0.3 g of cetyltrimethylammonium bromide dissolved in 100 ml of water, and the nitrobenzene solution in which the above-mentioned triazine monomer was dissolved, were mixed, severely stirred and reacted for 24 hours. After the reaction, the reacted solution was slowly poured into methanol to form a precipitate, the precipitate was filtered and dried under vacuum. The process for dissolving the obtained polymer again in tetrahydrofuran and then precipitating in methanol was repeated twice, and then it was dried under vacuum to finally obtain 35.9 g of polythioether having a cinnamate functional group.

### MANUFACTURING EXAMPLE 4-2

### Photoactive Polythioether Having Side Chain of Chalcone Group

(1) Synthesis of Chalcone Photoactive Group

10 g of 4-methoxy chalcone and 2.05 g of sodium cyanide were dissolved into 100 ml of dimethyl-sulfoxide, and then reacted during 24 hours. After the reaction, the reacted solution was mixed with chloroform and stirred together with distilled water so as to extract impurities. After removing the aqueous solution phase, the solution was decompressed at a room temperature in order to eliminate chloroform. After recrystallizing the remained solid phase in methanol, the solid was dried under vacuum at 40° C. to obtain 20.7 g of 4-hydroxychalcone for photoreaction.

(2) Introduction of a Chalcone Functional Group into a Triazine Ring

23.8 g of 4-hydroxchalcone synthesized in a way of (1) of the manufacturing example 4-2 was put into a round bottom flask filled with nitrogen and then dissolved in 240 ml of anhydrous tetrahydrofuran. 2.4 g of sodium hydride (NaH) was added to the solution and reacted at a room temperature for 6 hours. The solution was reacted at −5° C. for 24 hours by severely stirring with slowly dropping into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 31.6 g of triazine derivative having chalcone functional group.

(3) Synthesis of a Triazine Monomer Having Dihalide Functional Group

38.6 g of the triazine derivative having chalcone photoactive group obtained in a way of (2) of the manufacturing example 4-2 was put into a round bottom flask and dissolved with 400 ml of chloroform. 25.6 g of 4-chlorophenol and 8 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 50.2 g of a triazine monomer.

(4) Polymerization of Polyether Having a Chalcone Functional Group

56.7 g of the triazine monomer obtained in the way of (3) of the manufacturing example 4-2 was put into a round bottom flask filled with nitrogen and then dissolved by 600 ml of nitrobenzene. The solution of 14.2 g of phenyldithiol, 8 g of sodium hydroxide, and 0.3 g of cetyltrimethylammonium bromide dissolved in 100 ml of water was mixed with the nitrobenzene solution in which the above-mentioned triazine monomer was dissolved, severely stirred and reacted for 24 hours. After the reaction, the reacted solution was slowly poured into methanol to form a precipitate, the precipitate was filtered and dried under vacuum. The process for dissolving the obtained polymer again in tetrahydrofuran and then precipitating in methanol was repeated twice, and then it was dried under vacuum to finally obtain 35.2 g of polythioether having a chalcone functional group.

### MANUFACTURING EXAMPLE 4-3

### Photoactive Polythioether Having Side Chain of Coumarin Group

(1) Introduction of a Coumarin Photoactive Group

16.2 g of 7-hydroxycoumarin and 2.4 g of sodium hydride (NaH) were put into a round bottom flask filled with nitrogen, and then they were dissolved into 160 ml of anhydrous tetrahydrofuran. After that, the solution was severely stirred and reacted for 6 hours. This solution was severely stirred and reacted for 24 hours at −5° C. with slowly dropping it into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 29.7 g of triazine derivative having a coumarin functional group.

(2) Synthesis of a Triazine Monomer Having Dihalide Functional Group

31.1 g of the triazine derivative having coumarin photoactive group obtained in a way of (1) of the manufacturing example 4-3 was put into a round bottom flask and dissolved with 400 ml of chloroform. 25.6 g of 4-chlorophenol and 8 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 40.2 g of a triazine monomer.

(3) Polymerization of Polythioether Having a Coumarin Functional Group

49.1 g of the triazine monomer obtained in the way of (2) of the manufacturing example 4-3 was put into a round bottom flask filled with nitrogen and then dissolved by 600 ml of nitrobenzene. The solution of 14.2 g of 1,4-phenyldithiol, 8 g of sodium hydroxide, and 0.3 g of cetyltrimethylammonium bromide dissolved in 100 ml of water was mixed with the nitrobenzene solution in which the above-mentioned triazine monomer was dissolved, severely stirred and reacted for 24 hours. After the reaction, the reacted solution was slowly poured into methanol to form a precipitate, the precipitate was filtered and dried under vacuum. The process for dissolving the obtained precipitate again in tetrahydrofuran and then precipitating in methanol was repeated twice, and then it was dried under vacuum to finally obtain 37 g of polythioether having a coumarin functional group.

### MANUFACTURING EXAMPLE 5

### Synthesis Photoactive Poly(Amide-Imide)

### MANUFACTURING EXAMPLE 5-1

### Photoactive Poly(Amide-Imide) Having Side Chains of Cinnamate Groups

(1) Reforming of Triazine Ring

27.1 g of 4-(2-tetrahydropyranyl methoxy)bromobenzene was dissolved into 250 ml of anhydrous tetrahydrofuran in three-neck flask filled with nitrogen, and then made to react upon 3 g of magnesium for 24 hours. This solution was reacted at −20° C. for 12 hours in a three-neck flask filled with nitrogen while slowly dropping it into a solution of 18.4 g of cyanuric chloride in 200 ml of anhydrous tetrahydrofuran.

After the reaction, the reaction solution was decompressed at a room temperature to remove the tetrahydrofuran, and then dissolved in ethylacetate. After mixing this solution with basic solution and severely stirring it to extract impurities, aqueous phase was separated and removed from the solution, and then the solution was decompressed at a room temperature to remove ethylacetate.

The solid phase material remaining after the removal of solvent is recrystallized in n-hexane to obtain 30 g of 2-(4-(2-tetrahydropyranylmethoxy)phenyl)-4,6-dichloro-1,3,5-triazine.

(2) Introduction of a Hydroxy Functional Group into a Triazine Ring

After putting 34.0 g of the material obtained in (1) of the manufacturing example 5-1 into a round bottom flask and then dissolving it with 300 ml of tetrahydrofuran, 0.3 g of pyridinum-paratoluene-sulfonate was additionally put into the flask and 50 ml of ethanol is added for reaction for 24 hours.

After the reaction, the solvent was removed by distillation under reduced pressure, and then remained solids were dissolved again by methylene-chloride and then blended with distilled water in a separating funnel to extract impurities twice. Calcium chloride was put into the methylene chloride solution to remove moisture, and then the solvent was removed again through distillation under reduced pressure. This solid phase was recrystallized in a mixed solvent of methylene chloride and n-hexane to obtain 20.6 g of 2-(4-hydroxyphenyl)-4,6-dichloro-1,3,5-triazine.

(3) Synthesis of a Triazine Ring Having Cinnamate Side Chain

25.6 g of the triazine derivative obtained in (2) of the manufacturing example 5-1 was put into a round bottom flask filled with nitrogen and then dissolved with 200 ml of anhydrous tetrahydrofuran. After adding 15.2 g of triethylamine to this solution and then lowering the temperature of the solution to −5-C, the solution was severely stirred and reacted for 12 hours with slowly dropping a cinnamoyl chloride solution diluted by putting 100 ml of anhydrous tetrahydrofuran into 25 g of cinnamoyl chloride.

After the reaction, the reacted solution was distilled under reduced pressure to remove tetrahydrofuran, and then the solution was dissolved by methylene chloride, passed through a filter filled with silica gels and was then distilled under reduced pressure to remove the solvent.

Finally, after recrystallization in a mixed solvent of methylene chloride and n-hexane, the solution was filtered under reduced pressure. The obtained solid phase material was dried under vacuum to obtain 35.1 g of a triazine derivative having a cinnamate side chain.

(4) Synthesis of a Triazine Monomer Having Diamine Functional Group

38.6 g of the triazine derivative obtained in a way of (3) of the manufacturing example 5-1 was put into a round bottom flask and dissolved with 400 ml of chloroform. 32.8 g of 4-aminophenol and 12 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 49.2 g of a triazine monomer.

(5) Polymerization of Poly(Amide-Imide) Having a Cinnamate Functional Group

53.156 g of the triazine monomer obtained in the way of (4) of the manufacturing example 5-1 was put into a round bottom flask filled with nitrogen and then dissolved by 400 ml of tetrahydrofuran. 20.238 g of triethylamine was added to the solution.

After dissolving 10.15 g of terephthaloyl chloride in 100 ml of anhydrous tetrahydrofuran, the solution was severely stirred and reacted for 6 hours while slowly dropping it into a solution in which the above-mentioned triazine monomer and triethylamine were dissolved. This solution was additionally reacted for 6 hours while slowly dropping a solution, in which 10.9 g of 1,2,4,5-benzenetetracarboxylic acid dianhydride was dissolved in 100 ml of N-methyl-pyrrolidone, into the above solution.

After the reaction, the reacted solution was slowly poured into methanol for precipitation, filtering and drying a polymer under vacuum. The process for dissolving the obtained polymer again in tetrahydrofuran and then precipitating in methanol was repeated twice, and then it is dried under vacuum to finally obtain 40.1 g of poly(amide-imide) copolymer having a cinnamate functional group with the use of a triazine ring.

### MANUFACTURING EXAMPLE 5-2

### Photoactive Poly(Amide-Imide) Having Side Chains of Chalcone Groups

(1) Synthesis of Chalcone Photoactive Group

10 g of 4-methoxy chalcone and 2.05 g of sodium cyanide were dissolved into 100 ml of dimethyl-sulfoxide, and then reacted during 24 hours. After the reaction, the reacted solution was mixed with chloroform and stirred together with distilled water so as to extract impurities. After removing the aqueous solution phase, the solution was decompressed at a room temperature in order to eliminate chloroform. After recrystallizing the remained solid phase in methanol, the solid was dried under vacuum to obtain 19.7 g of 4-hydroxychalcone for photoreaction.

(2) Introduction of a Chalcone Functional Group into a Triazine Ring

23.8 g of 4-hydroxchalcone synthesized in a way of (1) of the manufacturing example 5-2 was put into a round bottom flask filled with nitrogen and then dissolved in 240 ml of anhydrous tetrahydrofuran. 2.4 g of sodium hydride (NaH) was added to the solution and reacted at a room temperature for 6 hours. The solution was reacted at −5° C. for 24 hours by severely stirring with slowly dropping into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 31.3 g of triazine derivative having chalcone functional group.

(3) Synthesis of a Triazine Monomer Having Diamine Functional Group

38.6 g of the triazine derivative having a chalcone functional group synthesized in a way of (2) of the manufacturing example 5-2 was put into a round bottom flask and dissolved by 300 ml of chloroform. In addition, 32.8 g of 4-aminophenol and 12 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated and moved to a separating funnel and washed three times with distilled water to extract impurities. And then, moisture was removed by calcium chloride. The solution was distilled under reduced pressure to remove chloroform, and then recrystallized in a mixed solvent of methylene chloride and n-hexane. The deposited crystal was filtered under reduced pressure and then dried under vacuum to obtain 48.7 g of a triazine monomer.

(4) Polymerization of Poly(Amide-Imide) Having a Chalcone Functional Group

53.15 g of the triazine monomer obtained in the way of (3) of the manufacturing example 5-2 was put into a round bottom flask filled with nitrogen and dissolved by 400 ml of anhydrous tetrahydrofuran. 20.24 g of triethylamine was added to the solution. 10.15 g of terephthaloil chloride was dissolved in 100 ml of anhydrous tetrahydrofuran, and then with slowly dropping it into the above-mentioned solution in which the triazine monomer and triethylamine were dissolved, the solution was severely stirred and reacted for 6 hours. While dropping a solution, in which 10.9 g of 1,2,4,5-benzenetetracarboxylic acid dianhydride was dissolved in 100 ml of N-methyl-pyrrolidone, the above-mentioned solution was additionally reacted for 6 hours. After the reaction, the reacted solution was slowly poured into methanol for precipitation, filtered and dried under vacuum. The process for dissolving the obtained polymer again in tetrahydrofuran and then precipitating in methanol was repeated twice, and then it was dried under vacuum to finally obtain 42.2 g of poly(amide-imide) copolymer having a chalcone functional group.

### MANUFACTURING EXAMPLE 5-3

### Photoactive Poly(Amide-Imide) Polymer Having Side Chain of Coumarin Group

(1) Introduction of a Coumarin Photoactive Group

16.2 g of 7-hydroxycoumarin and 2.4 g of sodium hydride (NaH) were put into a round bottom flask filled with nitrogen, and then they were dissolved into 160 ml of anhydrous tetrahydrofuran. After that, the solution was severely stirred and reacted for 6 hours. This solution was severely stirred and reacted for 24 hours at −5° C. with slowly dropping it into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water in a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 28.2 g of triazine derivative having a coumarin functional group.

(2) Synthesis of a Triazine Monomer having Diamine Functional Group

31.1 g of the triazine derivative having a coumarin functional group synthesized in a way of (1) of the manufacturing example 5-3 was put into a round bottom flask and dissolved by 300 ml of chloroform. 32.8 g of 4-aminophenol and 12 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated and moved to a separating funnel and washed three times with distilled water to extract impurities. And then, moisture was removed by calcium chloride. The solution was distilled under reduced pressure to remove chloroform, and then recrystallized in a mixed solvent of methylene chloride and n-hexane. The deposited crystal was filtered under reduced pressure and then dried under vacuum to obtain 41.6 g of a triazine monomer.

(3) Polymerization of Poly(Amide-Imide) Having a Coumarin Functional Group

45.54 g of the triazine monomer obtained in the way of (2) of the manufacturing example 5-3 was put into a round bottom flask filled with nitrogen and dissolved by 400 ml of tetrahydrofuran. 20.24 g of triethylamine was added to the solution. 10.15 g of terephthaloyl chloride was dissolved in 100 ml of anhydrous tetrahydrofuran, and then with slowly dropping it into the above-mentioned solution in which the triazine monomer and triethylamine were dissolved, the solution was severely stirred and reacted for 6 hours. While dropping a solution, in which 10.9 g of 1,2,4,5-benzenetetracarboxylic acid dianhydride was dissolved in 100 ml of N-methyl-pyrrolidone, the above-mentioned solution was additionally reacted for 6 hours. After the reaction, the reacted solution was slowly poured into methanol for precipitation, filtered and dried under vacuum. The process for dissolving the obtained polymer again in tetrahydrofuran and then precipitating in methanol was repeated twice, and then it was dried under vacuum to finally obtain 26.7 g of poly(amide-imide) copolymer having a coumarin functional group with the use of a triazine ring.

### MANUFACTURING EXAMPLE 6

### Preparation of Photoactive Polyamic Acid

### MANUFACTURING EXAMPLE 6-1

### Preparation of Photoactive Polyamic Acid Having Side Chains of Cinnamate Groups

(1) Introduction of Cinnamate Functional Group

18.4 g of cyanuric chloride was put into a round bottom flask filled with nitrogen and then dissolved with 200 ml of anhydrous tetrahydrofuran. After adding 15.2 g of triethylamine to this solution and then lowering the temperature of the solution to −5° C., the solution was severely stirred and reacted for 12 hours with slowly dropping a cinnamoyl chloride solution diluted by putting 20 ml of anhydrous tetrahydrofuran into cinnamoyl chloride.

After the reaction, the reacted solution was distilled under reduced pressure to remove tetrahydrofuran, and then the solution was dissolved by methylene chloride, passed through a filter filled with silica gels and was then distilled under reduced pressure to remove the solvent.

Finally, after recrystallization in a 1:1 mixed solvent of methylene chloride and n-hexane, the solution was filtered under reduced pressure. The obtained solid phase material was dried under vacuum to obtain 25 g of 2-cinnamoyl-4,6-dichloro-1,3,5-triazine.

(2) Synthesis of a Triazine Monomer Having Diamine Functional Group

29.6 g of 2-cinnamoyl-4,6-dichloro-1,3,5-triazine obtained in a way of (1) of the manufacturing example 6-1 was put into a round bottom flask and dissolved with 300 ml of chloroform. 32.8 g of 4-aminophenol and 12 g of sodium hydroxide were dissolved in 300 ml of distilled water in which 3 g of cetyltrimethylammonium bromide was dissolved, and then they were mixed with the above 2-cinnamoyl-4,6-dichloro-1,3,5-triazine solution and severely reacted for 24 hours. After the reaction, organic solution phase was separated, and the reacted solution was moved to a separating funnel and washed three times with distilled water to extract impurities, and then moisture was removed by calcium chloride. The solution free from water was distilled under reduced pressure to remove chloroform, and then recrystallized in a mixed solvent of methylene chloride and n-hexane.

The deposited crystal was filtered under reduced pressure and then dried under vacuum to obtain 40 g of a triazine monomer.

(3) Polymerization of Polyamic Acid Having a Cinnamate Functional Group

44.144 g of the triazine monomer obtained in the way of (2) of the manufacturing example 6-1 was put into a round bottom flask filled with nitrogen and then dissolved by 250 ml of N-methylpyrrolidone.

After dissolving 21.8 g of 1,2,4,5-benzenetetracarboxylic acid dianhydride in 50 ml of N-methylpyrrolidone, the solution was severely stirred and reacted for 24 hours while slowly dropping it into a solution in which the above-mentioned triazine monomer was dissolved to obtain polyamic acid solution as a precursor of photoactive polyimide.

### MANUFACTURING EXAMPLE 6-2

### Preparation of Photoactive Polyamic Acid Having Side Chain of Chalcone Group

(1) Synthesis of Chalcone Functional Group

10 g of 4-methoxy chalcone and 2.05 g of sodium cyanide were dissolved in 100 ml of dimethyl-sulfoxide, and then reacted during 24 hours. After the reaction, the reacted solution was mixed with chloroform and stirred together with distilled water so as to extract impurities. After removing the solution phase, the solution was decompressed at a room temperature in order to eliminate chloroform. After recrystallizing the remained solid phase in methanol, the solid was dried under vacuum to obtain 20 g of 4-hydroxychalcone.

(2) Introduction of a Chalcone into a Triazine Ring

23.8 g of 4-hydroxychalcone synthesized in a way of (1) of the manufacturing example 6-2 was put into a round bottom flask filled with nitrogen and then dissolved in 240 ml of anhydrous tetrahydrofuran. 2.4 g of sodium hydride (NaH) was added to the solution and reacted at room temperature for 6 hours. The solution was reacted at −5° C. for 24 hours by severely stirring with slowly dropping it into a solution which was made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water at a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 34 g of triazine derivative having chalcone functional group.

(3) Synthesis of a Triazine Monomer Having Diamine Functional Group

38.6 g of the triazine derivative having a chalcone functional group synthesized in a way of (2) of the manufacturing 6-2 was put into a round bottom flask and dissolved by 300 ml of chloroform. In addition, 32.8 g of 4-aminophenol and 12 g of sodium hydroxide were dissolved in 300 ml of distilled water to which 3 g of cetyltrimethylammonium bromide was dissolved, and then they were mixed with the above triazine solution and severely reacted for 24 hours. After the reaction, organic solution phase was separated and moved to a separating funnel and washed three times with distilled water to extract impurities. And then, moisture was removed by calcium chloride. The solution free from water was distilled under reduced pressure to remove chloroform, and then recrystallized in a mixed solvent of methylene chloride and n-hexane. The deposited crystal was filtered under reduced pressure and then dried under vacuum to obtain 45 g of a triazine monomer.

(4) Polymerization of Polyamic Acid Having a Chalcone Functional Group

53.15 g of the triazine monomer obtained in the way of (3) of the manufacturing example 6-2 was put into a round bottom flask filled with nitrogen and then dissolved by 260 ml of N-methylpyrrolidone.

After dissolving 21.8 g of 1,2,4,5-benzenetetracarboxylic acid dianhydride in 50 ml of N-methylpyrrolidone, the solution was severely stirred and reacted for 24 hours while slowly dropping it into a solution in which the above-mentioned triazine monomer was dissolved to obtain polyamic acid solution as precursor of photoactive polyimide.

### MANUFACTURING EXAMPLE 6-3

### Preparation of Photoactive Polyamic Acid Having Side Chain of Coumarin Group

(1) Introduction of a Coumarin Photoactive Group

16.2 g of 7-hydroxycoumarin and 2.4 g of sodium hydride (NaH) were put into a round bottom flask filled with nitrogen, and then they were dissolved into 160 ml of anhydrous tetrahydrofuran. After that, the solution was severely stirred and reacted for 6 hours. This solution was severely stirred and reacted for 24 hours at −5° C. with slowly dropping it into a solution which is made by putting 18.4 g of cyanuric chloride into a round bottom flask and then dissolving it into 200 ml of anhydrous tetrahydrofuran. After the reaction, tetrahydrofuran was removed by distillation under reduced pressure, and then remained solids were dissolved again into chloroform. This solution was washed three times with distilled water at a separating funnel to extract impurities, and then moisture was removed by calcium chloride. The solution was then distilled under reduced pressure to remove chloroform, and then recrystallized with a mixed solvent of methylene chloride and n-hexane. The recrystallized material was filtered under reduced pressure and then dried under vacuum to obtain 29 g of triazine derivative having a coumarin functional group.

(2) Synthesis of a Triazine Monomer Having Diamine Functional Group

31.1 g of the triazine derivative having a coumarin functional group synthesized in a way of (1) of the manufacturing 6-3 was put into a round bottom flask and dissolved by 300 ml of chloroform. 32.8 g of 4-aminophenol and 12 g of sodium hydroxide were dissolved in 300 ml of distilled water in which 3 g of cetyltrimethylammonium bromide was dissolved, and then they were mixed with the above triazine solution and severely reacted for 24 hours. After the reaction, organic solution phase was separated, moved to a separating funnel and washed three times with distilled water to extract impurities. And then, moisture was removed by calcium chloride. The solution free from moisture was distilled under reduced pressure to remove chloroform, and then recrystallized in a mixed solvent of methylene chloride and n-hexane. The deposited crystal was filtered under reduced pressure and then dried under vacuum to obtain 40 g of a triazine monomer.

(3) Polymerization of Polyamic Acid Having a Coumarin Functional Group

45.54 g of the triazine monomer obtained in the way of (2) of the manufacturing example 6-3 was put into a round bottom flask filled with nitrogen and then dissolved by 250 ml of N-methylpyrrolidone.

After dissolving 21.8 g of 1,2,4,5-benzenetetracarboxylic acid dianhydride in 50 ml of N-methylpyrrolidone, the solution was severely stirred and reacted for 24 hours while slowly dropping it into a solution in which the above-mentioned triazine monomer was dissolved to obtain polyamic acid solution as precursor of photoactive polyimide.

### EMBODIMENTS 1-5

A photoactive polymer prepared by the manufacturing examples 1 to 5 was dissolved in NMP to form a solution for embodiments 1 to 5. The solution was applied on a surface of a copper thin film having 18 μm of thickness using coater with Im/min of linear velocity to form a coating layer having 25 μm of thickness. The solvent in the coating layer was eliminated at 2000. And then the solvent-free coating layer was irradiated using a UV lamp with 600 W/inch, which induced photo-crosslinking reaction to form a flexible metal clad laminate film.

### EMBODIMENT 6

A photoactive polyamic acid solution prepared by the manufacturing 6 was applied on a surface of a copper thin film having 18 μm of thickness using coater with Im/min of linear velocity to form a coating layer having 25 μm of thickness. The solvent in the coating layer was eliminated at 200□. And then the solvent-free coating layer was irradiated using a UV lamp with 600 W/inch, which induced photo-crosslinking reaction. After that, the polyamic acid in the coating layer was imidized at 350° C. to form a flexible metal clad laminate film.

The flexible metal clad laminate films prepared by the embodiments 1 to 6 were tested for several physical properties. The results are shown in tables 1 to 6.

TABLE 1

| Embodiments | | 1-1 | | 1-2 | | 1-3 | | Methods |
|---|---|---|---|---|---|---|---|---|
| Tensile Strength | | 251 | MPa | 249.1 | MPa | 249.5 | MPa | IPC-TM-650, |
| Tensile Elongation | | 50% | | 50% | | 50% | | 2.4.19 |
| Tensile Modulus | | 4600 | MPa | 4550 | MPa | 4500 | MPa | |
| Peel Strength | Initial | 1.2 | kN/m | 1.1 | kN/m | 1.1 | kN/m | JIS C-5012 |
| | Aging | 0.9 | kN/m | 0.8 | kN/m | 0.8 | kN/m | 150° C., 7 days |

| | | | | | | | |
|---|---|---|---|---|---|---|---|
| Etch Shrinkage | 0.01% | | 0.02% | | 0.02% | | |
| Thermal Shrinkage | −0.01% | | −0.02% | | −0.02% | | |
| Insulation Resistance | 1.1 × 10⁸ | MΩ | 1.0 × 10⁸ | MΩ | 1.0 × 10⁸ | MΩ | IPC-TM-650, 2.5.9 |
| Volume Resistivity | 5.0 × 10⁹ | MΩ · cm | 4.9 × 10⁹ | MΩ · cm | 5.0 × 10⁹ | MΩ · cm | IPC-TM-650, 2.5.17 |
| Dielectric Strength | ≧5 | kV/mil | ≧5 | kV/mil | ≧5 | kV/mil | ASTM-D-149 |
| Solder Float Resistance | 400° | C. | 400° | C. | 400° | C. | 1 min, dipping |

TABLE 2

| Embodiments | | 2-1 | | 2-2 | | 2-3 | | Methods |
|---|---|---|---|---|---|---|---|---|
| Tensile Strength | | 251 | MPa | 249.1 | MPa | 248.5 | MPa | IPC-TM-650, |
| Tensile Elongation | | 50% | | 50% | | 50% | | 2.4.19 |
| Tensile Modulus | | 4600 | MPa | 4550 | MPa | 4500 | MPa | |
| Peel Strength | Initial | 1.2 | kN/m | 1.1 | kN/m | 1.1 | kN/m | JIS C-5012 |
| | Aging | 0.9 | kN/m | 0.8 | kN/m | 0.8 | kN/m | 150° C., 7 days |

| | | | | | | | |
|---|---|---|---|---|---|---|---|
| Etch Shrinkage | 0.01% | | 0.02% | | 0.02% | | |
| Thermal Shrinkage | −0.01% | | −0.02% | | −0.02% | | |
| Insulation Resistance | 1.1 × 10⁸ | MΩ | 1.0 × 10⁸ | MΩ | 1.0 × 10⁸ | MΩ | IPC-TM-650, 2.5.9 |
| Volume Resistivity | 5.0 × 10⁹ | MΩ · cm | 4.9 × 10⁹ | MΩ · cm | 5.0 × 10⁹ | MΩ · cm | IPC-TM-650, 2.5.17 |
| Dielectric Strength | ≧5 | kV/mil | ≧5 | kV/mil | ≧5 | kV/mil | ASTM-D-149 |
| Solder Float Resistance | 400° | C. | 400° | C. | 400° | C. | 1 min, dipping |

TABLE 3

| Embodiments | | 3-1 | | 3-2 | | 3-3 | | Methods |
|---|---|---|---|---|---|---|---|---|
| Tensile Strength | | 251 | MPa | 241.7 | MPa | 248.5 | MPa | IPC-TM-650, |
| Tensile Elongation | | 50% | | 50% | | 50% | | 2.4.19 |
| Tensile Modulus | | 4825 | MPa | 4755 | MPa | 4680 | MPa | |
| Peel Strength | Initial | 1.4 | kN/m | 1.2 | kN/m | 1.2 | kN/m | JIS C-5012 |
| | Aging | 1.0 | kN/m | 0.9 | kN/m | 0.9 | kN/m | 150° C., 7 days |

| | | | | | | | |
|---|---|---|---|---|---|---|---|
| Etch Shrinkage | 0.01% | | 0.02% | | 0.02% | | |
| Thermal Shrinkage | −0.01% | | −0.02% | | −0.02% | | |
| Insulation Resistance | 1.2 × 10⁸ | MΩ | 1.1 × 10⁸ | MΩ | 1.0 × 10⁸ | MΩ | IPC-TM-650, 2.5.9 |
| Volume Resistivity | 5.2 × 10⁹ | MΩ · cm | 5.0 × 10⁹ | MΩ · cm | 5.0 × 10⁹ | MΩ · cm | IPC-TM-650, 2.5.17 |
| Dielectric Strength | ≧5 | kV/mil | ≧5 | kV/mil | ≧5 | kV/mil | ASTM-D-149 |
| Solder Float Resistance | 420° | C. | 400° | C. | 410° | C. | 1 min, dipping |

TABLE 4

| Embodiments | | 4-1 | | 4-2 | | 4-3 | | Methods |
|---|---|---|---|---|---|---|---|---|
| Tensile Strength | | 254 | MPa | 248.7 | MPa | 248.5 | MPa | IPC-TM-650, |
| Tensile Elongation | | 50% | | 50% | | 50% | | 2.4.19 |
| Tensile Modulus | | 4820 | MPa | 4750 | MPa | 4680 | MPa | |
| Peel Strength | Initial | 1.4 | kN/m | 1.2 | kN/m | 1.2 | kN/m | JIS C-5012 |
| | Aging | 1.0 | kN/m | 0.9 | kN/m | 0.9 | kN/m | 150° C., 7 days |

| | | | | | | | |
|---|---|---|---|---|---|---|---|
| Etch Shrinkage | 0.01% | | 0.02% | | 0.02% | | |
| Thermal Shrinkage | −0.01% | | −0.02% | | −0.02% | | |
| Insulation Resistance | 1.2 × 10⁸ | MΩ | 1.1 × 10⁸ | MΩ | 1.0 × 10⁸ | MΩ | IPC-TM-650, 2.5.9 |
| Volume Resistivity | 5.2 × 10⁹ | MΩ · cm | 5.0 × 10⁹ | MΩ · cm | 5.0 × 10⁹ | MΩ · cm | IPC-TM-650, 2.5.17 |
| Dielectric Strength | ≧5 | kV/mil | ≧5 | kV/mil | ≧5 | kV/mil | ASTM-D-149 |
| Solder Float Resistance | 420° | C. | 400° | C. | 410° | C. | 1 min, dipping |

TABLE 5

| Embodiments | | 5-1 | | 5-2 | | 5-3 | | Methods |
|---|---|---|---|---|---|---|---|---|
| Tensile Strength | | 250 | MPa | 249.1 | MPa | 248.9 | MPa | IPC-TM-650, |
| Tensile Elongation | | 50% | | 50% | | 50% | | 2.4.19 |
| Tensile Modulus | | 4600 | MPa | 4570 | MPa | 4600 | MPa | |
| Peel Strength | Initial | 1.1 | kN/m | 1.0 | kN/m | 1.0 | kN/m | JIS C-5012 |
| | Aging | 1.0 | kN/m | 0.9 | kN/m | 0.9 | kN/m | 150° C., 7 days |

| | | | | | | | |
|---|---|---|---|---|---|---|---|
| Etch Shrinkage | 0.01% | | 0.02% | | 0.02% | | |
| Thermal Shrinkage | −0.01% | | −0.02% | | −0.02% | | |
| Insulation Resistance | 1.2 × 10⁸ | MΩ | 1.0 × 10⁸ | MΩ | 1.1 × 10⁸ | MΩ | IPC-TM-650, 2.5.9 |
| Volume Resistivity | 5.0 × 10⁹ | MΩ · cm | 4.9 × 10⁹ | MΩ · cm | 5.0 × 10⁹ | MΩ · cm | IPC-TM-650, 2.5.17 |
| Dielectric Strength | ≧5 | kV/mil | ≧5 | kV/mil | ≧5 | kV/mil | ASTM-D-149 |
| Solder Float Resistance | 400° | C. | 400° | C. | 400° | C. | 1 min, dipping |

TABLE 6

| Embodiments | | 6-1 | | 6-2 | | 6-3 | | Methods |
|---|---|---|---|---|---|---|---|---|
| Tensile Strength | | 255 | MPa | 249.7 | MPa | 249.5 | MPa | IPC-TM-650, |
| Tensile Elongation | | 50% | | 50% | | 50% | | 2.4.19 |
| Tensile Modulus | | 4800 | MPa | 4760 | MPa | 4690 | MPa | |
| Peel Strength | Initial | 1.4 | kN/m | 1.2 | kN/m | 1.2 | kN/m | JIS C-5012 |
| | Aging | 1.0 | kN/m | 0.9 | kN/m | 0.9 | kN/m | 150° C., 7 days |

| | | | | | | | |
|---|---|---|---|---|---|---|---|
| Etch Shrinkage | 0.01% | | 0.02% | | 0.02% | | |
| Thermal Shrinkage | −0.01% | | −0.02% | | −0.02% | | |
| Insulation Resistance | 1.2 × 10⁸ | MΩ | 1.1 × 10⁸ | MΩ | 1.0 × 10⁸ | MΩ | IPC-TM-650, 2.5.9 |
| Volume Resistivity | 5.2 × 10⁹ | MΩ · cm | 5.0 × 10⁹ | MΩ · cm | 5.0 × 10⁹ | MΩ · cm | IPC-TM-650, 2,5,17 |
| Dielectric Strength | ≧5 | kV/mil | ≧5 | kV/mil | ≧5 | kV/mil | ASTM-D-149 |
| Solder Float Resistance | 420° | C. | 400° | C. | 410° | C. | 1 min, dipping |

Moreover, reflow resistance (85□, 60% RH, 168 hr.+Reflow) was measured. The results are shown in table 7.

TABLE 7

| Embodiments | 1-1 | 1-2 | 1-3 | 2-1 | 2-2 | 2-3 | 3-1 | 3-2 | 3-3 | 4-1 | 4-2 | 4-3 | 5-1 | 5-2 | 5-3 | 6-1 | 6-2 | 6-3 |
|---|---|---|---|---|---|---|---|---|---|---|---|---|---|---|---|---|---|---|
| 1^{st} cycle | 260 | 260 | 260 | 260 | 260 | 260 | 270 | 270 | 270 | 270 | 270 | 270 | 260 | 260 | 260 | 270 | 270 | 270 |
| (° C.) | | | | | | | | | | | | | | | | | | |
| 2^{nd} cycle | 260 | 260 | 260 | 260 | 260 | 260 | 260 | 260 | 260 | 260 | 260 | 260 | 260 | 260 | 260 | 260 | 260 | 260 |
| (° C.) | | | | | | | | | | | | | | | | | | |
| 3^{rd} cycle | 260 | 250 | 260 | 260 | 250 | 260 | 260 | 260 | 260 | 260 | 260 | 260 | 250 | 250 | 250 | 260 | 260 | 260 |
| (° C.) | | | | | | | | | | | | | | | | | | |

As shown in the tables 1 to 7, the flexible metal clad laminate film of the present invention has good physical properties such as size stability. In particular, deflecting or twisting of the flexible metal clad laminate film is minimized.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The flexible metal clad laminate film of the present invention has good physical properties such as size stability, and is almost not deflected or twisted, since it includes the flexible insulating film composed of crosslinked resin formed by photo-crosslinking reaction of photoactive polymer. Therefore, the flexible metal clad laminate film of the present invention will be available in electronic industry for small electronic devices.

1. A flexible metal clad laminate film comprising:
a metal thin film; and
a flexible insulating film formed by photo-crosslinking reaction of photoactive polymers having photoactive side chains which may be crosslinked by photo-irradiation.

2. The flexible metal clad laminate film according to claim 1,
wherein the photoactive side chain is selected from the group consisting of (1a), (2a), (3a), and (4a) having the structure of the following chemical formula 2: 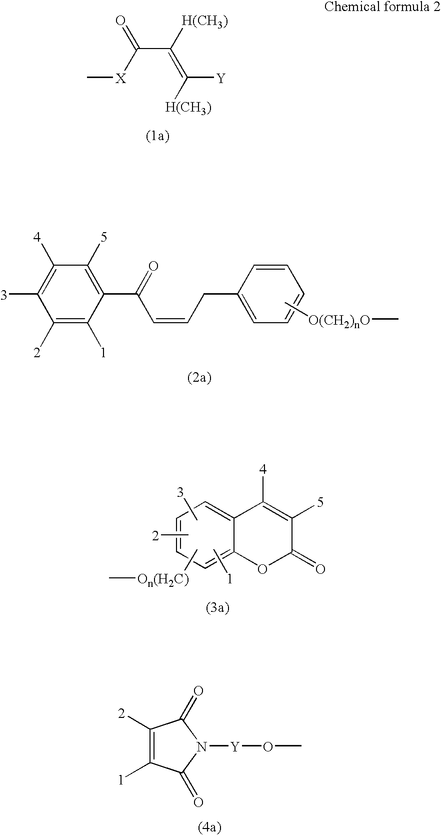
where, in the chemical formula 2 (1a), X is selected from the group consisting of the structures of the following chemical formula 3, 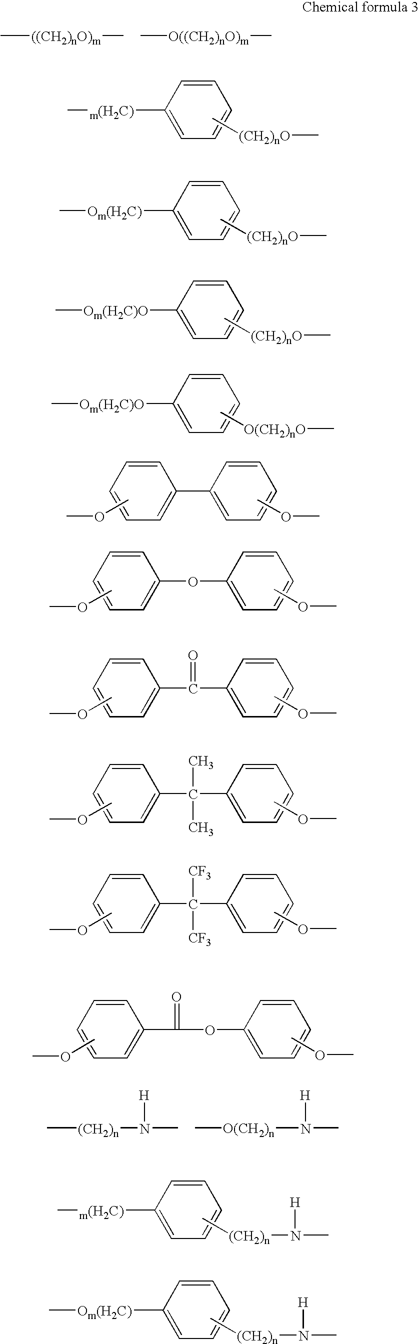 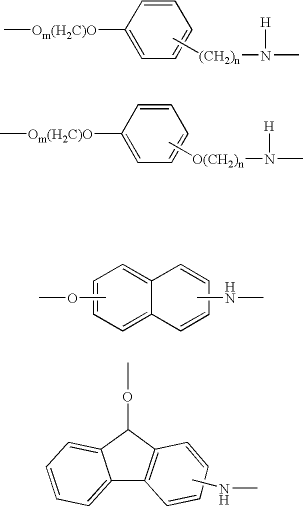
where, in the chemical formula 3, m and n are 0˜10 respectively;
where, in the chemical formula 2 (1a), Y is selected from the group consisting of the structures of the following chemical formula 4: 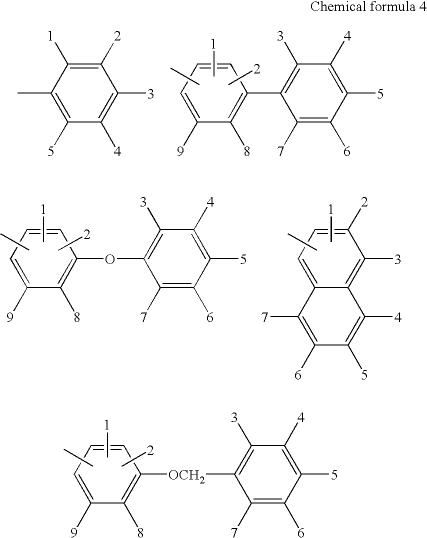
where, in the chemical formula 4, the numerals 1, 2, 3, 4, 5, 6, 7, 8, and 9 are respectively selected from the group consisting of the structures of the following chemical formula 5, 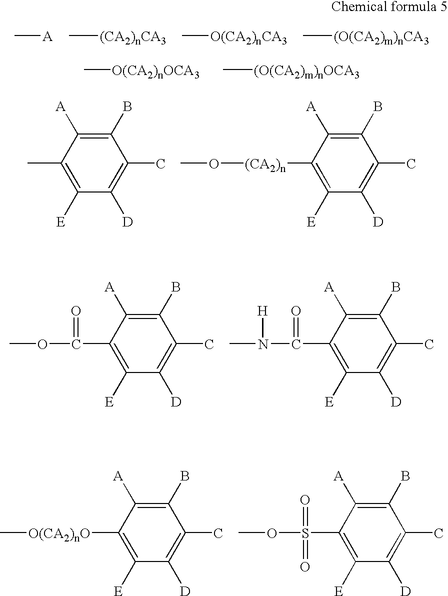
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following formula 6, 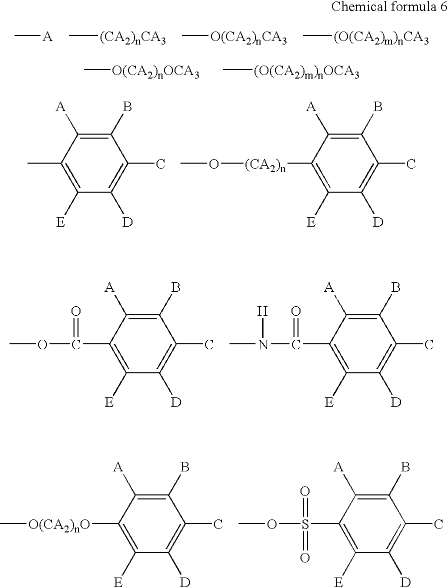
where, in the chemical formula 6, m and n are 0˜10 respectively, and A, B, B, C, D, and E are respectively selected from the group consisting of H, F, Cl, CN, CF₃ and CH₃,
where, in the chemical formula 2 (4a), Y is selected from the group consisting of the structures of the following chemical formula 7, 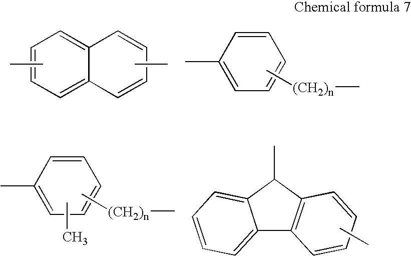
where, in the chemical formula 7, n is 0˜10,
where, in the chemical formula 2 (4a), the numerals 1 and 2 are respectively selected from the group consisting of the structures of the following chemical formula 8, 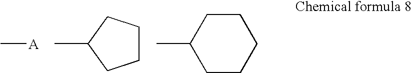
where, in the chemical formula 8, A is selected from the group consisting of H, F, CH₃, CF₃, and CN.

3. The flexible metal clad laminate film according to claim 1,
wherein the photoactive polymer comprises a main chain in which triazine rings are introduced.

4. The flexible metal clad laminate film according to claim 1,
wherein the photoactive polymer comprises a main chain in which triazine rings having photoactive side chains capable of crosslinking reaction by photo-irradiation are introduced.

5. The flexible metal clad laminate film according to claim 4,
wherein the photoactive polymer comprises a photoactive polycyanurate having the structure of the following chemical formula 1: 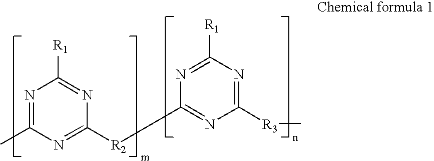
where, in the chemical formula 1, m+n=1, 0≦m≦1, 0≦n≦1, and R₁ is selected from the group of (1a), (2a), (3a), and (4a) of the following chemical formula 2 respectively, 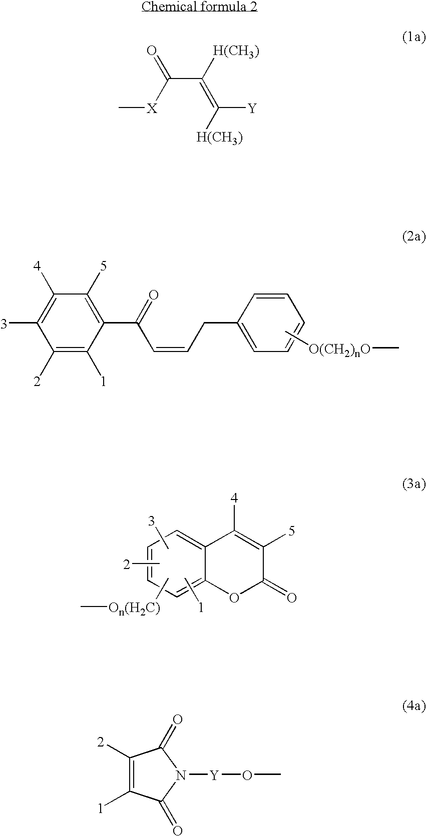
where, in the chemical formula 2 (1a), X is selected from the group consisting of the structures of the following chemical formula 3, 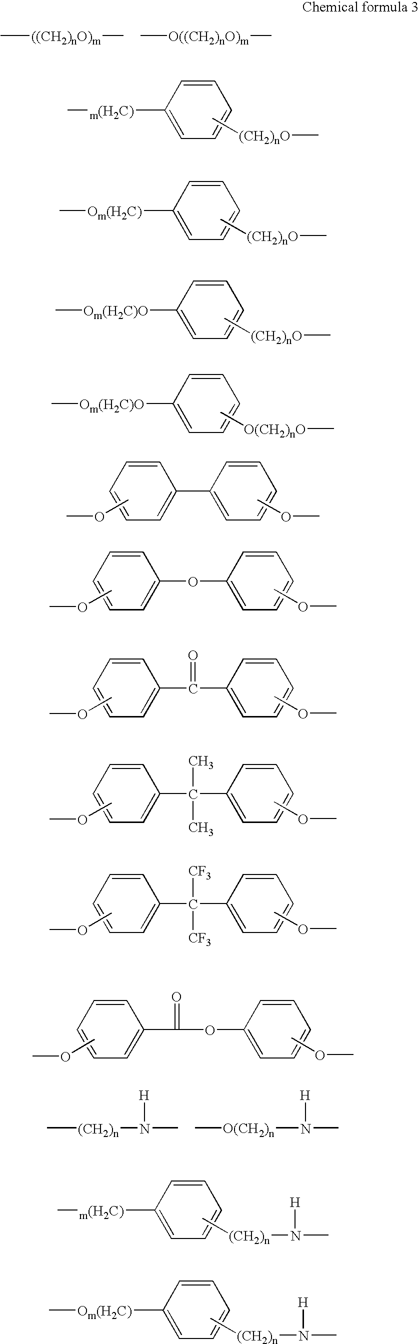 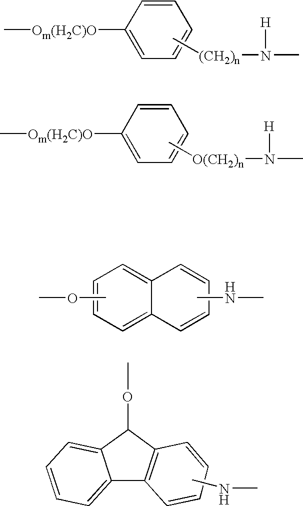
where, in the chemical formula 3, m and n are 0˜10 respectively,
where, in the chemical formula 2 (1a), Y is selected from the group consisting of the structures of the following chemical formula 4, 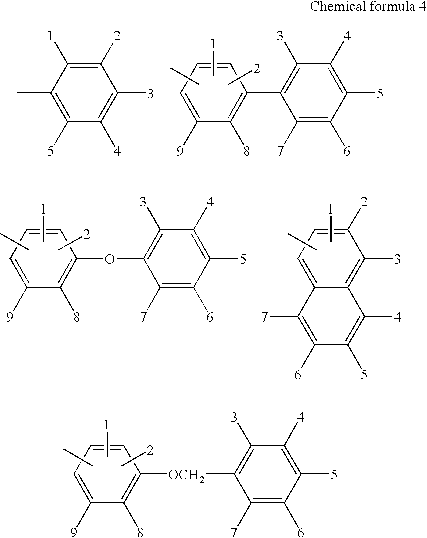
where, in the chemical formula 4, the numerals 1, 2, 3, 4, 5, 6, 7, 8, and 9 are respectively selected from the group consisting of the structures of the following chemical formula 5, 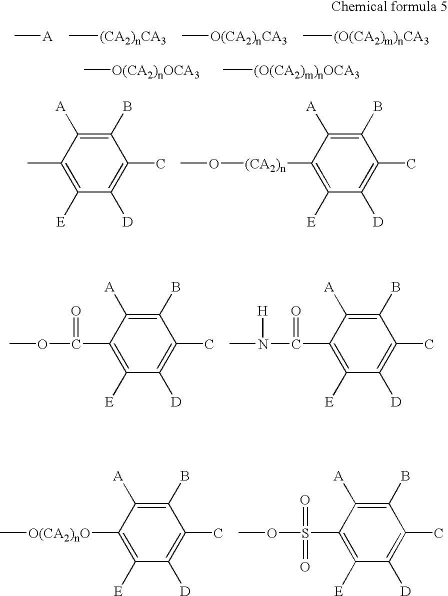
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following formula 6, 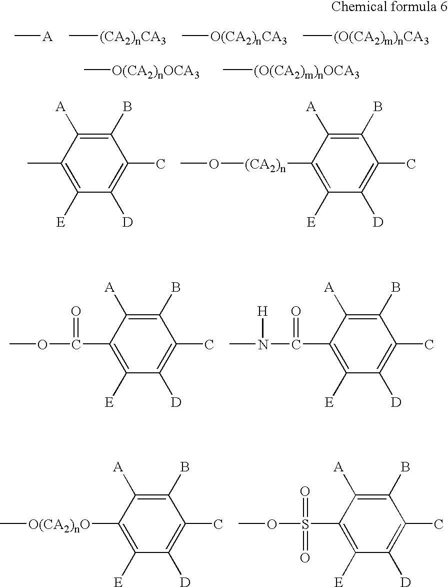
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 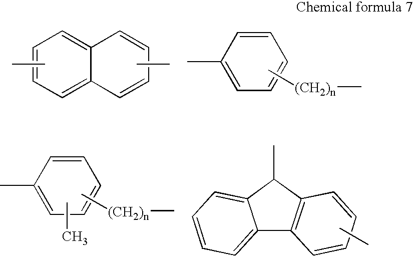
where, in the chemical formula 7, n is 0˜10,
where, in the chemical formula 2 (4a), the numerals 1 and 2 are respectively selected from the group consisting of the structures of the following chemical formula 8, 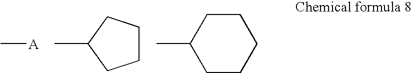
where, in the chemical formula 8, A is selected from the group consisting of H, F, CH₃, CF₃, and CN,
where, in the chemical formula 1, R₂ and R₃ are respectively selected from the group consisting of the structures of the following chemical formula 9, 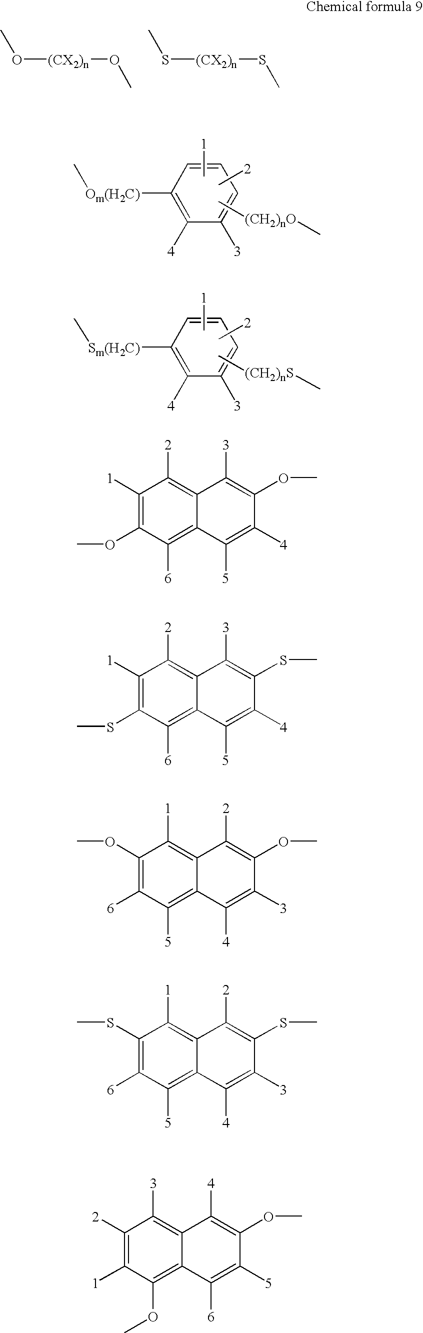 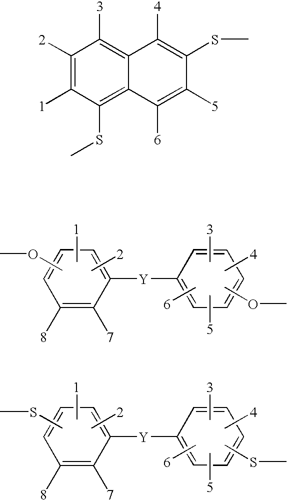
where, in the chemical formula 9, m and n are 0˜10 respectively, the numerals 1, 2, 3, 4, 5, 6, 7, and 8 are respectively selected from the group consisting of H, F, Cl, CN, CH₃, OCH₃, and CF₃, X is selected from the group consisting of H, F, Cl, CN, CH₃, OCH₃, and CF₃, and Y is selected from the group consisting of CH₂, C(CH₃)₂, C(CF₃)₂, O, S, SO₂, CO, and CO₂.

6. The flexible metal clad laminate film according to claim 4,
wherein the photoactive polymer comprises a photoactive polyester having the structure of the following chemical formula 10: 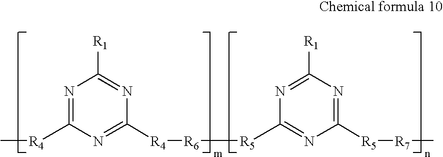
where, in the chemical formula 10, m+n=1, 0≦m≦1, 0≦n≦1, and R₁ is selected from the group of (1a), (2a), (3a), and (4a) of the following chemical formula 2 respectively, 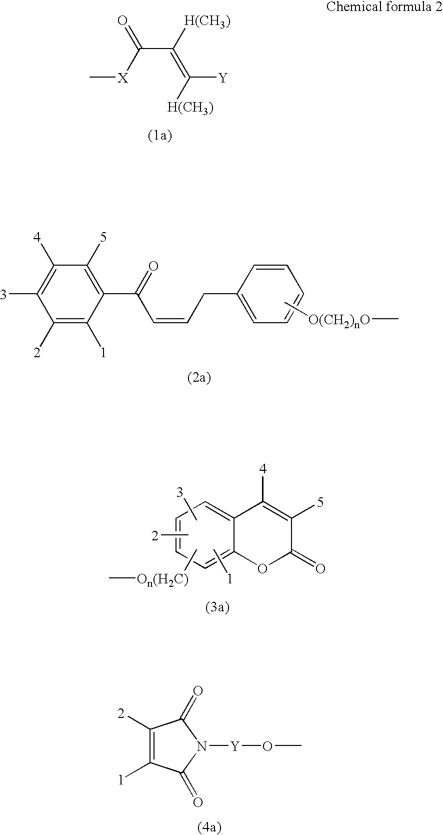
where, in the chemical formula 2 (1a), X is selected from the group consisting of the structures of the following chemical formula 3: 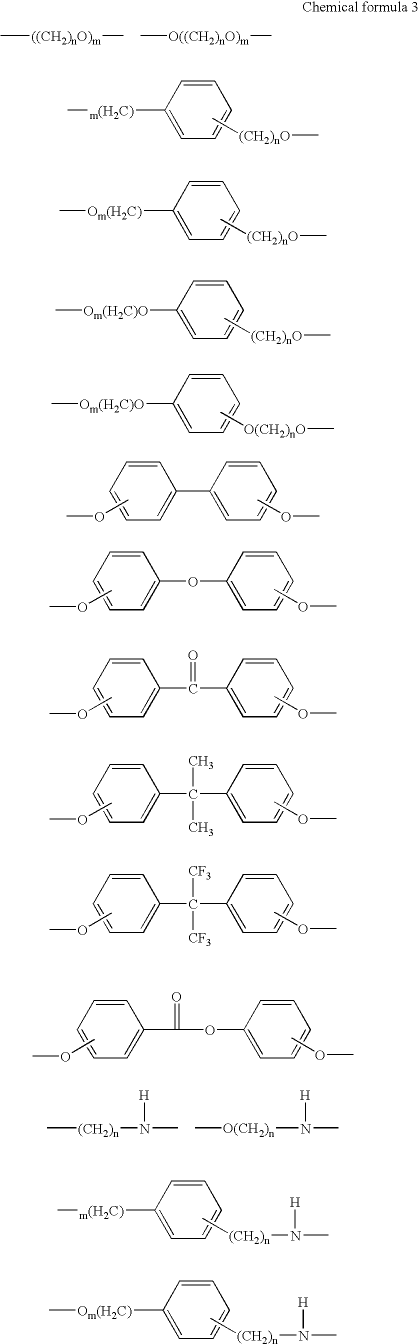 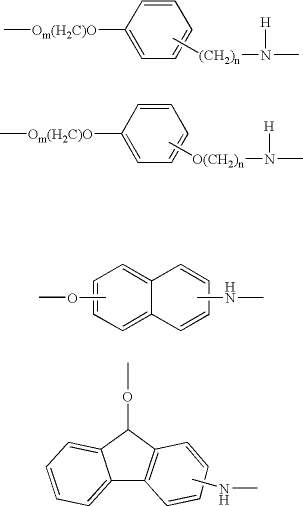
where, in the chemical formula 3, m and n are 0˜10 respectively,
where, in the chemical formula 2 (1a), Y is selected from the group consisting of the structures of the following chemical formula 4, 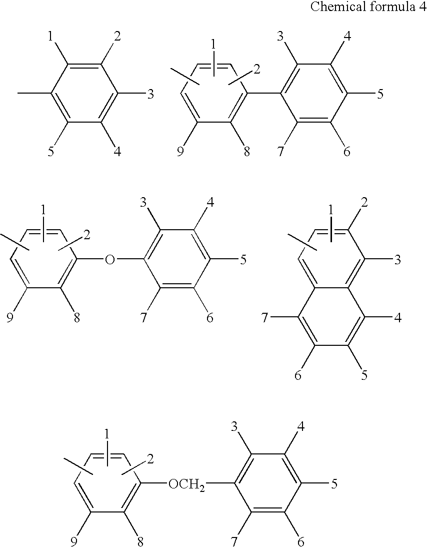
where, in the chemical formula 4, the numerals 1, 2, 3, 4, 5, 6, 7, 8, and 9 are respectively selected from the group consisting of the structures of the following chemical formula 5, 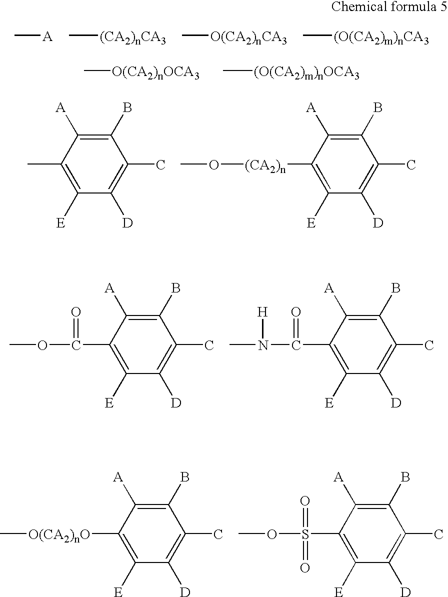
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following formula 6, 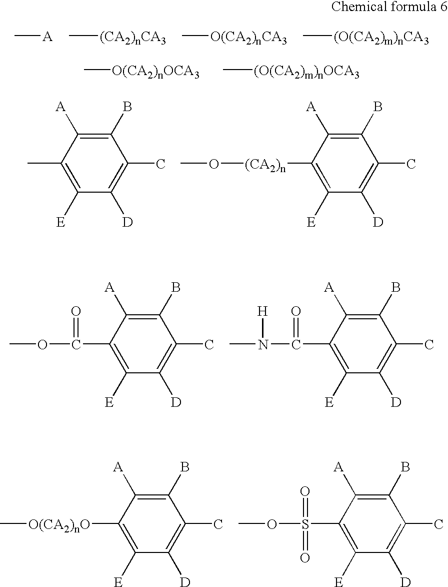
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 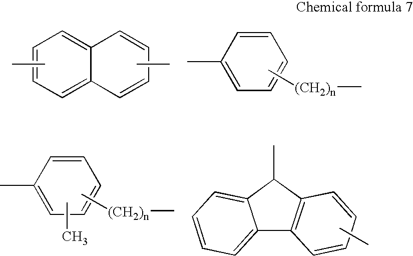
where, in the chemical formula 7, n is 0˜10,
where, in the chemical formula 2 (4a), the numerals 1 and 2 are respectively selected from the group consisting of the structures of the following chemical formula 8, 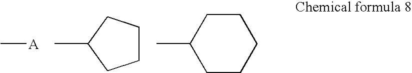
where, in the chemical formula 8, A is selected from the group consisting of H, F, CH₃, CF₃, and CN,
where, in the chemical formula 10, R₄ and R₅ are respectively selected from the group consisting of the structures of the following chemical formula 11, 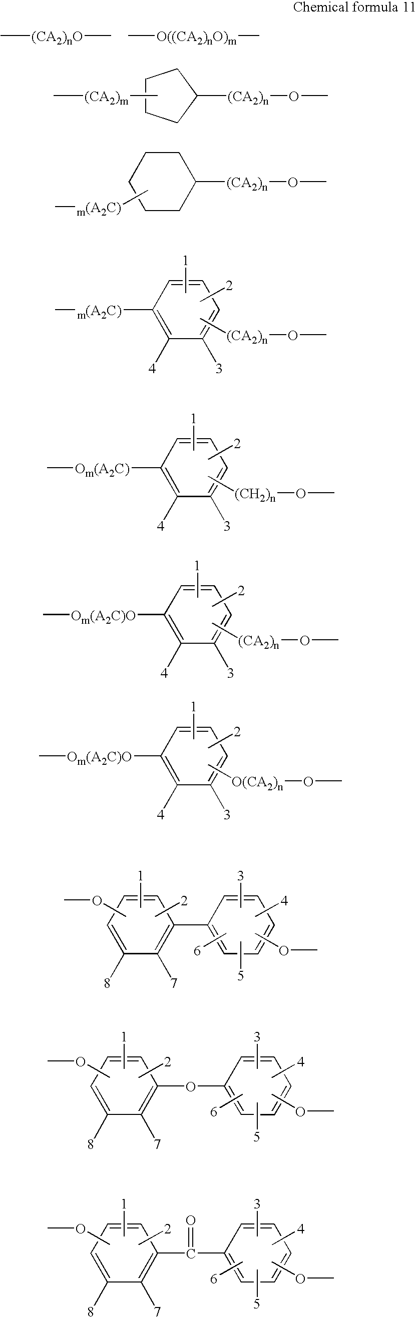 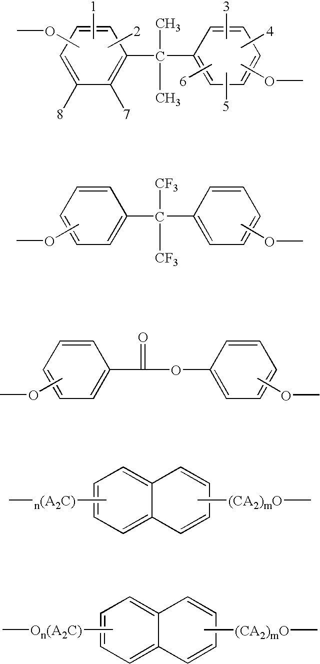
where, in the chemical formula 11, m and n are 0˜10 respectively, and A, the numerals 1, 2, 3, 4, 5, 6, 7, and 8 are respectively selected from the group consisting of H, F, Cl, CN, CF₃, and CH₃,
where, in the chemical formula 10, R₆ and R₇ are respectively selected from the group consisting of the structures of the following chemical formula 12, 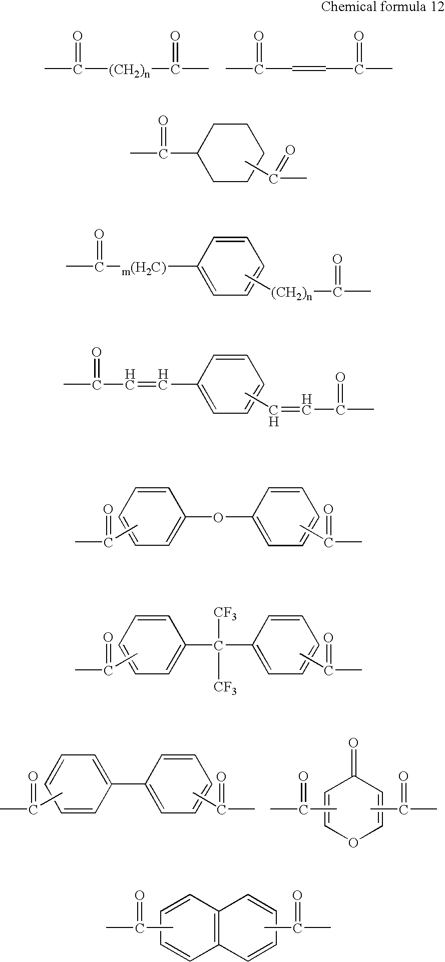
where, in the chemical formula 12, m and n are 0˜10 respectively.

7. The flexible metal clad laminate film according to claim 4,
wherein the photoactive polymer comprises a photoactive poly(thio)ether having the structure of the following chemical formula 13: 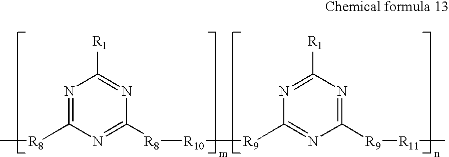
where, in the chemical formula 13, m+n=1, 0≦m≦1, 0≦n≦1, and R₁ is selected from the group of (1a), (2a), (3a), and (4a) of the following chemical formula 2 respectively, 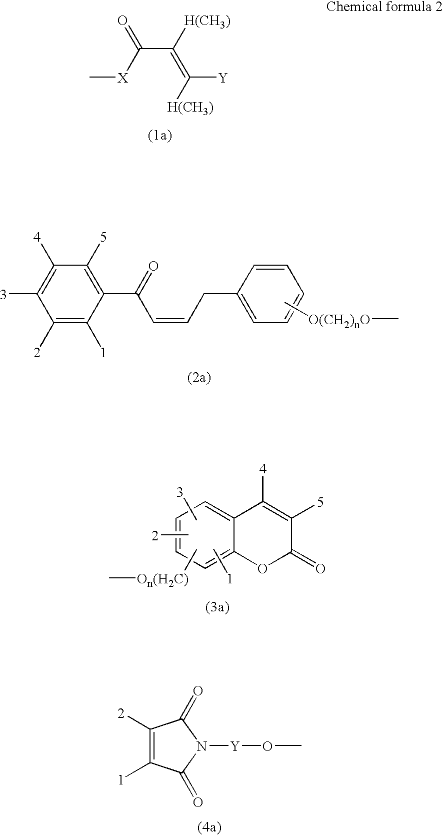
where, in the chemical formula 2 (1a), X is selected from the group consisting of the structures of the following chemical formula 3, 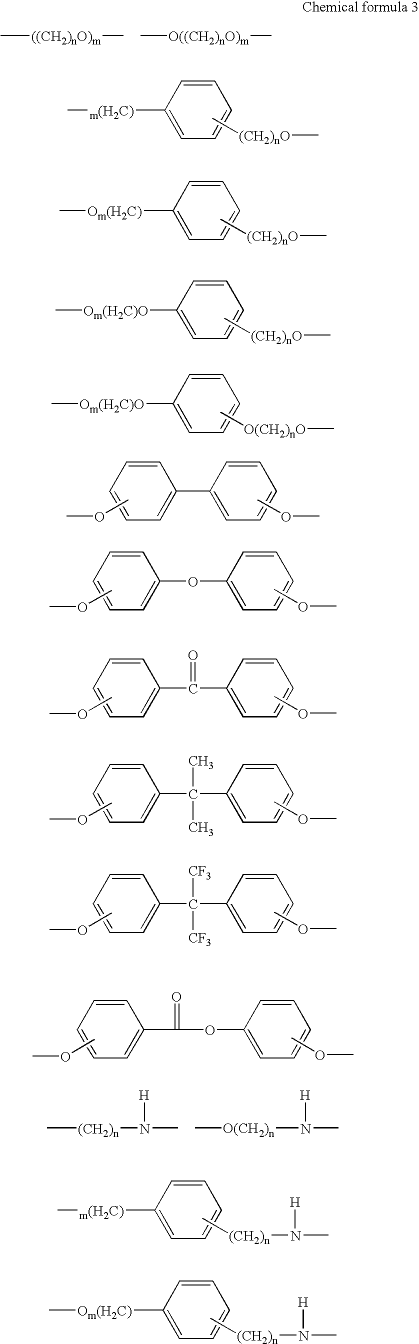 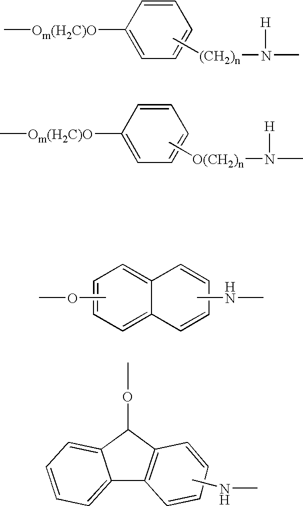
where, in the chemical formula 3, m and n are 0˜10 respectively;
where, in the chemical formula 2 (1a), Y is selected from the group consisting of the structures of the following chemical formula 4, 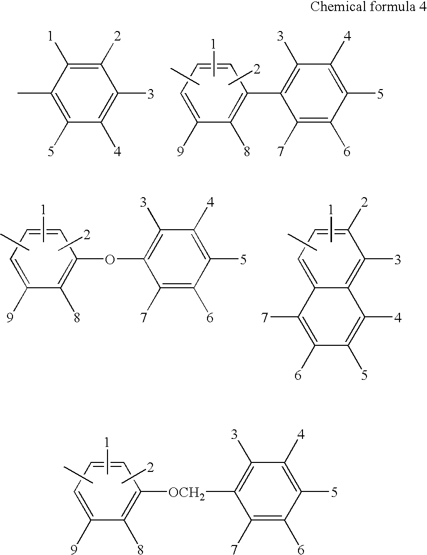
where, in the chemical formula 4, the numerals 1, 2, 3, 4, 5, 6, 7, 8, and 9 are respectively selected from the group consisting of the structures of the following chemical formula 5, 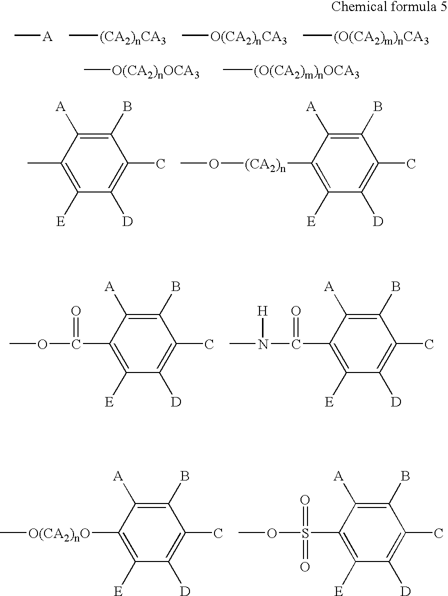
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following formula 6, 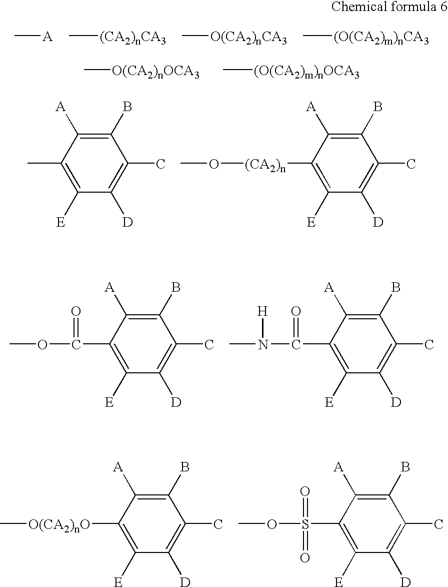
where, in the chemical formula 6, m and n are 0˜10 respectively, and A, B, C, D, and E are respectively selected from the group consisting of H, F. Cl, CN, CF₃ and CH₃,
where, in the chemical formula 2 (4a), Y is selected from the group consisting of the structures of the following chemical formula 7, 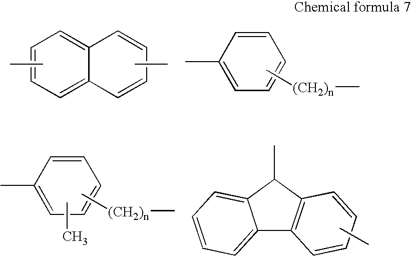
where, in the chemical formula 7, n is 0˜10,
where, in the chemical formula 2 (4a), the numerals 1 and 2 are respectively selected from the group consisting of the structures of the following chemical formula 8, 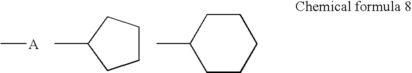
where, in the chemical formula 8, A is selected from the group consisting of H, F, CH₃, CF₃, and CN,
where, in the chemical formula 13, R₈ and R₉ are respectively selected from the group consisting of the structures of the following chemical formula 14, 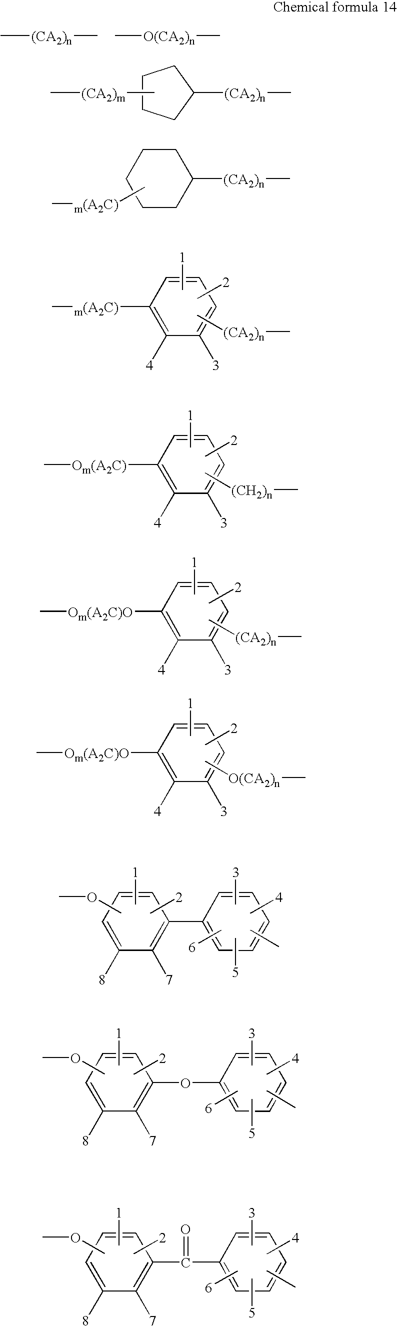 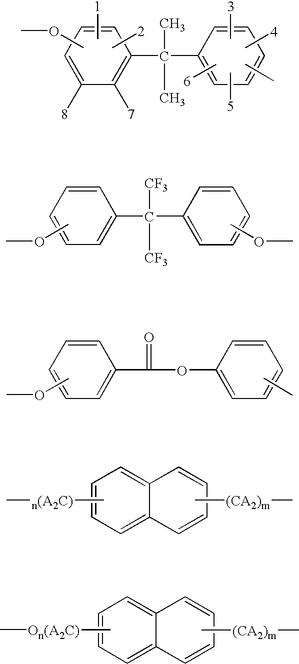
where, in the chemical formula 11, m and n are 0˜10 respectively, and A, and the numerals 1, 2, 3, 4, S. 6, 7, and 8 are respectively selected from the group consisting of H, F, Cl, CN, CF₃, and CH₃,
where, in the chemical formula 13, R₁₀ and R₁₁ are respectively selected from the group consisting of the structures of the following chemical formula 15, 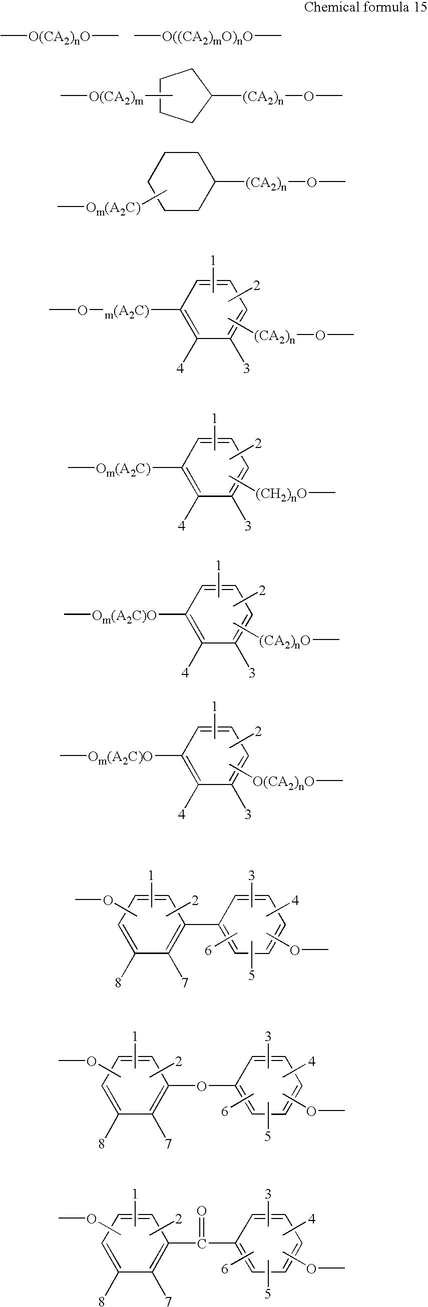 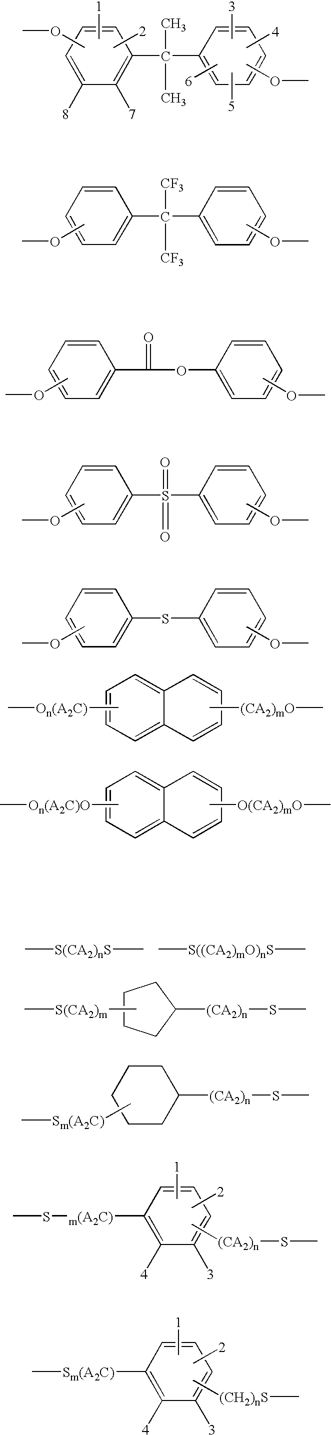 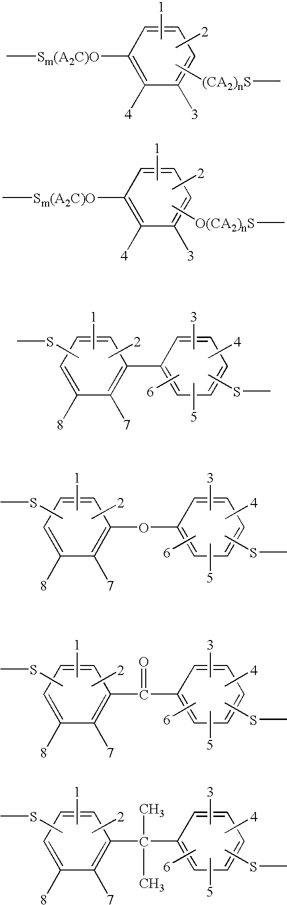 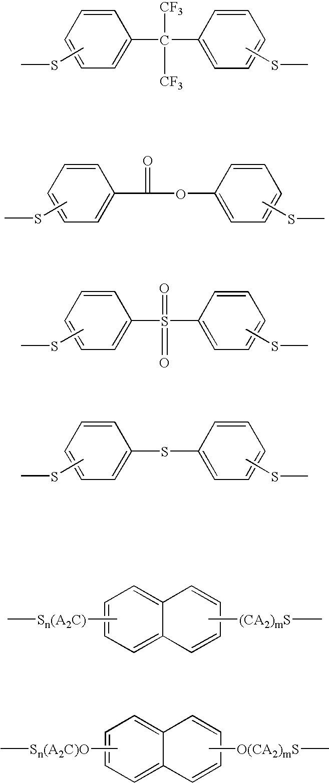
where, in the chemical formula 15, m and n are 0˜10 respectively, and A, the numerals 1, 2, 3, 4, 5, 6, 7, and 8 are respectively selected from the group consisting of H, F, Cl, CN, CF₃, and CH₃.

8. The flexible metal clad laminate film according to claim 4,
wherein the photoactive polymer comprises a photoactive poly(amide-imide) having the structure of the following chemical formula 16: 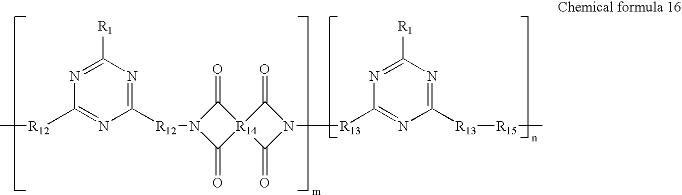
where, in the chemical formula 16, m+n=1, 0≦m≦1, 0≦n≦1, and R₁ is selected from the group of (1a), (2a), (3a), and (4a) of the following chemical formula 2 respectively, 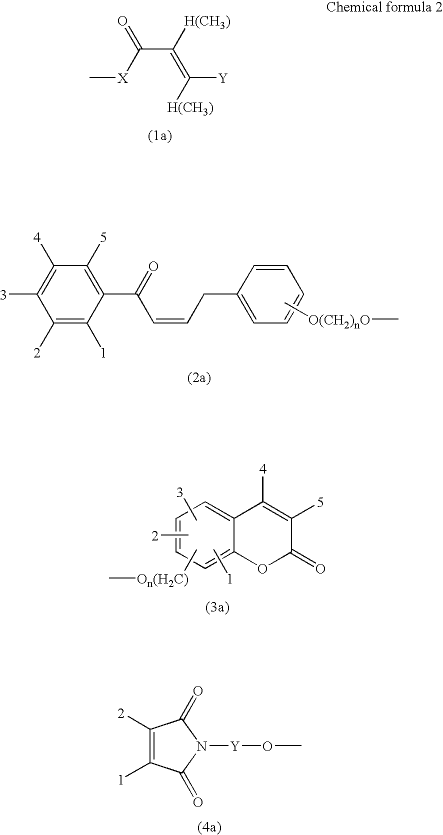
where, in the chemical formula 2 (1a), X is selected from the group consisting of the structures of the following chemical formula 3, 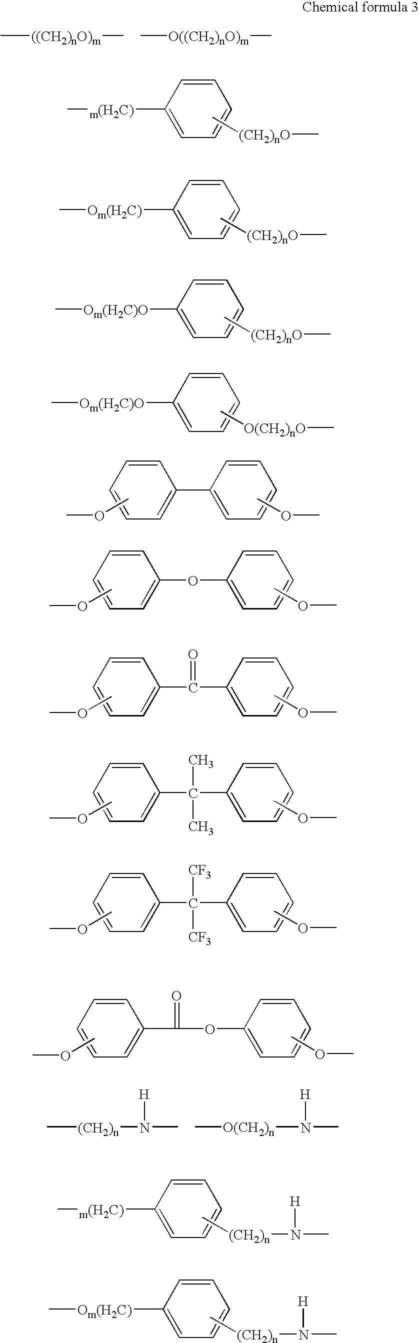 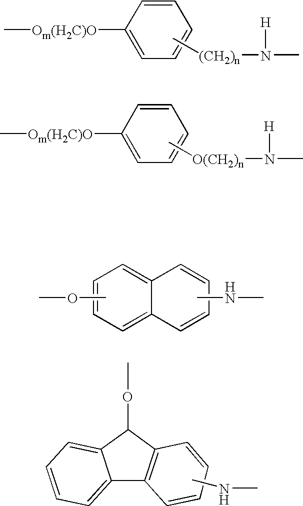
where, in the chemical formula 3, m and n are 0˜10 respectively,
where, in the chemical formula 2(1a), Y is selected from the group consisting of the structures of the following chemical formula 4, 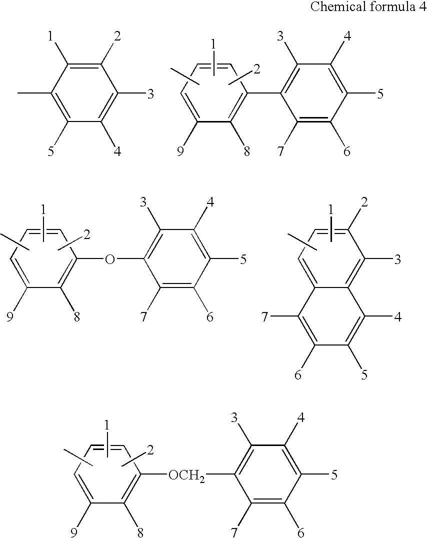
where, in the chemical formula 4, the numerals 1, 2, 3, 4, 5, 6, 7, 8, and 9 are respectively selected from the group consisting of the structures of the following chemical formula 5, 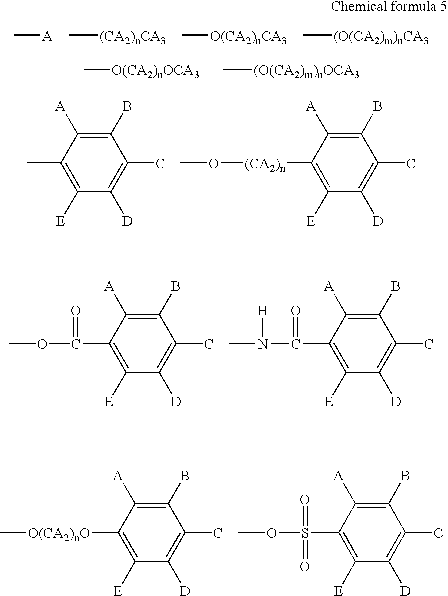
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following formula 6, 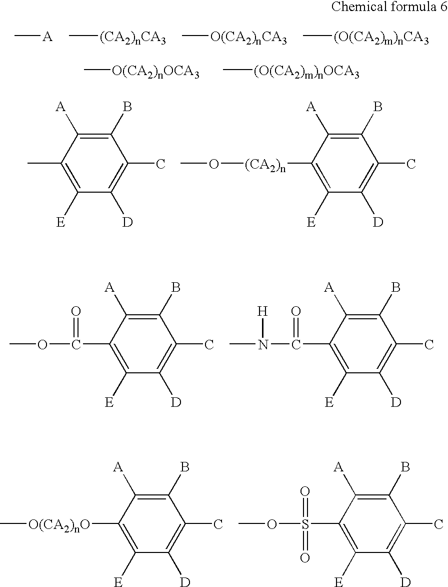
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 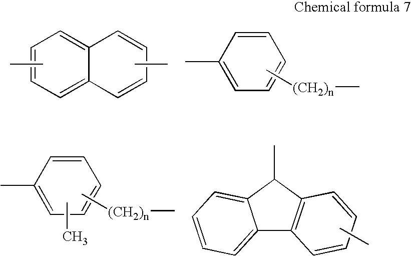
where, in the chemical formula 7, n is 0˜10,
where, in the chemical formula 2 (4a), the numerals 1 and 2 are respectively selected from the group consisting of the structures of the following chemical formula 8, 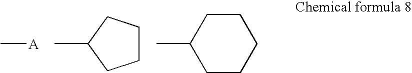
where, in the chemical formula 8, A is selected from the group consisting of H, F, CH₃, CF₃, and CN.
where, in the chemical formula 16, R₁₂ and R₁₃ are respectively based on one amine selected from the group consisting of the structures of the following chemical formula 17, 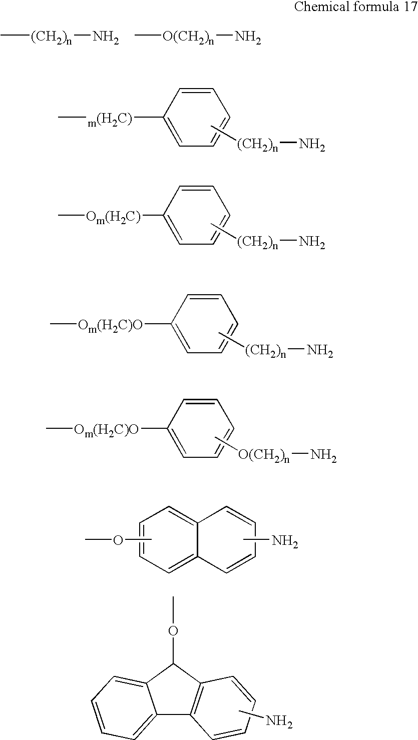
where, in the chemical formula 17, m and n are 0˜10 respectively,
where, in the chemical formula 16, R₁₄ is based on one carboxylic acid dianhydride selected from the group consisting of the structures of the following chemical formula 18, 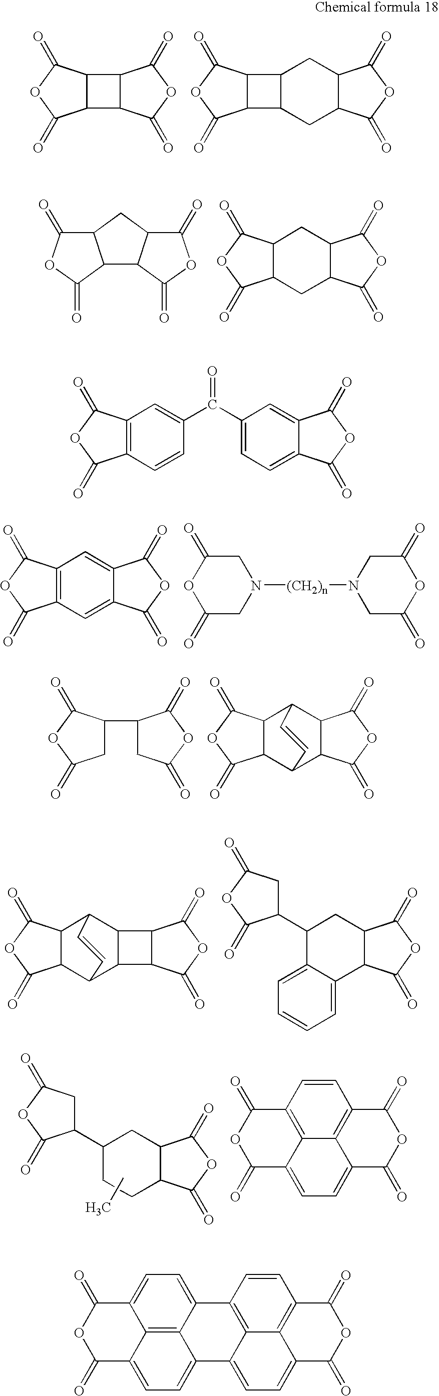
where, in the chemical formula 16, R₁₅ is selected from the group consisting of the structures of the following chemical formula 19, 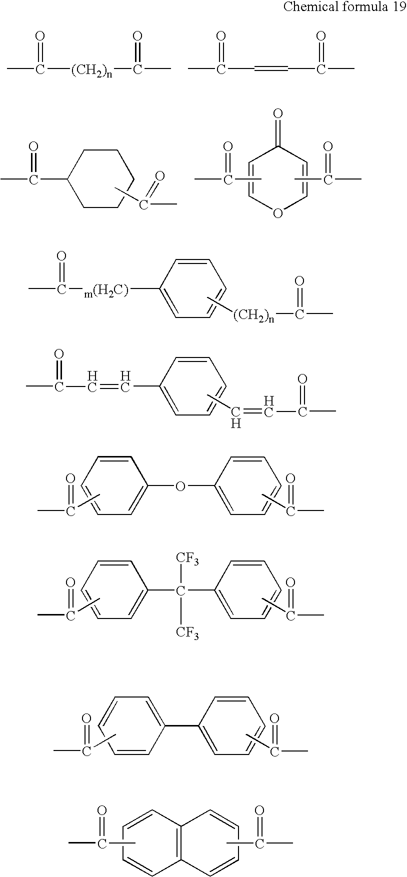
where, in the chemical formula 19, m and n are 0˜10 respectively.

9. The flexible metal clad laminate film according to claim 4,
wherein the photoactive polymer comprises a photoactive polyimide having the structure of the following chemical formula 20: 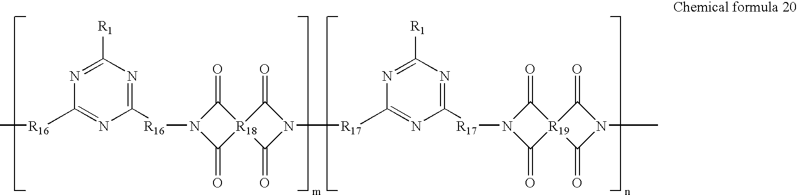
where in the chemical formula 20, m+n=1, 0≦m≦1, 0≦n≦1, and R₁ is selected from the group of (1a), (2a), (3a), and (4a) of the following chemical formula 2 respectively, 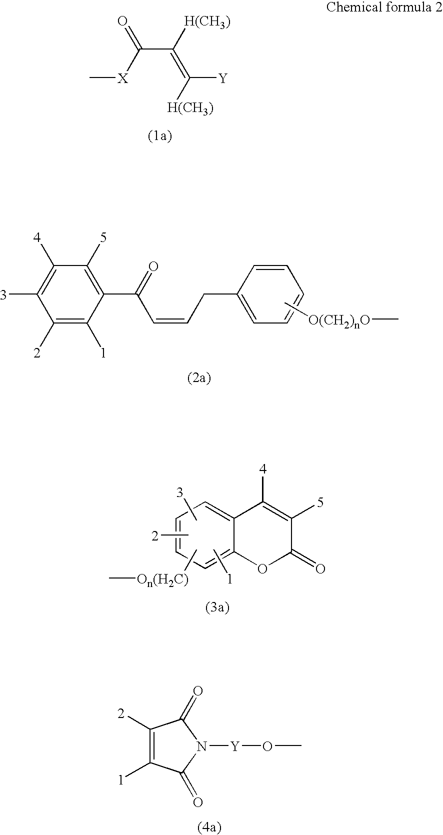
where, in the chemical formula 2 (1a), X is selected from the group consisting of the structures of the following chemical formula 3, 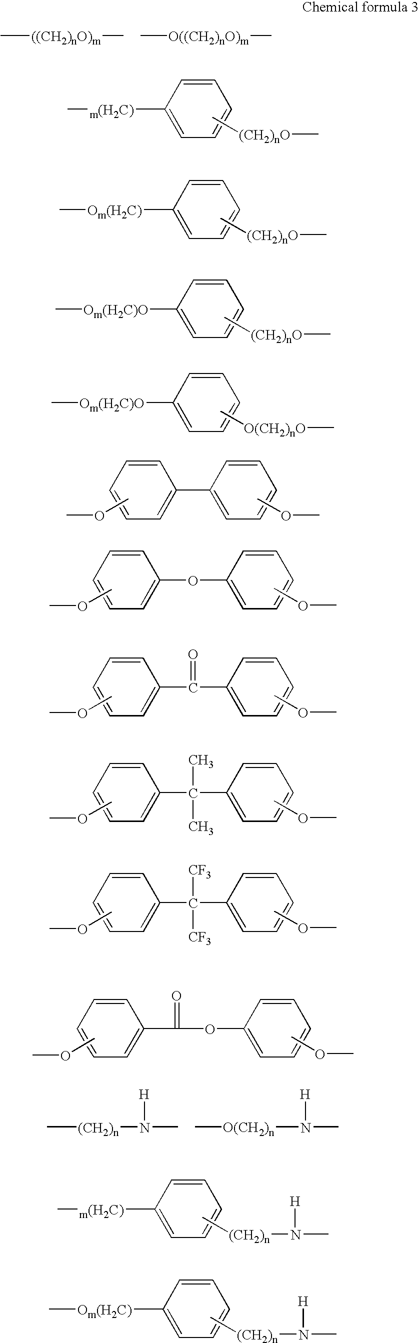 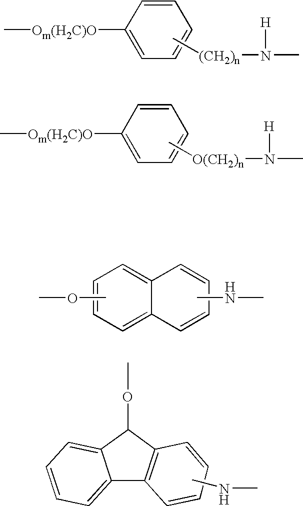
where, in the chemical formula 3, m and n are 0˜10 respectively;
where, in the chemical formula 2(1a), Y is selected from the group consisting of the structures of the following chemical formula 4, 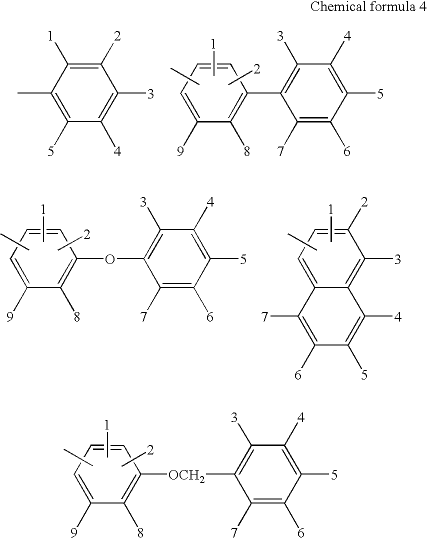
where, the numerals 1, 2, 3, 4, 5, 6, 7, 8, and 9 in the chemical formula 4 are respectively selected from the group consisting of the structures of the following chemical formula 5, 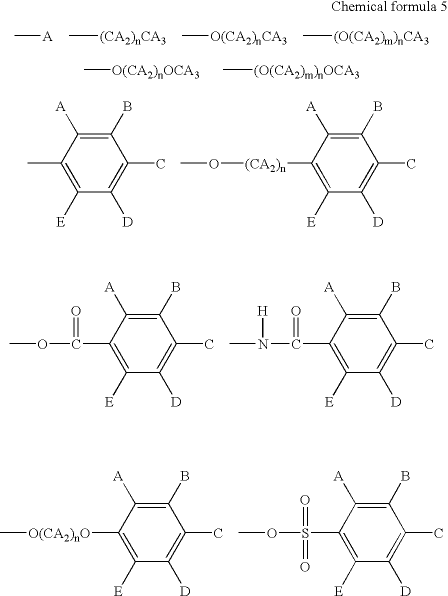
where, in the chemical formula 5, m and n are 0˜10 respectively, and A, B, C, D, and E are respectively selected from the group consisting of H, F, Cl, CN, CF₃ and CH₃,
where, in the chemical formula 2 of (2a) and (3a), n is 0˜10, and the numerals 1, 2, 3, 4, and 5 are respectively selected from the group consisting of the structures of the following formula 6, 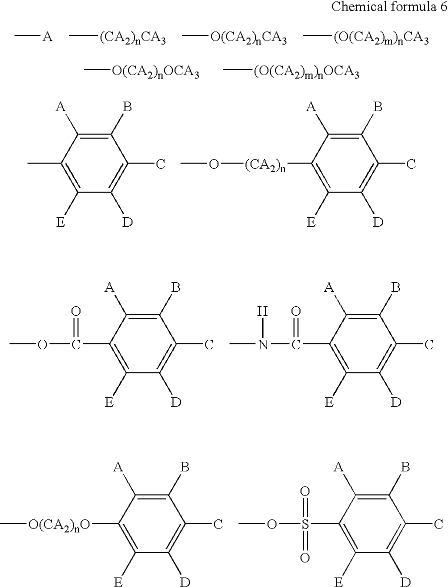
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 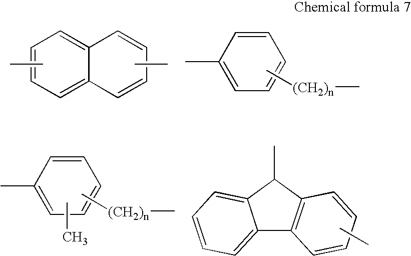
where, in the chemical formula 7, n is 0˜10,
where, in the chemical formula 2 (4a), the numerals 1 and 2 are respectively selected from the group consisting of the structures of the following chemical formula 8, 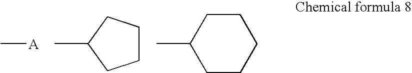
where, in the chemical formula 8, A is selected from the group consisting of H, F, CH₃, CF₃, and CN,
where, in the chemical formula 20, R₁₆ and R₁₇ are respectively based on one amine selected from the group consisting of the structures of the following chemical formula 17, 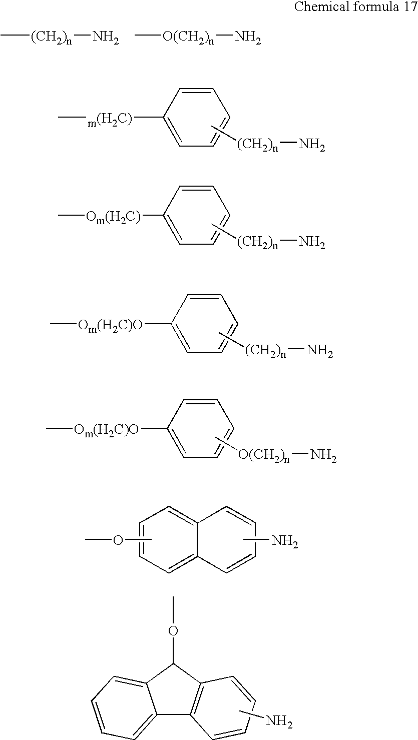
where, in the chemical formula 17, m and n are 0˜10 respectively,
where, in the chemical formula 20, R₁₈ and R₁₉ are respectively based on one carboxylic acid dianhydride selected from the group consisting of the structures of the following chemical formula 18.

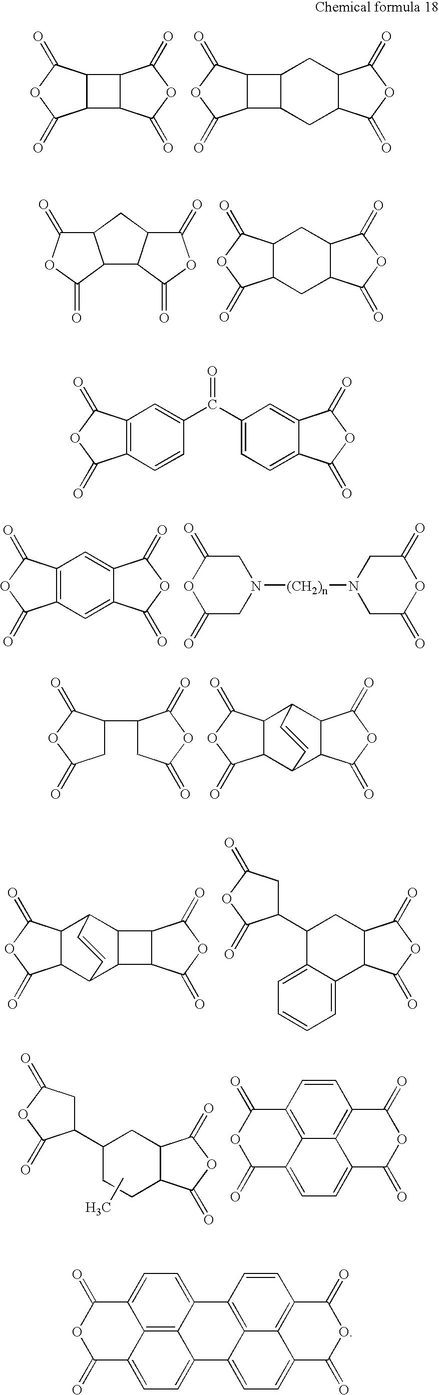

10. The flexible metal clad laminate film according to claim 1,
wherein the photoactive polymer has 1,000 to 1,000,000 of number average molecular weight (Mn).

11. The flexible metal clad laminate film according to claim 1,
wherein the metal thin film is made of one selected from the group consisting of copper, platinum, gold, silver, and aluminum.

12. The flexible metal clad laminate film according to claim 1,
wherein the metal thin film has 0.1˜500 μm of thickness.

13. The flexible metal clad laminate film according to claim 1,
wherein an adhesive layer is further formed between the metal thin film and the flexible insulating film.

14. The flexible metal clad laminate film according to claim 1,
wherein the flexible insulating film has 1 nm˜10 cm of thickness.

15. A method for manufacturing a flexible metal clad laminate film comprising the steps of:
(a) preparing a photoactive polymer having photoactive side chains, which may be crosslinked by photo-irradiation;
(b) preparing a solution by dissolving the photoactive polymer in a solvent;
(c) forming a coating layer by applying the solution on a surface of a metal thin film;
(d) eliminating the solvent from the coating layer; and
(e) forming a flexible insulating film by irradiating on the surface of the solvent-free coating layer so that the photoactive polymers may be crosslinked.

16. A method for manufacturing a flexible metal clad laminate film comprising the steps of:
(a) preparing a photoactive polymer having photoactive side chains, which may be crosslinked by photo-irradiation;
(b) preparing a solution by dissolving the photoactive polymer in a solvent;
(c) forming a coating layer by applying the solution on a surface of abase plate;
(d) eliminating the solvent from the coating layer;
(e) forming a flexible insulating film by irradiating on the surface of the solvent-free coating layer so that the photoactive polymers may be crosslinked;
(f) peeling off the flexible insulating film from the surface of the base plate; and
(g) adhering both the peeled flexible insulating film and a metal thin film using an adhesive.

17. The method for manufacturing a flexible metal clad laminate film according to claim 15 or 16,
wherein the photoactive side chain is selected from the group consisting of (1a), (2a), (3a), and (4a) having the structure of the following chemical formula 2: 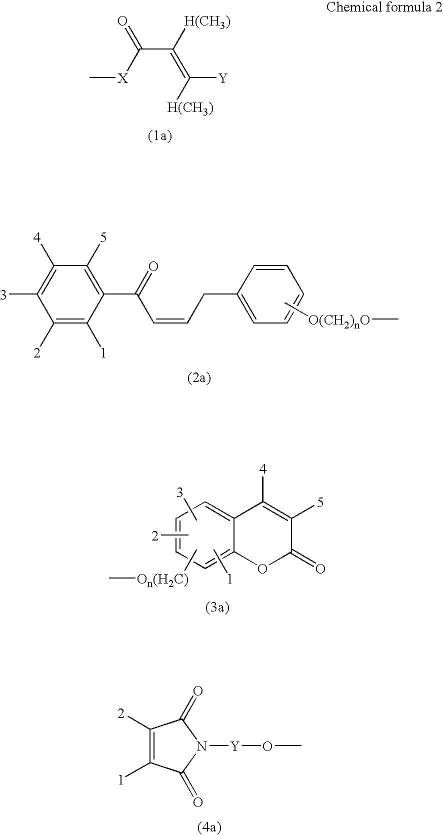
where, in the chemical formula 2 (1a), X is selected from the group consisting of 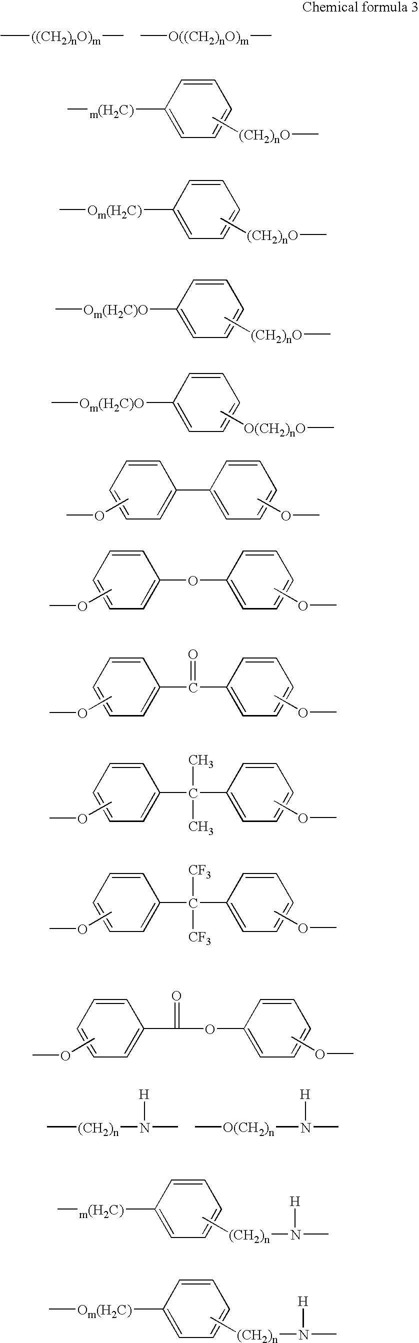 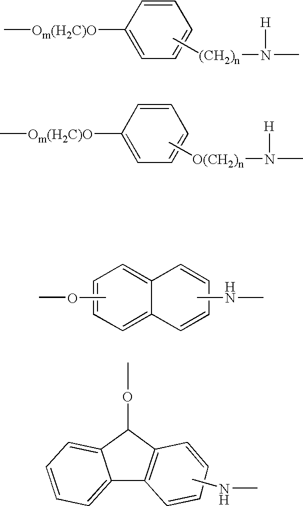
where, in the chemical formula 3, m and n are 0˜10 respectively;
where, in the chemical formula 2(1a), Y is selected from the group consisting of the structures of the following chemical formula 4,
Chemical formula 4
where, in the chemical formula 4, the numerals 1, 2, 3, 4, 5, 6, 7, 8, and 9 are respectively selected from the group consisting of the structures of the following chemical formula 5, 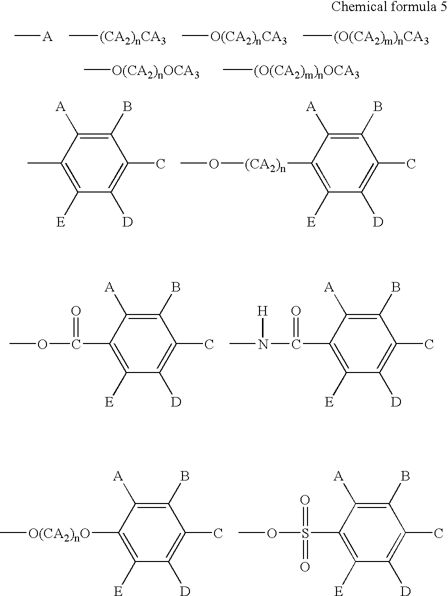
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following formula 6, 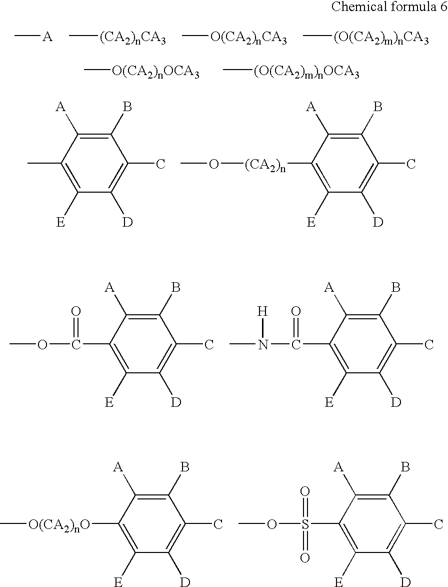
where, in the chemical formula 6, m and n are 0˜10 respectively, and A, B, C, D, and E are respectively selected from the group consisting of H. F; Cl, CN, CF₃ and CH₃,
where, in the chemical formula 2 (4a), Y is selected from the group consisting of the structures of the following chemical formula 7, 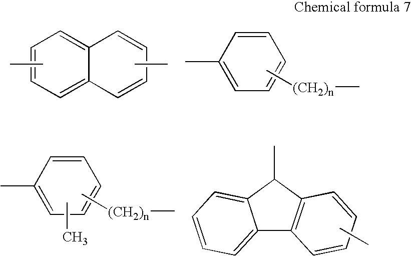
where, in the chemical formula 7, n is 0˜10,
where, in the chemical formula 2 (4a), the numerals 1 and 2 are respectively selected from the group consisting of the structures of the following chemical formula 8, 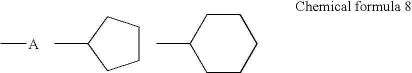
where, in the chemical formula 8, A is selected from the group consisting of H, F, CH₃, CF₃, and CN.

18. The method for manufacturing a flexible metal clad laminate film according to claim 15 or 16,
wherein the photoactive polymer comprises a main chain in which triazine rings are introduced.

19. The method for manufacturing a flexible metal clad laminate film according to claim 15 or 16,
wherein the photoactive polymer comprises a main chain in which triazine rings having photoactive side chains capable of crosslinking reaction by photo-irradiation are introduced.

20. The method for manufacturing a flexible metal clad laminate film according to claim 19,
wherein the photoactive polymer comprises a photoactive polycyanurate having the structure of the following chemical formula 1: 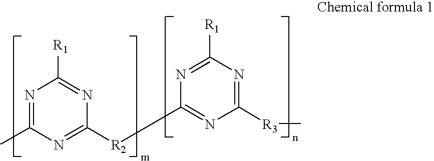
where in the chemical formula 1, m+n=1, 0≦m≦1, 0≦n≦1, and R₁ is selected from the group of (1a), (2a), (3a), and (4a) of the following chemical formula 2 respectively, 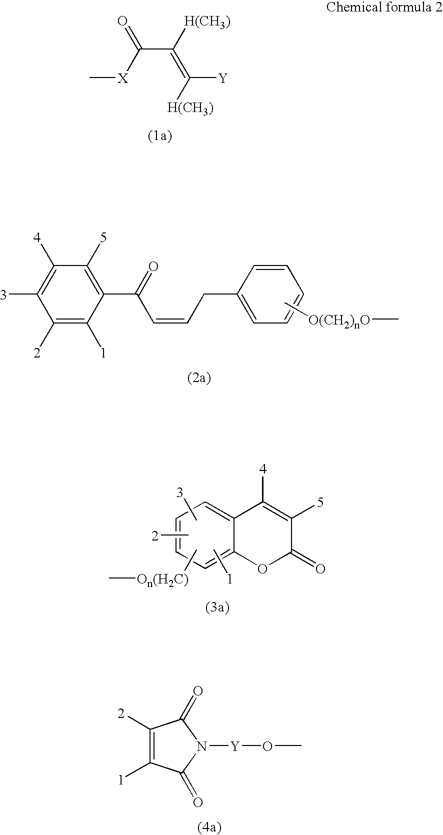
where, in the chemical formula 2 (1a), X is selected from the group consisting of the structures of the following chemical formula 3, 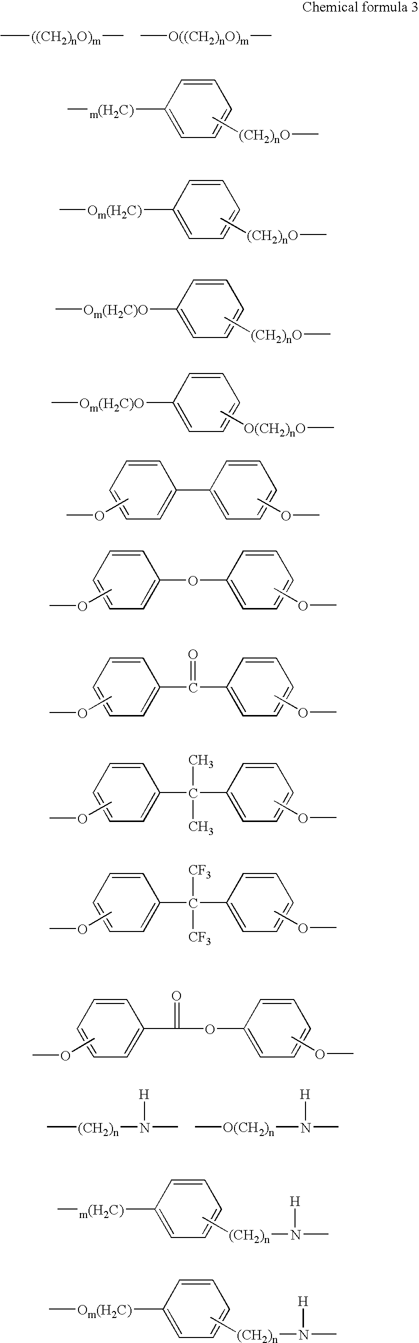 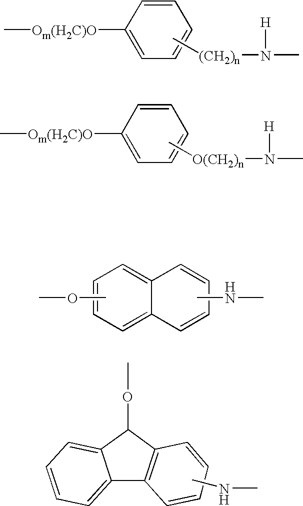
where, in the chemical formula 3, m and n are 0˜10 respectively;
where, in the chemical formula 2(1a), Y is selected from the group consisting of the structures of the following chemical formula 4, 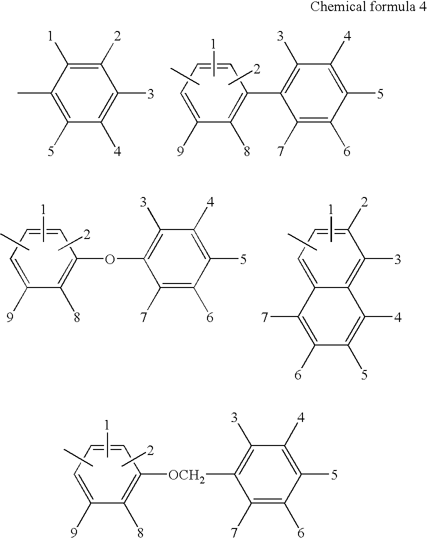
where, in the chemical formula 4, the numerals 1, 2, 3, 4, 5, 6, 7, 8, and 9 are respectively selected from the group consisting of the structures of the following chemical formula 5, 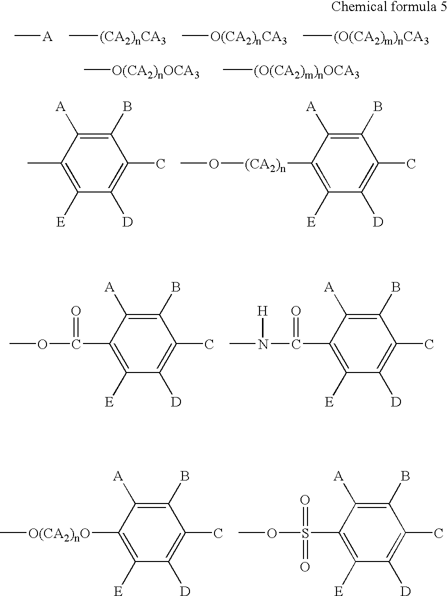
where, in the chemical formula 5, m and n are 0˜10 respectively, and A, B, C, D, and E are respectively selected from the group consisting of H, F, Cl, CN, CF₃ and CH₃,
where, in the chemical formula 2 of (2a) and (3a), n is 0˜10, and the numerals 1, 2, 3, 4, and 5 are respectively selected from the group consisting of the structures of the following formula 6, 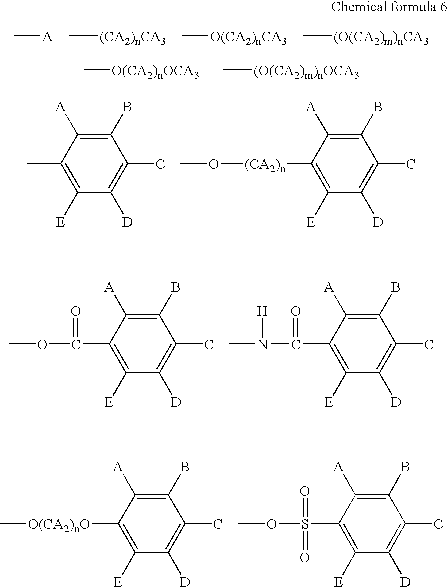
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 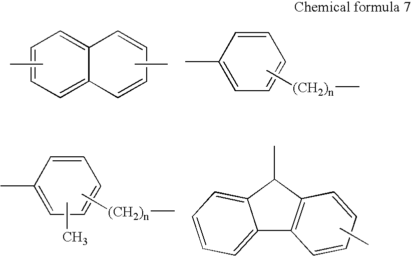
where, in the chemical formula 7, n is 0˜10,
where, in the chemical formula 2 (4a), the numerals 1 and 2 are respectively selected from the group consisting of the structures of the following chemical formula 8, 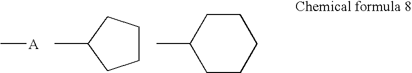
where, in the chemical formula 8, A is selected from the group consisting of H, F, CH₃, CF₃, and CN,
where, in the chemical formula 1, R₂ and R₃ are respectively selected from the group consisting of the structures of the following chemical formula 9. 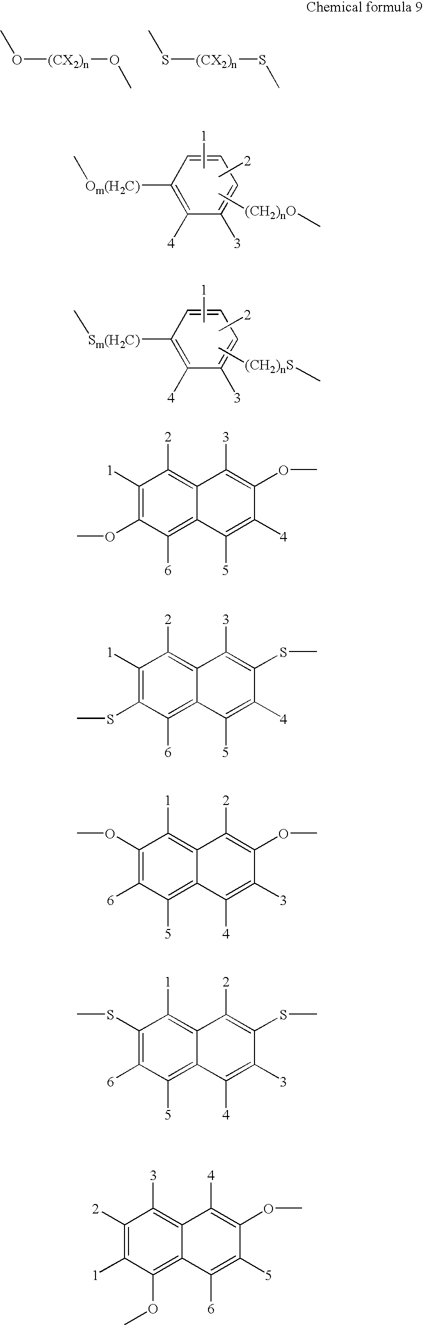 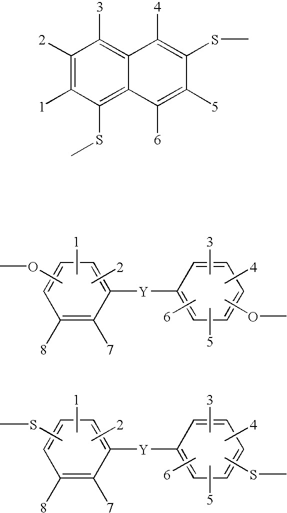
where, in the chemical formula 9, m and n are 0˜10 respectively, the numerals 1, 2, 3, 4, 5, 6, 7, and 8 are respectively selected from the group consisting of H. F. Cl, CN, CH₃, OCH₃, and CF₃, X is selected from the group consisting of H. F. Cl, CN, CH₃, OCH₃, and CF₃, and Y is selected from the group consisting of CH₂, C(CH₃)₂, C(CF₃)₂, O, S, SO₂, CO, and CO₂.

21. The method for manufacturing a flexible metal clad laminate film according to claim 19,
wherein the photoactive polymer comprises a photoactive polyester having the structure of the following chemical formula 10: 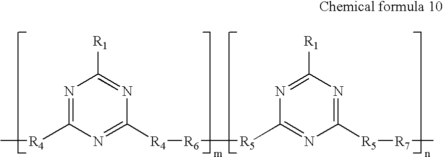
where, in the chemical formula 10, m+n=1, 0≦m≦1, 0≦n≦1, and R₁ is selected from the group of (1a), (2a), (3a), and (4a) of the following chemical formula 2 respectively, 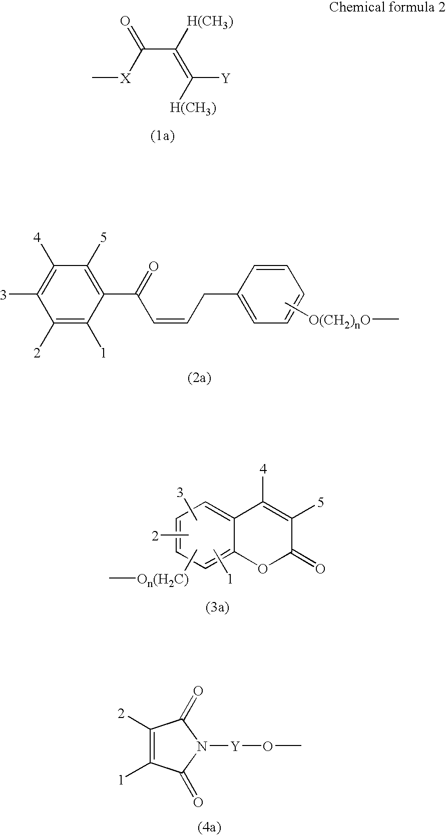
where, in the chemical formula 2 (1a), X is selected from the group consisting of the structures of the following chemical formula 3, 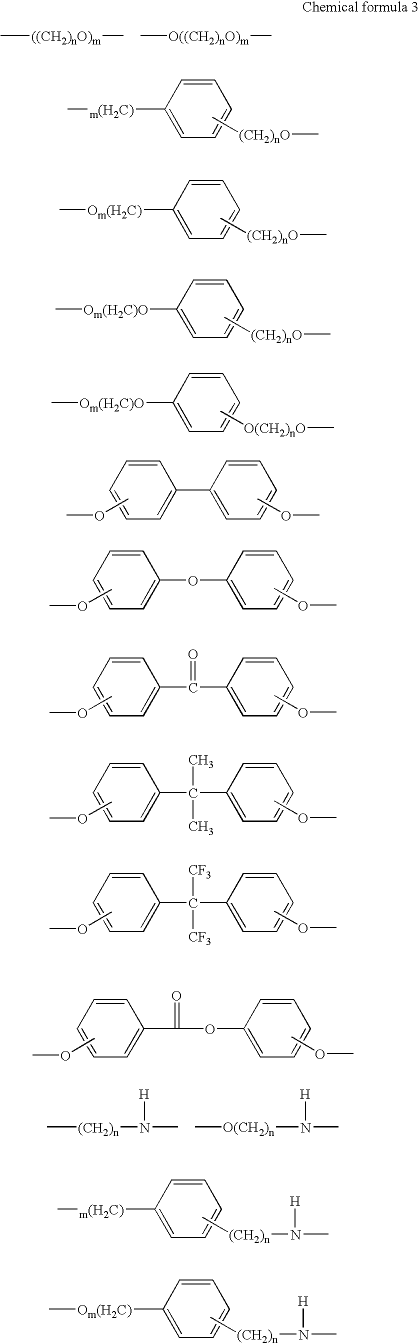 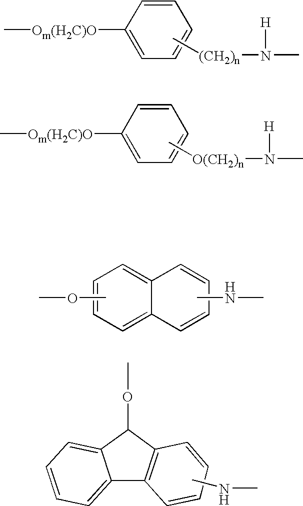
where, in the chemical formula 3, m and n are 0˜10 respectively,
where, in the chemical formula 2(1a), Y is selected from the group consisting of the structures of the following chemical formula 4, 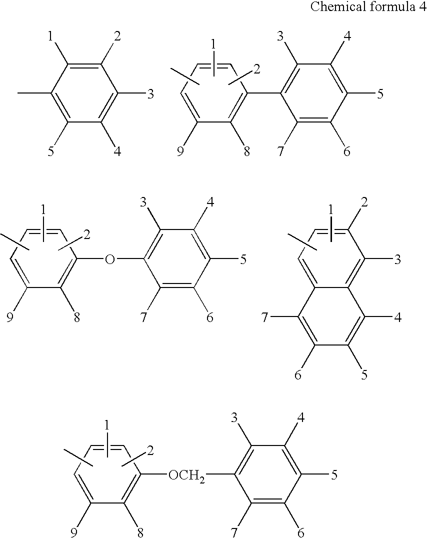
where, in the chemical formula 4, the numerals 1, 2, 3, 4, 5, 6, 7, 8, and 9 are respectively selected from the group consisting of the structures of the following chemical formula 5, 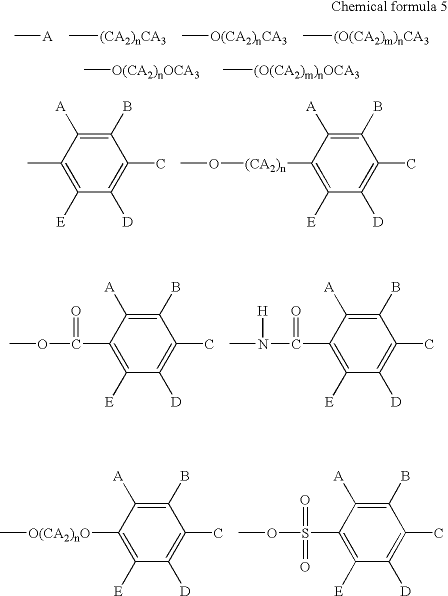
where, in the chemical formula 5, m and n are 0˜10 respectively, and A, B, C, D, and E are respectively selected from the group consisting of H, F, Cl, CN, CF₃ and CH₃,
where, in the chemical formula 2 of (2a) and (3a), n is 0˜10, and the numerals 1, 2, 3, 4, and 5 are respectively selected from the group consisting of the structures of the following chemical formula 6, 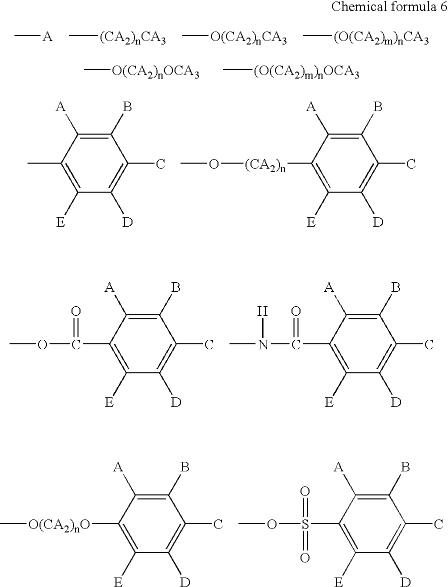
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 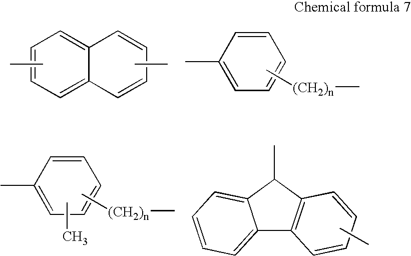
where, in the chemical formula 7, n is 0˜10,
where, in the chemical formula 2 (4a), the numerals 1 and 2 are respectively selected from the group consisting of the structures of the following chemical formula 8, 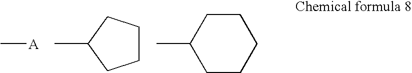
where, in the chemical formula 8, A is selected from the group consisting of H, F, CH₃, CF₃, and CN,
where, in the chemical formula 10, R₄ and R₅ are respectively selected from the group consisting of the structures of the following chemical formula 11, 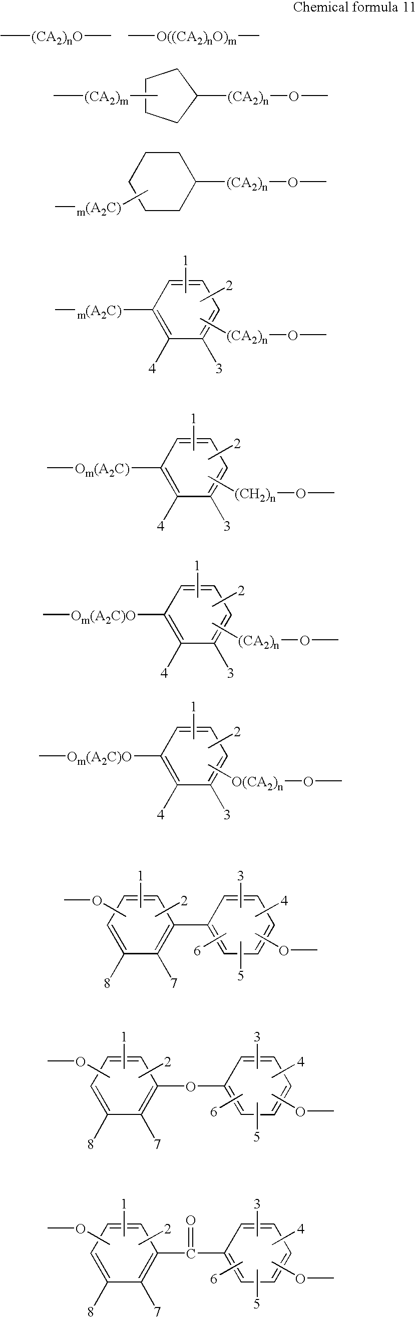 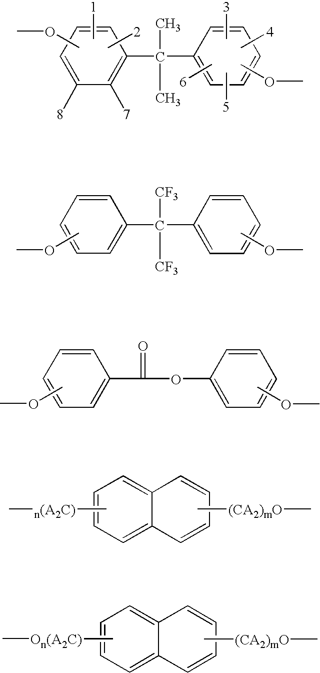
where, in the chemical formula 11, m and n are 0˜10 respectively, and A, the numerals 1, 2, 3, 4, 5, 6, 7, and 8 are respectively selected from the group consisting of H, F, Cl, CN, CF₃, and CH₃,
where, in the chemical formula 10, R₆ and R₇ are respectively selected from the group consisting of the structures of the following chemical formula 12, 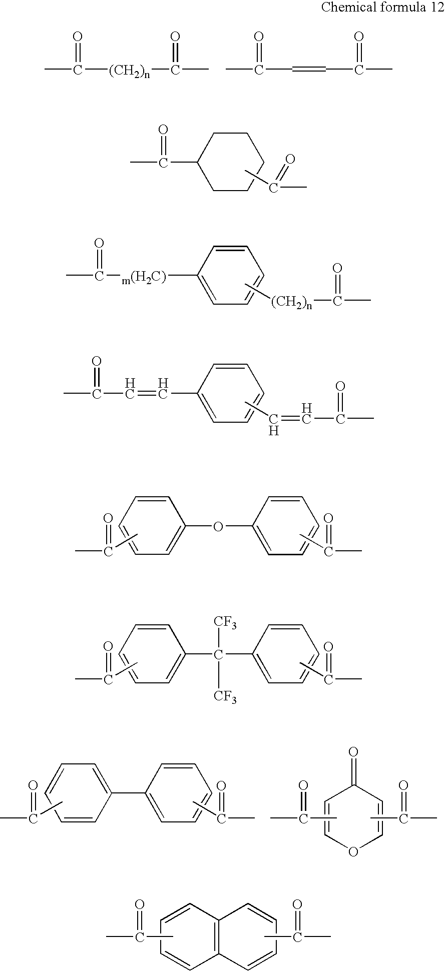
where, in the chemical formula 12, m and n are 0˜10 respectively.

22. The method for manufacturing a flexible metal clad laminate film according to claim 19,
wherein the photoactive polymer comprises a photoactive poly(thio)ether having the structure of the following chemical formula 13: 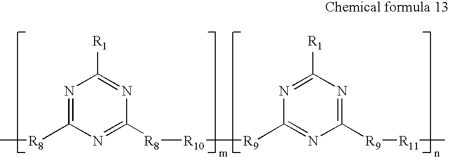
where, in the chemical formula 13, m+n=1, 0≦m≦1, 0≦n≦1, and R₁ is selected from the group of (1a), (2a), (3a), and (4a) of the following chemical formula 2 respectively, 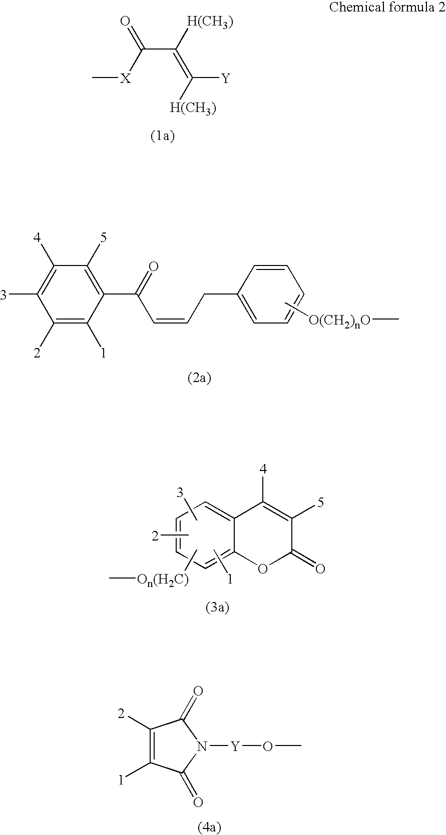
where, in the chemical formula 2 (1a), X is selected from the group consisting of the structures of the following chemical formula 3, 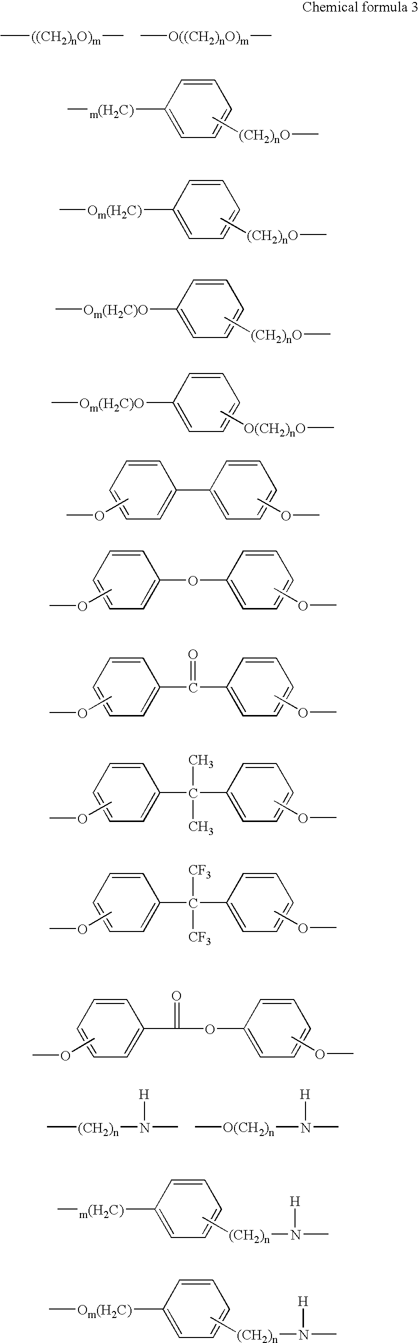 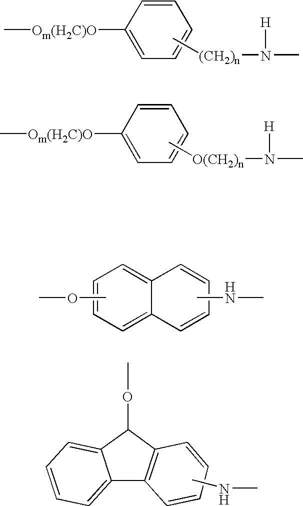
where, in the chemical formula 3, m and n are 0˜10 respectively;
where, in the chemical formula 2(1a), Y is selected from the group consisting of the structures of the following chemical formula 4, 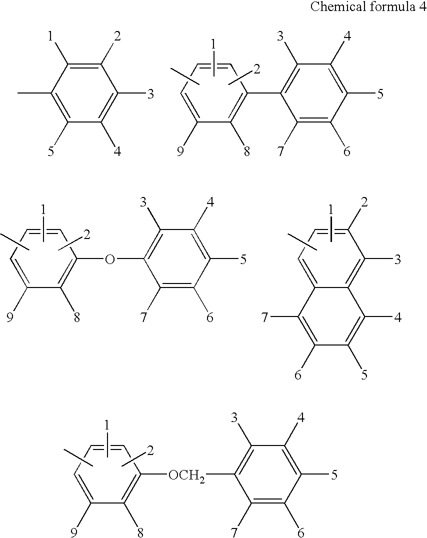
where, in the chemical formula 4, the numerals 1, 2, 3, 4, 5, 6, 7, 8, and 9 are respectively selected from the group consisting of the structures of the following chemical formula 5, 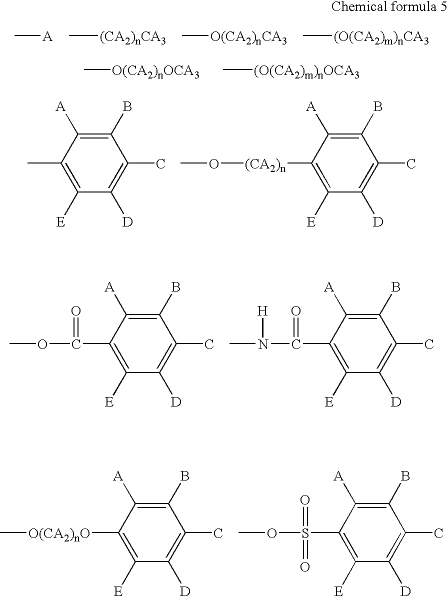
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following chemical formula 6, 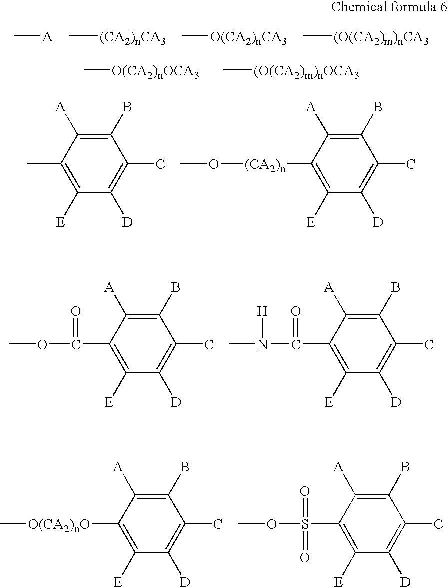
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 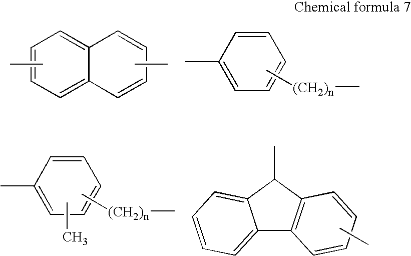
where, in the chemical formula 7, n is 0˜10,
where, in the chemical formula 2 (4a), the numerals 1 and 2 are respectively selected from the group consisting of the structures of the following chemical formula 8, 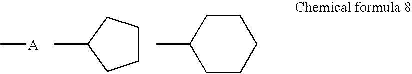
where, in the chemical formula 8, A is selected from the group consisting of H, F, CH₃, CF₃, and CN,
where, in the chemical formula 13, R₈ and R₉ are respectively selected from the group consisting of the structures of the following chemical formula 14, 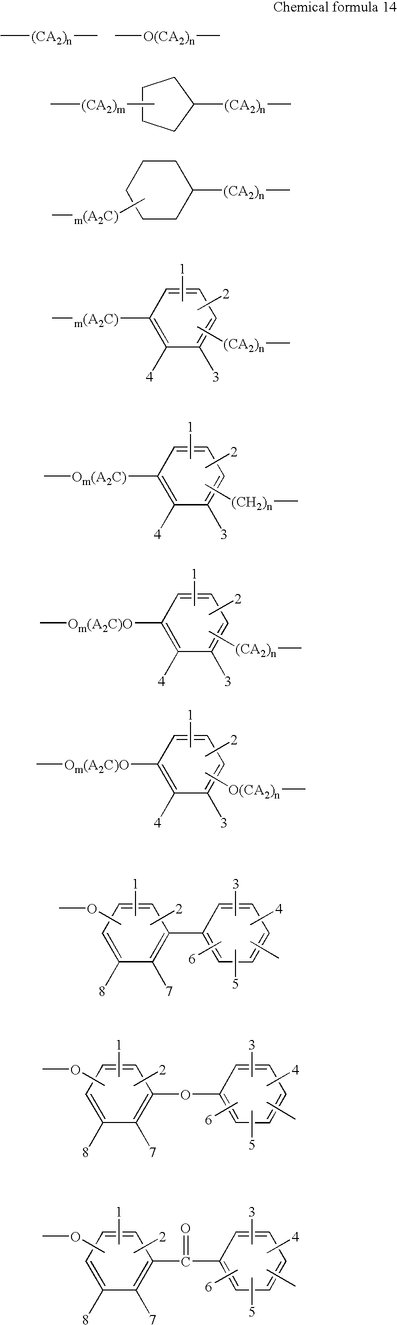 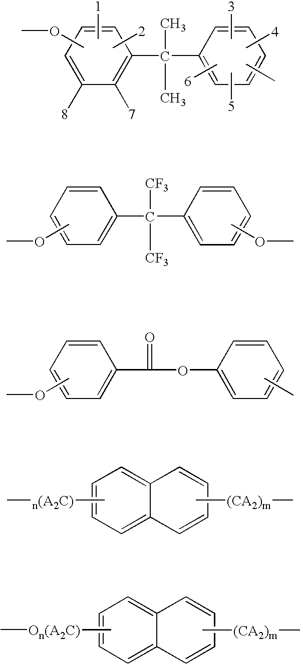
where, in the chemical formula 14, m and n are 0˜10 respectively, and A, the numerals 1, 2, 3, 4, 5, 6, 7, and 8 are respectively selected from the group consisting of H, F, Cl, CN, CF₃, and CH₃,
where, in the chemical formula 13, R₁₀ and R₁₁ are respectively selected from the group consisting of the structures of the following chemical formula 15, 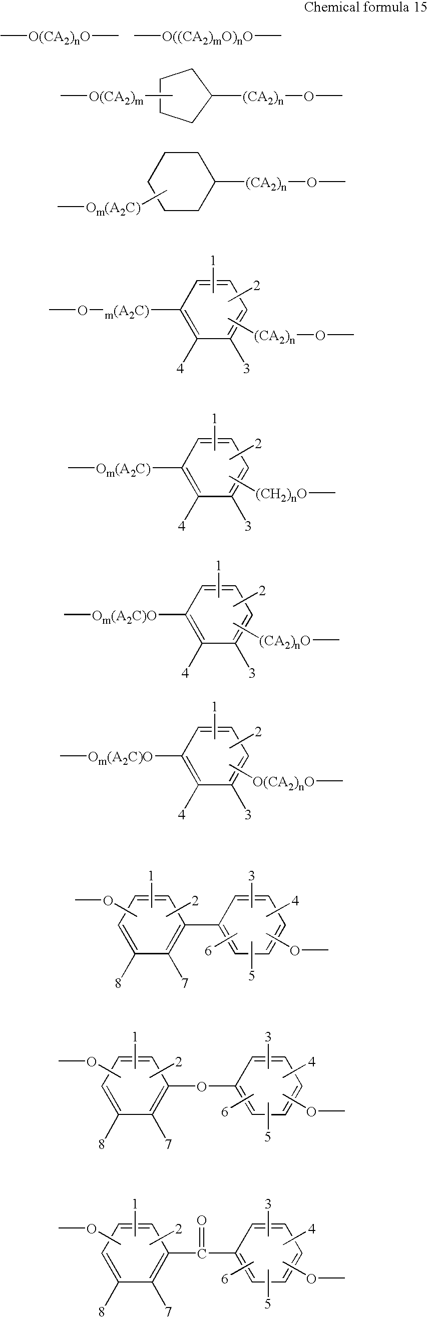 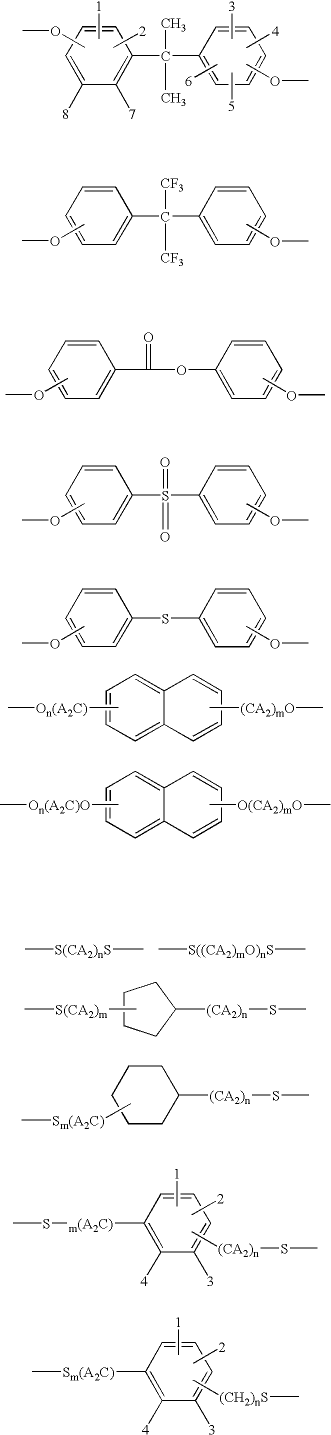 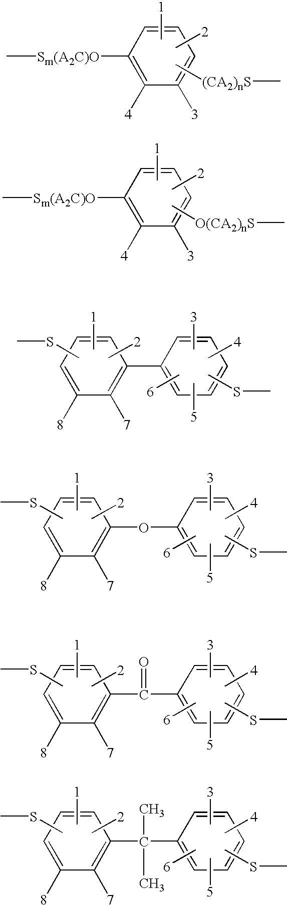 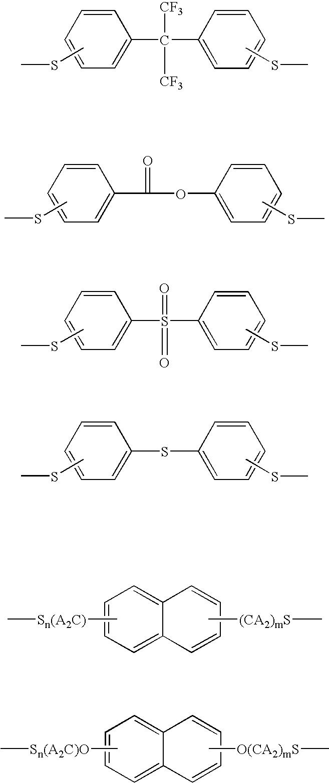
where, in the chemical formula 15, m and n are 0˜10 respectively, and A, the numerals 1, 2, 3, 4, 5, 6, 7, and 8 are respectively selected from the group consisting of H, F, Cl, CN, CF₃, and CH₃.

23. The method for manufacturing a flexible metal clad laminate film according to claim 19,
wherein the photoactive polymer comprises a photoactive poly(amide-imide) having the structure of the following chemical formula 16: 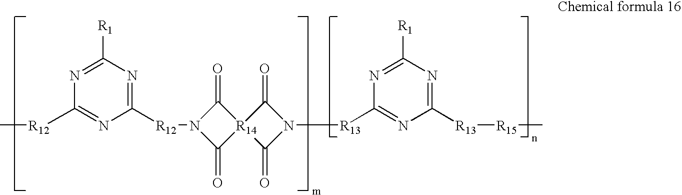
where, in the chemical formula 16, m+n=1, 0≦m≦1, 0≦n≦1, and R₁ is selected from the group of (1a), (2a), (3a), and (4a) of the following chemical formula 2 respectively, 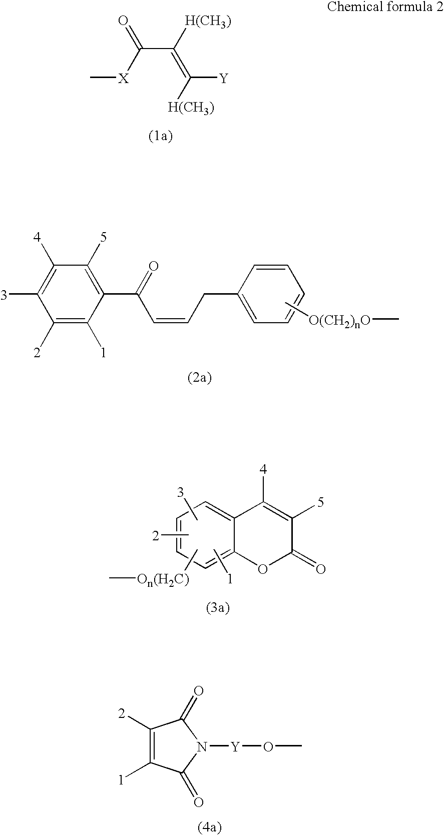
where, in the chemical formula 2 (1a), X is selected from the group consisting of the structures of the following chemical formula 3, 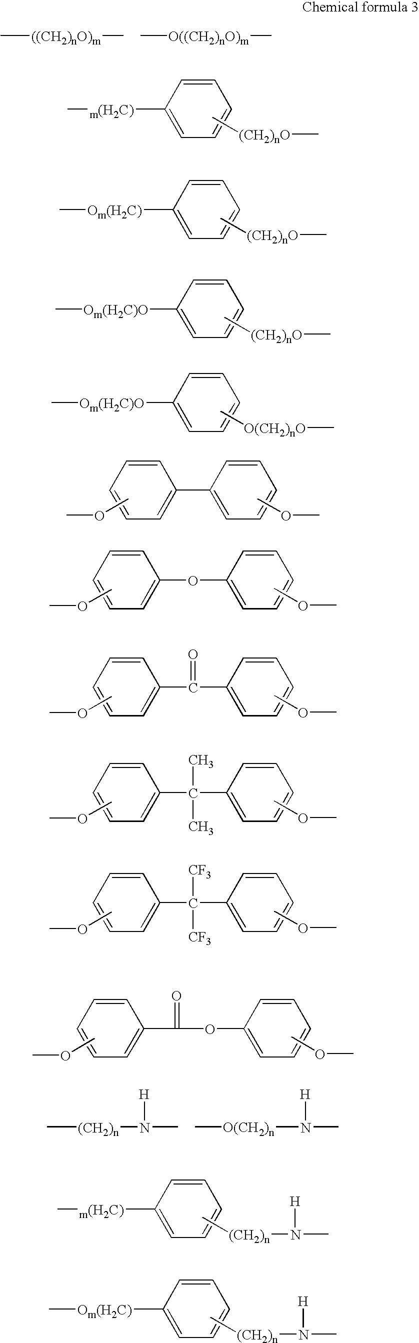 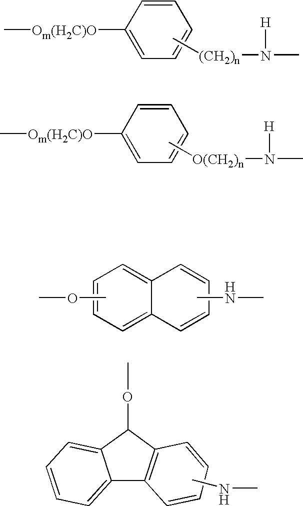
where, in the chemical formula 3, m and n are 0˜10 respectively;
where, in the chemical formula 2(1a), Y is selected from the group consisting of the structures of the following chemical formula 4, 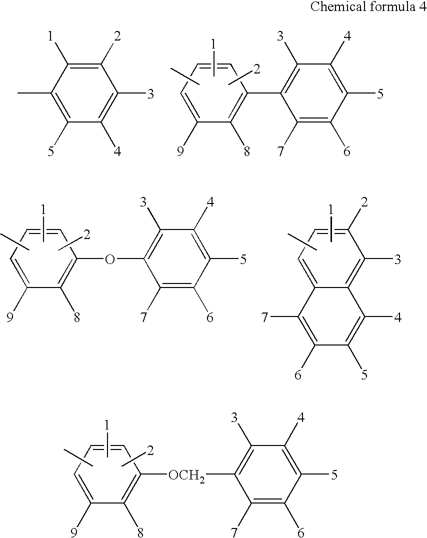
where, in the chemical formula 4, the numerals 1, 2, 3, 4, 5, 6, 7, 8, and 9 are respectively selected from the group consisting of the structures of the following chemical formula 5, 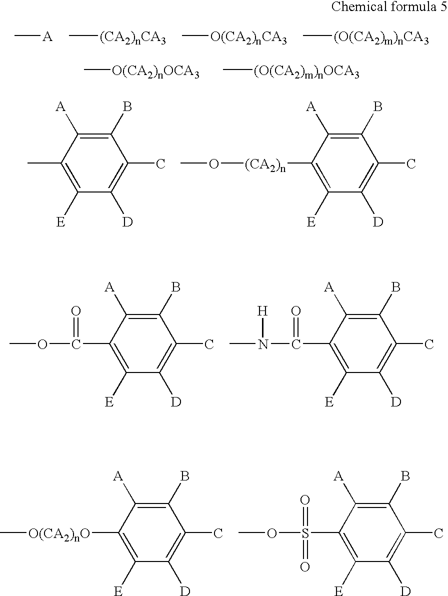
where, in the chemical formula 5, m and n are 0˜10 respectively, and A, B, C, D, and E are respectively selected from the group consisting of H, F, Cl, CN, CF₃ and CH₃,
where, in the chemical formula 2 of (2a) and (3a), n is 0˜10, and the numerals 1, 2, 3, 4, and 5 are respectively selected from the group consisting of the structures of the following formula 6, 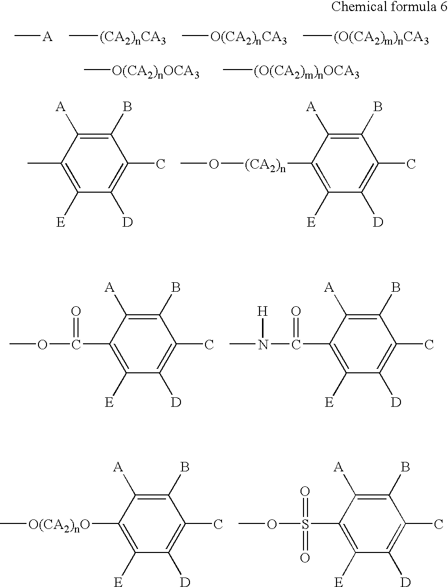
where, in the chemical formula 6, m and n are 0˜10 respectively, and A, B. C, D, and E are respectively selected from the group consisting of H, F, Cl, CN, CF₃ and CH₃,
where, in the chemical formula 2 (4a), Y is selected from the group consisting of the structures of the following chemical formula 7, 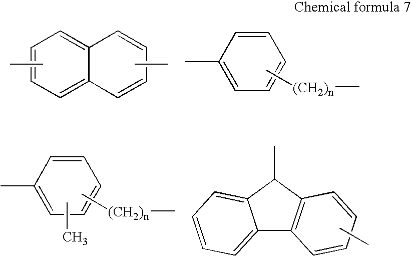
where, in the chemical formula 7, n is 0˜10,
where, in the chemical formula 2 (4a), the numerals 1 and 2 are respectively selected from the group consisting of the structures of the following chemical formula 8, 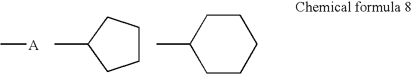
where, in the chemical formula 8, A is selected from the group consisting of H, F, CH₃, CF₃, and CN,
where, in the chemical formula 16, R₁₂ and R₁₃ are respectively based on one amine selected from the group consisting of the structures of the following chemical formula 17, 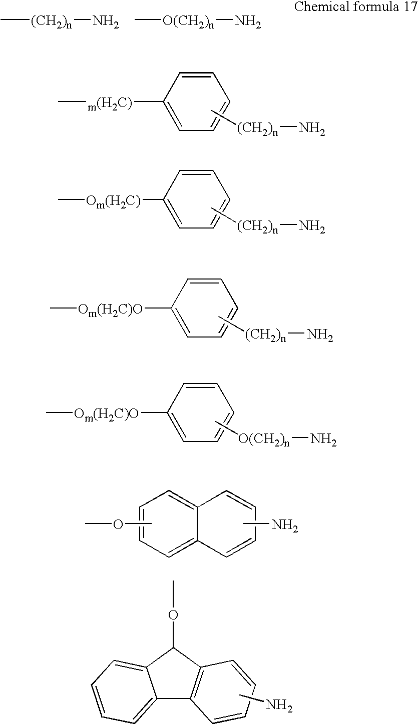
where, in the chemical formula 17, m and n are 0˜10 respectively,
where, in the chemical formula 16, R₁₄ is based on one carboxylic acid dianhydride selected from the group consisting of the structures of the following chemical formula 18, 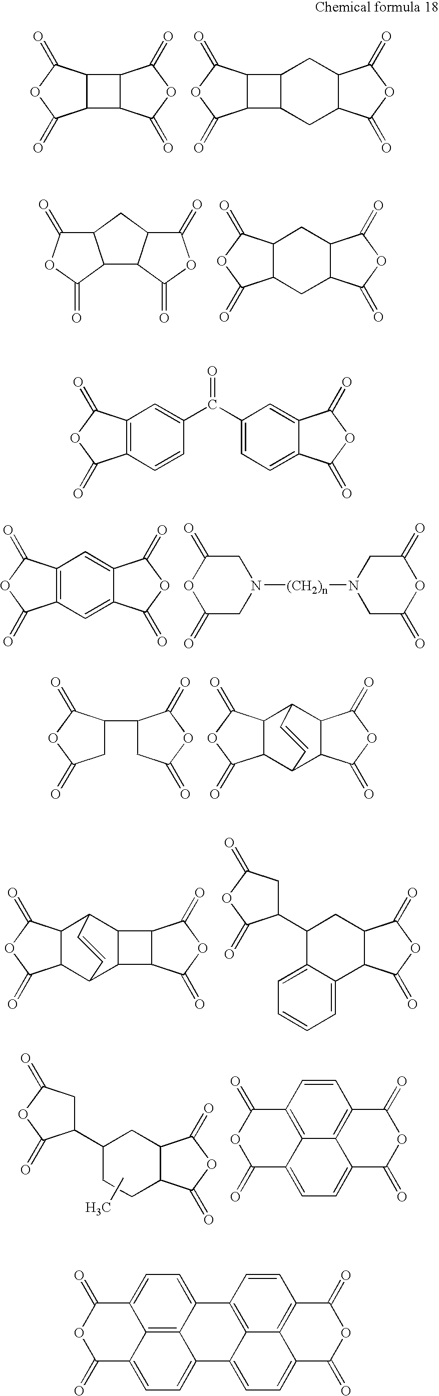
where, in the chemical formula 16, R₁₅ is group consisting of the structures of the following chemical formula 19, 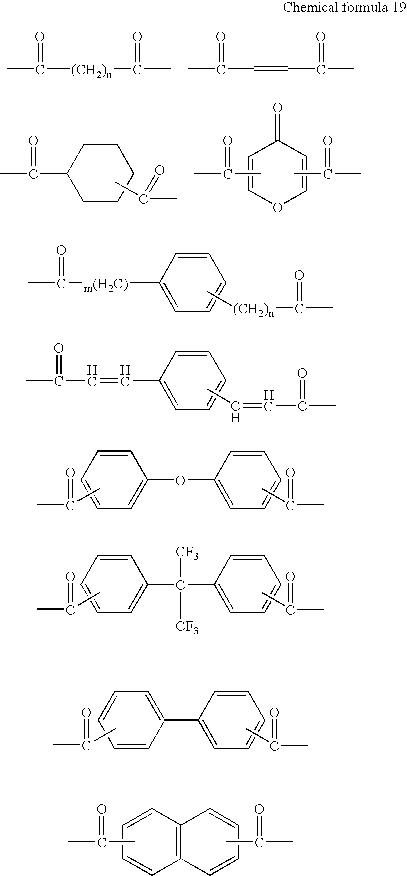
where, in the chemical formula 19, m and n are 0˜10 respectively.

24. A method for manufacturing a flexible metal clad laminate film comprising the steps of:
(a) preparing a solution of a photoactive polyamic acid having photoactive side chains, which may be crosslinked by photo-irradiation;
(b) forming a coating layer by applying the solution on a surface of a metal thin film;
(c) eliminating the solvent from the coating layer;
(d) imidizing the polyamic acid in the solvent-free coating layer so as to form a photoactive polyimide; and
(e) forming a flexible insulating film by irradiating on the surface of the coating layer so that the photoactive polyimides may be crosslinked before or after the step (d).

25. A method for manufacturing a flexible metal clad laminate film comprising the steps of:
(a) preparing a solution of a photoactive polyamic acid having photoactive side chains, which may be crosslinked by photo-irradiation;
(b) forming a coating layer by applying the solution on a surface of a base plate;
(c) eliminating the solvent from the coating layer;
(d) imidizing the polyamic acid in the solvent-free coating layer so as to form a photoactive polyimide;
(e) forming a flexible insulating film by irradiating on the surface of the coating layer so that the photoactive polyimides may be crosslinked before or after the step (d);
(f) peeling off the flexible insulating film from the surface of the base plate; and
(g) adhering both the peeled flexible insulating film and a metal thin film using an adhesive.

26. The method for manufacturing a flexible metal clad laminate film according to claim 24 or 25,
wherein the photoactive side chain is selected from the group consisting of (1a), (2a), (3a), and (4a) having the structure of the following chemical formula 2: 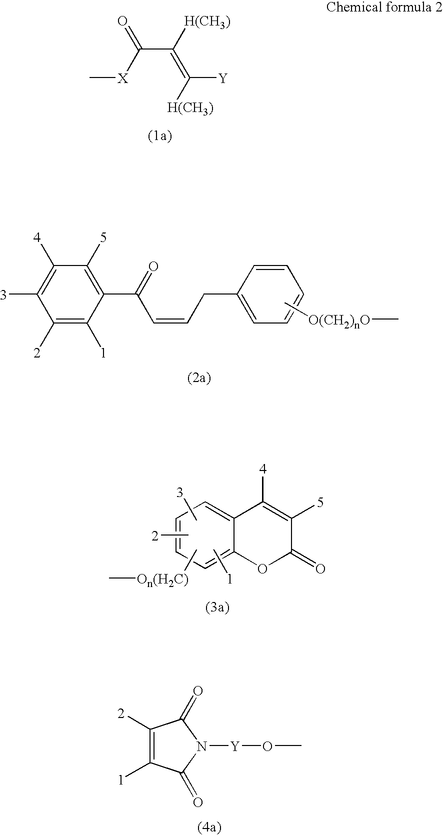
where, in the chemical formula 2 (1a), X is selected from the group consisting of the structures of the following chemical formula 3, 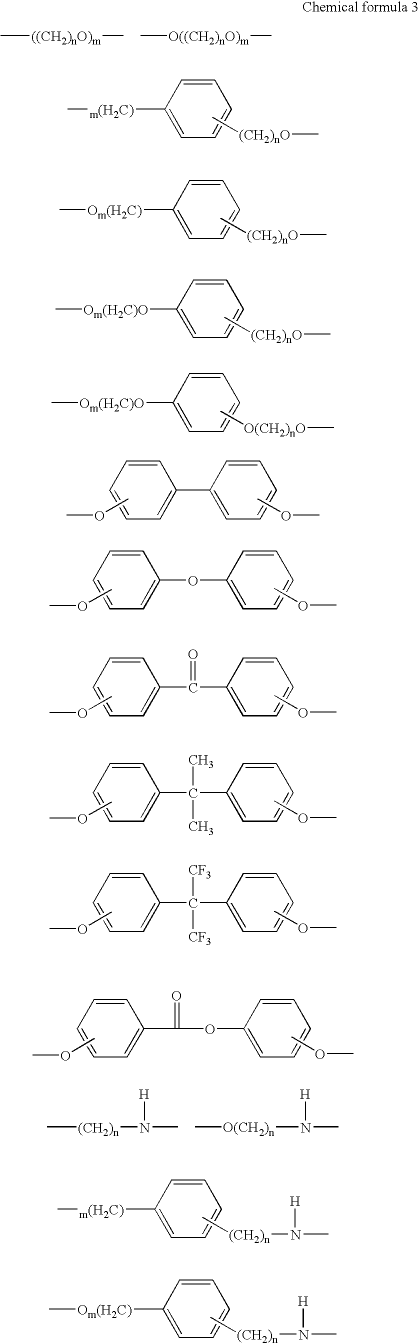 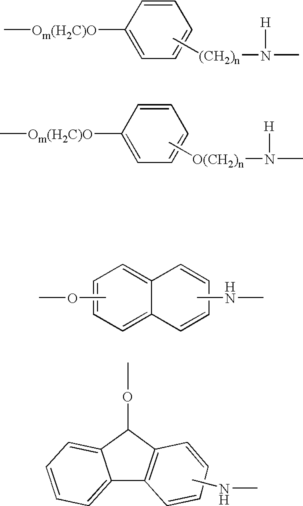
where, in the chemical formula 3, m and n are 0˜10 respectively;
where, in the chemical formula 2(1a), Y is selected from the group consisting of the structures of the following chemical formula 4, 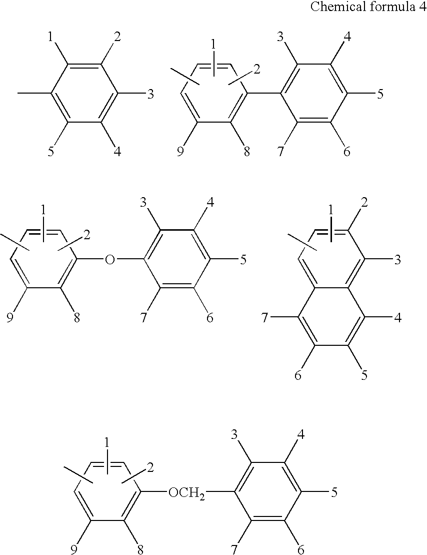
where, in the chemical formula 4, the numerals 1, 2, 3, 4, 5, 6, 7, 8, and 9 are respectively selected from the group consisting of the structures of the following chemical formula 5, 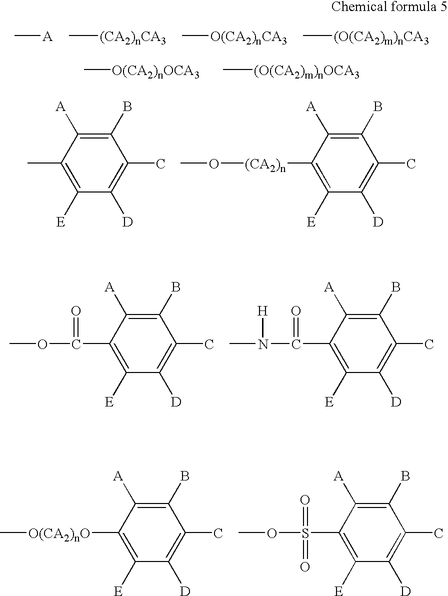
where, in the chemical formula 5, m and n are 0˜10 respectively, and A, B, C, D, and E are respectively selected from the group consisting of H, F, Cl, CN, CF₃ and CH₃,
where, in the chemical formula 2 (2a) and (3a), n is 0˜10, and the numerals 1, 2, 3, 4, and 5 are respectively selected from the group consisting of the structures of the following chemical formula 6, 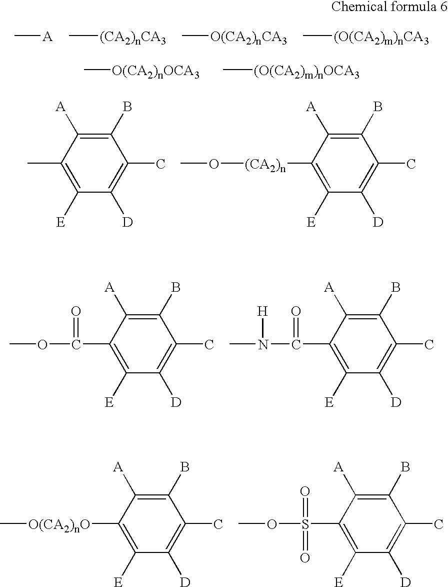
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 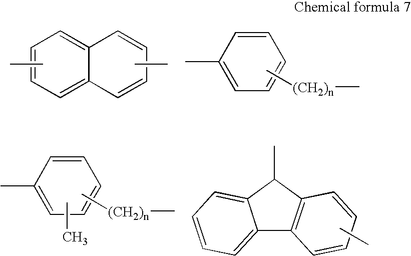
where, in the chemical formula 7, n is 0˜10,
where, in the chemical formula 2 (4a), the numerals 1 and 2 are respectively selected from the group consisting of the structures of the following chemical formula 8, 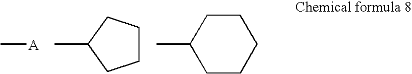
where, in the chemical formula 8, A is selected from the group consisting of H, F, CH₃, CF₃, and CN.

27. The method for manufacturing a flexible metal clad laminate film according to claim 24 or 25,
wherein the photoactive polyimide comprises a main chain in which triazine rings are introduced.

28. The method for manufacturing a flexible metal clad laminate film according to claim 24 or 25,
wherein the photoactive polyimide comprises a main chain in which triazine rings having photoactive side chains capable of crosslinking reaction by photo-irradiation are introduced.

29. The method for manufacturing a flexible metal clad laminate film according to claim 28,
wherein the photoactive polyimide comprises the structure of the following chemical formula 20: 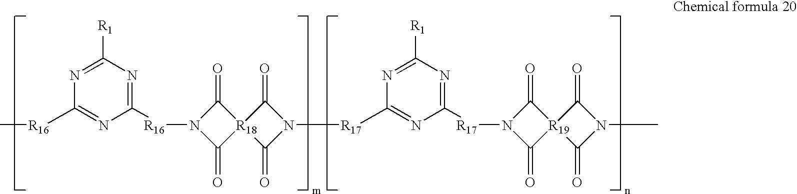
where, in the chemical formula 20, m+n=1, 0≦m≦1, 0≦n≦1, and R₁ is selected from the group of (1a), (2a), (3a), and (4a) of the following chemical formula 2 respectively, 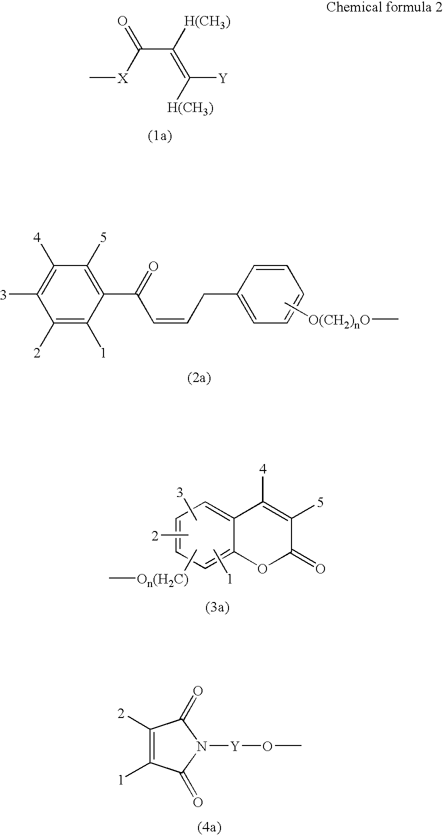
where, in the chemical formula 2 (1a), X is selected from the group consisting of the structures of the following chemical formula 3, 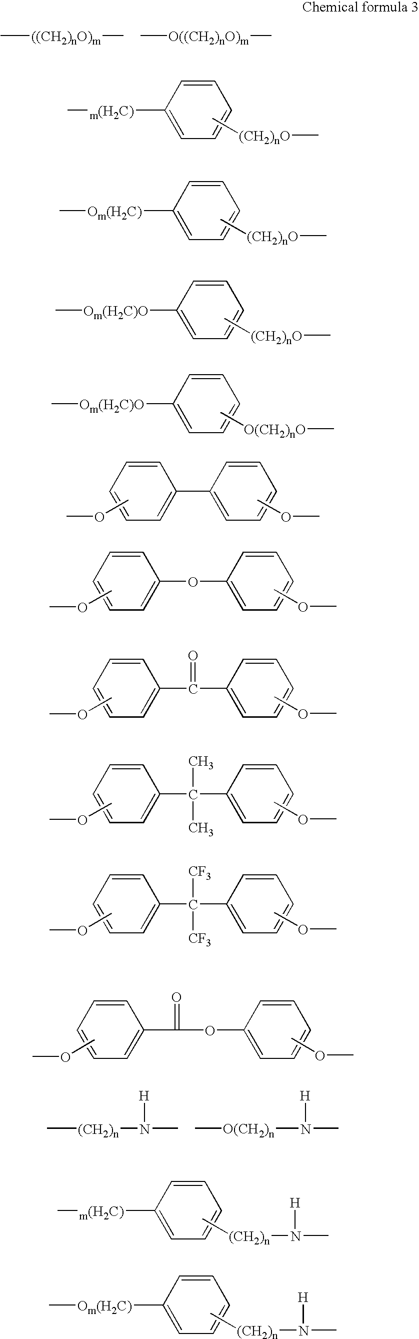 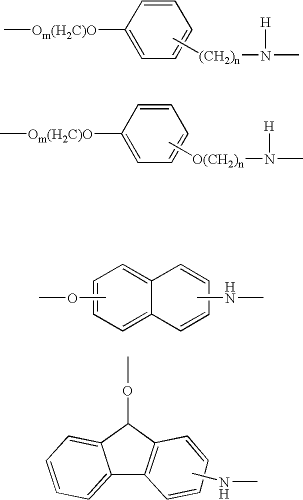
where, in the chemical formula 3, m and n are 0˜10 respectively,
where, in the chemical formula 2(1a), Y is selected from the group consisting of the structures of the following chemical formula 4, Chemical formula 4 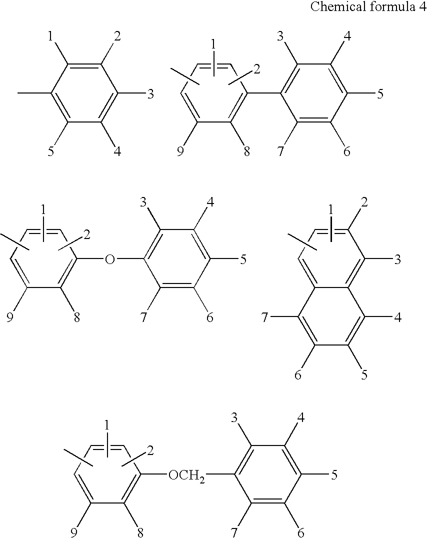
where, in the chemical formula 4, the numerals 1, 2, 3, 4, 5, 6, 7, 8, and 9 are respectively selected from the group consisting of the structures of the following chemical formula 5, 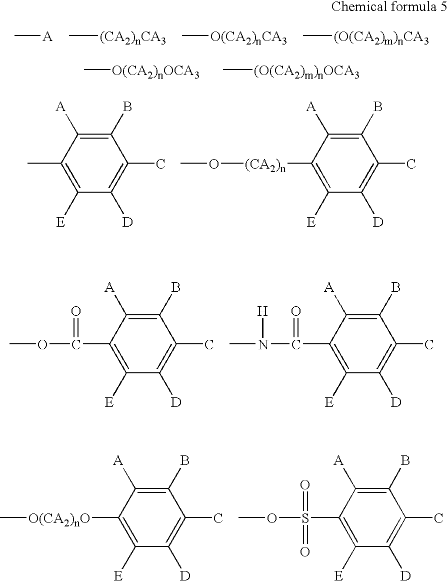
where, in the chemical formula 5, m and n are 0˜10 respectively, and A, B, C, D, and E are respectively selected from the group consisting of H, F, Cl, CN, CF₃ and CH₃,
where, in the chemical formula 2 of (2a) and (3a), n is 0˜10, and the numerals 1, 2, 3, 4, and 5 are respectively selected from the group consisting of the structures of the following formula 6, 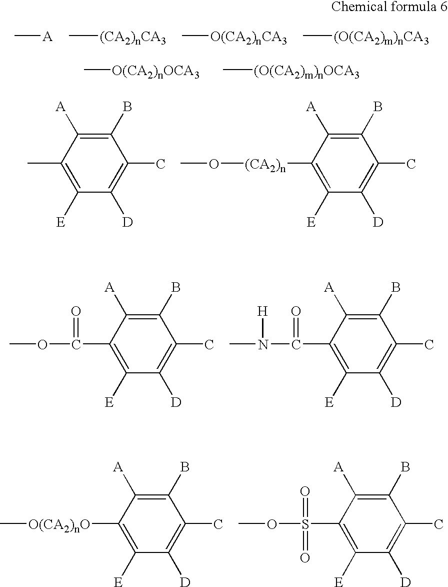
where, in the chemical formula 6, m and n are 0˜10 respectively, and A, B, C, D, and E are respectively selected from the group consisting of H, F, Cl, CN, CF₃ and CH₃,
where, in the chemical formula 2 (4a), Y is selected from the group consisting of the structures of the following chemical formula 7, 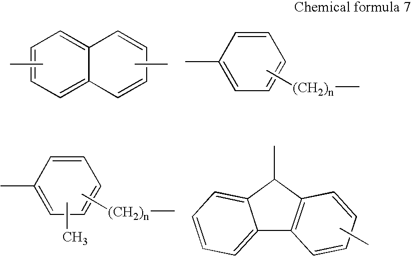
where, in the chemical formula 7, n is 0˜10,
where, in the chemical formula 2 (4a), the numerals 1 and 2 are respectively selected from the group consisting of the structures of the following chemical formula 8, 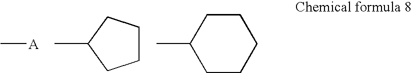
where, in the chemical formula 8, A is selected from the group consisting of H, F, CH₃, CF₃, and CN,
where, in the chemical formula 20, R₁₆ and R₁₇ are respectively based on one amine selected from the group consisting of the structures of the following chemical formula 17, 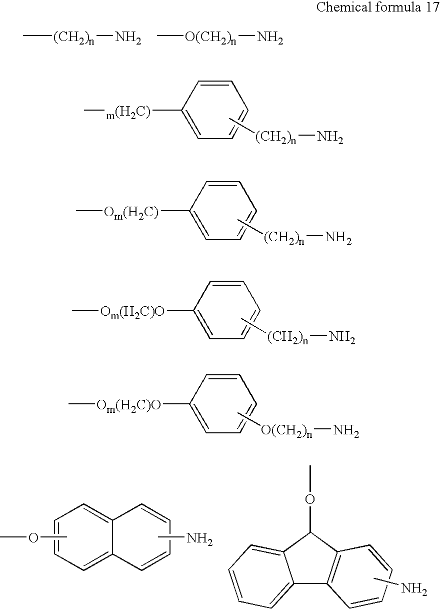
where, in the chemical formula 17, m and n are 0˜10 respectively,
where, in the chemical formula 20, R₁₈ and R₁₉ are respectively based on one carboxylic acid dianhydride selected from the group consisting of the structures of the following chemical formula 18.

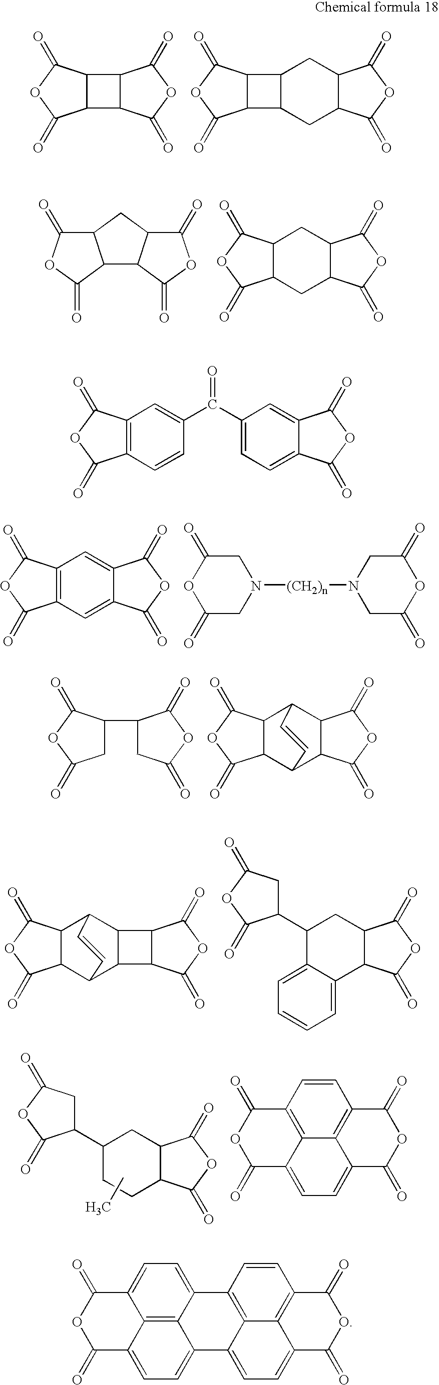

30. The method for manufacturing a flexible metal clad laminate film according to any of claims 15, 16, 24, and 25,
wherein the metal thin film is made of one selected from the group consisting of copper, platinum, gold, silver, and aluminum.

31. The method for manufacturing a flexible metal clad laminate film according to any of claims 15, 16, 24, and 25,
wherein the metal thin film has 0.1˜500 μm of thickness.

32. The method for manufacturing a flexible metal clad laminate film according to any of claims 15, 16, 24, and 25,
wherein the flexible insulating film has 1 nm˜10 cm of thickness.

33. The method for manufacturing a flexible metal clad laminate film according to any of claims 15, 16, 24, and 25,
wherein the photoactive polymer has 1,000 to 1,000,000 of number average molecular weight (Mn).
